(19) United States
(12) Patent Application Publication
(10) Pub. No.: US 2023/0138910 A1
(43) Pub. Date: May 4, 2023

(54) PESTICIDES AND INSECT REPELLENTS

(71) Applicant: The Regents of the University of California, Oakland, CA (US)

(72) Inventors: Anandasankar RAY, Riverside, CA (US); Joel KOWALEWSKI, La Quinta, CA (US)

(73) Assignee: The Regents of the University of California, Oakland, CA (US)

(21) Appl. No.: 17/795,854

(22) PCT Filed: Jan. 29, 2021
(86) PCT No.: PCT/US21/15869

§ 371 Date: Jul. 27, 2022

Related U.S. Application Data
(60) Provisional application No. 62/968,817, filed on Jan. 31, 2020.

(51) Int. Cl. A01N 25/02; A01P 17/00

(52) U.S. Cl. CPC A01N 25/02; A01P 17/00

(57) ABSTRACT

Provided herein are screening methods for identifying compounds for use as repellents, e.g., as alternatives to DEET, and as pesticides. Further provided are one or more compounds identified using the screening methods described herein, and compositions containing such compounds.

### CROSS-REFERENCE TO RELATED APPLICATION

This application claims priority benefit of U.S. Provisional Patent Application No. 62/968,817, filed Jan. 31, 2020. The disclosure of this application is hereby incorporated herein by reference in its entity.

### STATEMENT REGARDING FEDERALLY-SPONSORED RESEARCH

This invention was made with government support under 1R01DC014092-01A1 awarded by NIH. The government has certain rights in the invention.

### TECHNICAL FIELD

The present disclosure relates generally to the field of pesticides and insect repellents, and more specifically to methods of identifying such pesticides and repellents and the compounds being identified.

### BACKGROUND

Blood-feeding insects, such as mosquitoes, transmit deadly pathogens like malaria parasites, dengue viruses, and filarial worms to hundreds of millions of people every year. Insect repellents can be very effective in reducing vectorial capacity by blocking the contact between blood-seeking insects and humans; however, they are seldom used in disease-prone areas of Africa and Asia due to high costs and need for continuous application on skin.

N,N-Diethyl-m-toluamide (DEET) is an example of an insect repellent used in the developed world for more than sixty years. The use of DEET as an insect repellent, however, has several drawbacks. For example, DEET is a solvent capable of melting several forms of plastics, synthetic fabrics, painted and varnished surfaces (Krajick et al., Science, 313: 36, 2006). Additionally, DEET has been shown to inhibit mammalian cation channels and human acetylcholinesterase, which is also inhibited by carbamate insecticides commonly used in disease endemic areas (Corbel et al., BMC Biol, 7, 2009). These concerns are enhanced by the requirement of direct and continuous application of DEET to every part of exposed skin in concentrations that can be as high as 30-100%. Several instances of increased resistance to DEET have also been reported in flies, Anopheles albimanus, and Aedes aegypti (Reeder et al., J Econ Entomol, 94: 1584, 2001; Klun et al., J Med Entomol, 41: 418, 2004; Stanczyk et al., Proc Natl Acad Sci USA, 107: 8575, 2010). Thus, what is needed in the art are alternative compounds to DEET that can be used as insect repellents but are safe for human use, and methods of identifying such alternatives.

Moreover, mosquito strains with resistance to pyrethroid insecticides, the main line of defense against mosquitoes in developing countries, are spreading (Butler et al., Nature, 475: 19, 2011). Increased resistance to pyrethroid insecticides also necessitates discovery of new alternatives.

### BRIEF SUMMARY

In one aspect, provided is a method for identifying a compound that is a pesticide and/or a repellent. In some embodiments, provided is a method for identifying a compound that is a repellent, for example, an insect repellent, such as an alternative to DEET. In some embodiments, provided is a method for identifying a compound that is a pesticide, for example, a pesticide similar to pyrethroid.

In another aspect, provided are compositions each comprising at least one compound identified according to any one of the methods described herein. The compound identified and compositions thereof may be suitable for use as repellents and/or pesticides. In some embodiments, compounds identified and compositions thereof may be useful in agricultural control. In some embodiments, compounds identified and compositions thereof may be useful in treating and/or controlling pest insects to plants, cereals, oilseeds, fruits and vegetables, and other corps. Compounds identified and compositions thereof can be used to treat and/or control pest insects, including but not being limited to, pests of field crops (such as aphids, armyworms, and blister beetles, and see more examples on https://entomology.ca.uky.edu/fieldcrop), fruits pests (such as fruit flies, codling moth, controlling apple pests, grape insects, green fruitworms, and leafhoppers, and see more examples on https://entomology.ca.uky.edu/fruit), vegetable pests (such as beet armyworms, cabbage insects, seedcorn maggots, and whiteflies, and see more examples on https://entomology.ca.uky.edu/vegetable), and liverstock pests (such as horn flies and cattle, and horse bots, and see more examples on https://entomology.ca.uky.edu/livestock). In some embodiments, compounds identified and compositions thereof may be useful in household pest control. Exemplary household pests include but are not limited to termites and cockroaches.

### DESCRIPTION OF THE FIGURES

The present application can be best understood by references to the following description taken in conjunction with the accompanying figures.

FIGS. 1A and 1B are representative images showing the mosquitoes landed on an attractive 37 C heat pad, by overlaying the photo frames taken over 5 minutes. FIG. 1A is the positive control where a filter paper with solvent acetone (air dried) is placed on top of the 37 C heat pad placed in a cage of 20 female Aedes aegypti mosquitoes. FIG. 1B is a filter paper with one of the identified repellents from Table A, dissolved at 3% concentration with acetone (air dried).

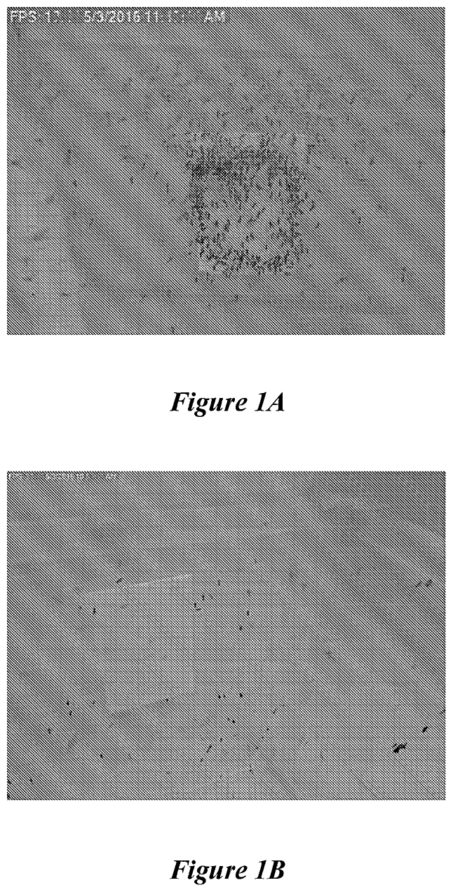

FIG. 2 shows percentage Mean repellency, compared to solvent control, of different test compounds at 3% (v/v or w/v in acetone) from Table A using the assay in FIG. 1. A horizontal line reflects 90% repellency. N=3 trials, ˜20 female Aedes aegypti/trial. Several fall above the horizontal line which reflects 90% repellency. The repellency data is used to generate partially the training set for the Machine Learning.

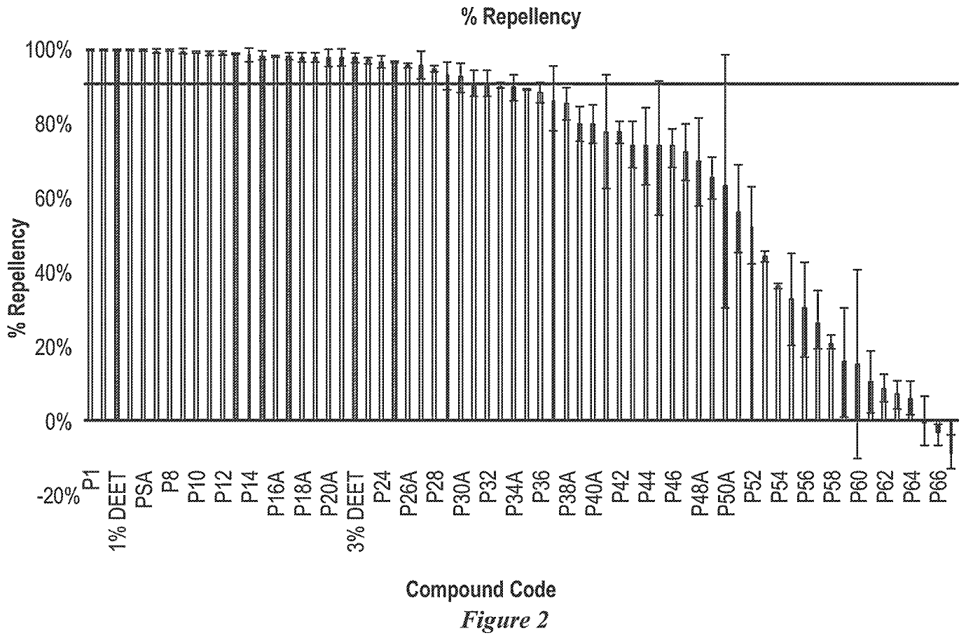

FIG. 3 shows percentage repellency, compared to solvent control, of different test compounds at 3% (v/v or w/v in acetone) from Table A and B using the assay in FIG. 1. N=1 trial, with ˜20 female Aedes aegypti. Several fall above the horizontal line which reflects 90% repellency. The compounds are randomly selected from repellent predictions in Table A and B performed by Machine Learning.

FIG. 4 illustrates mosquito behavioral assay glove setup. The assay glove is assembled in the following order: rubber glove with window cut into the hand, magnet glued around the cut window, control or test odor treatment mesh, three spacer magnets that prevent mosquitoes from biting through to the hand, untreated mesh to prevent mosquitoes from touching the treated mesh, and finally a top magnet. One metal clip is then used on each side of the stack to further reinforce the arrangement of magnets and mesh.

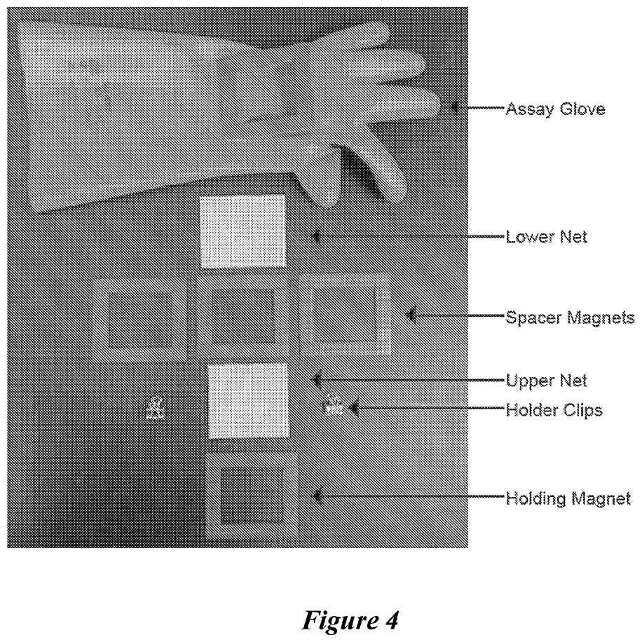

FIG. 5 shows a series of representative still photographs from specific time-points of video assaying landing of female Aedes aegypti on solvent treated and repellent treated netting in the hand-in-glove assay.

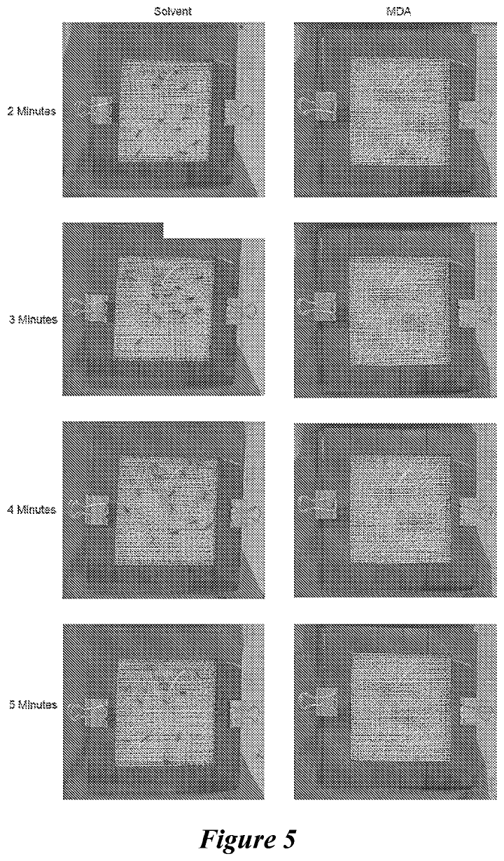

### DETAILED DESCRIPTION

As used herein and in the appended claims, the singular forms “a,” “and,” and “the” include plural referents unless the context clearly dictates otherwise. Thus, for example, reference to “an insect” includes a plurality of such insects and reference to “the compound” includes reference to one or more compounds, and so forth.

Unless defined otherwise, all technical and scientific terms used herein have the same meaning as commonly understood to one of ordinary skill in the art to which this disclosure belongs. Although any methods and reagents similar or equivalent to those described herein can be used in the practice of the disclosed methods and compositions, the exemplary methods and materials are now described.

The following description is presented to enable a person of ordinary skill in the art to make and use the various embodiments. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

### Screening Methods

Provided herein are screening methods for identifying one or more compounds that are natural repellents, e.g., as alternatives to DEET. Provided herein are also screening methods for identifying one or more compounds that are natural insecticides, e.g., the ones that are structurally similar to pyrethroid insecticides.

In some embodiments, chemical features that are predictive of repellency are identified and used to predict new chemicals from natural sources. In some embodiments, models rank the chemicals allowing for the selection of a smaller set of candidates that are suitable for experimental validation.

In some embodiments, structural features of known pyrethroid insecticides are used to develop models that predict new naturally sourced chemicals with insecticidal activity and therefore identifies several new potential insecticides.

Candidate Compounds

The screening methods provided herein may be used to screen one candidate compound or a plurality of candidate compounds. The one or more candidate compounds may be natural or synthetic compounds. For example, the one or more candidate compounds may be from bacterial, fungal, plant and animal extracts that are commercially available or readily produced. The one or more candidate compounds can also be chemically-modified compounds, such as by acylation, alkylation, esterification, or acidification of natural compounds. The one or more candidates compounds screened in the methods described herein may be pre-selected based on one or more criteria. For example, a set of compounds with structural similarities to known insect repellents, like DEET, may be screened and selected for use in the methods described herein. A computation method may be used to select such candidate compounds. Other criteria used for selecting the one or more candidate compounds include the environmental impact of the compounds, regulatory approval of the compounds for human consumption (e.g., FDA-approval), and the smell of the compounds (e.g., natural fragrances, aromas, or odors).

### Compounds Identified and Compositions Thereof

The following compounds have been identified using the methods and systems described herein. One or more of such identified compounds may be used in an insect repellent composition or a pesticide composition.

Insect Repellent Composition

In some embodiments, the compound identified as an insect repellent according to the methods and systems described herein are selected from Table A and Table B. In some aspects, provided are insect repellent compositions comprising one or more, two or more, or three or more compounds selected from Table A and Table B below.

In some embodiments, the compounds identified as an insect repellent according to the methods and systems described herein consist of core structures that are conserved in the structures of several compounds.

In some embodiments, the compounds identified have a core structure selected from the groups of Table A.1 or Table A.2 and are conserved in the structure of compounds selected from Table A.

In some embodiments, the compounds have a core structure selected from the group consisting of

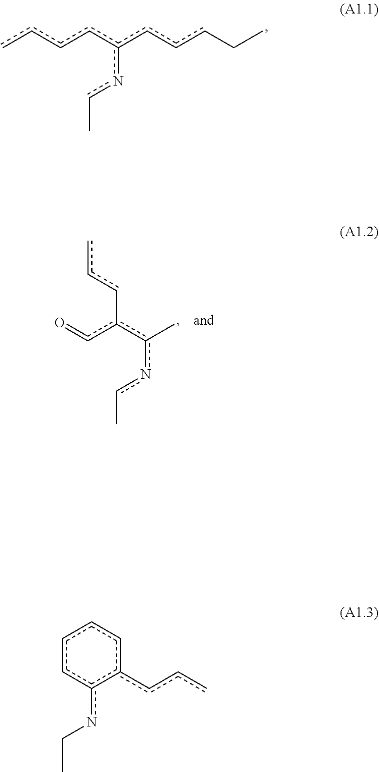

from Table A.2. In some embodiments, the compounds have a core structure of

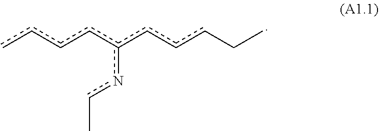

In some embodiments, the compound is selected from the group consisting of

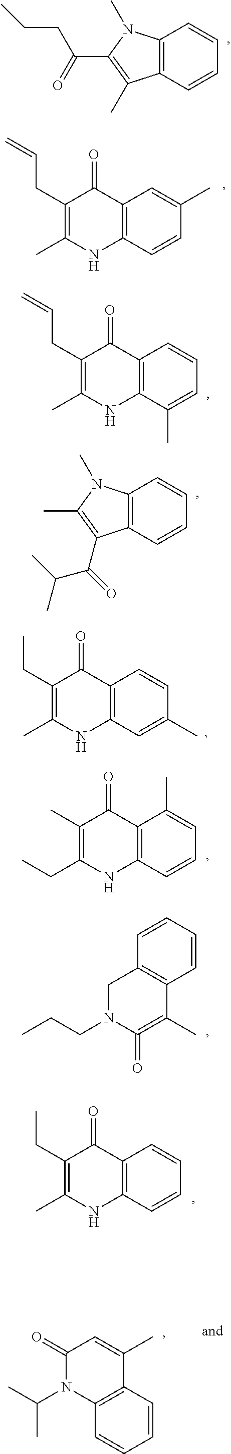

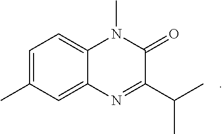 [SMILES: Cc1ccc2c(c1)nc(C(C)C)c(=O)n2C]

In some embodiments, the compounds have a core structure of

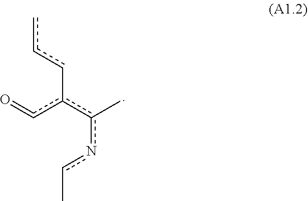

In some embodiments, the compound is selected from the group consisting of

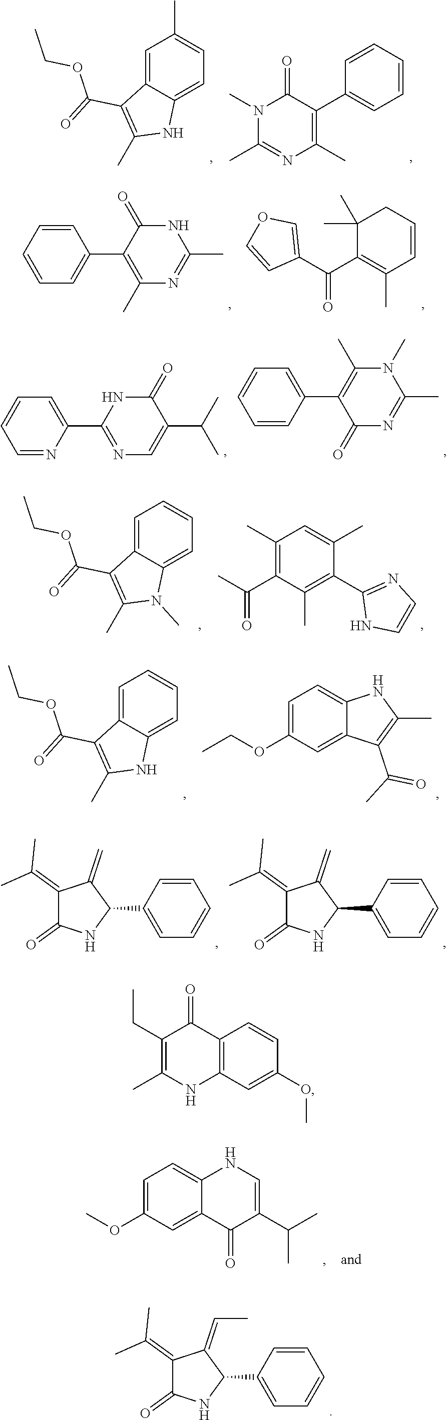

In some embodiments, the compounds have a core structure of

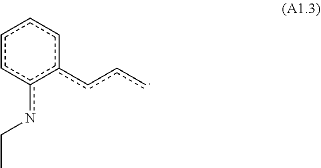

In some embodiments, the compound is selected from the group consisting of

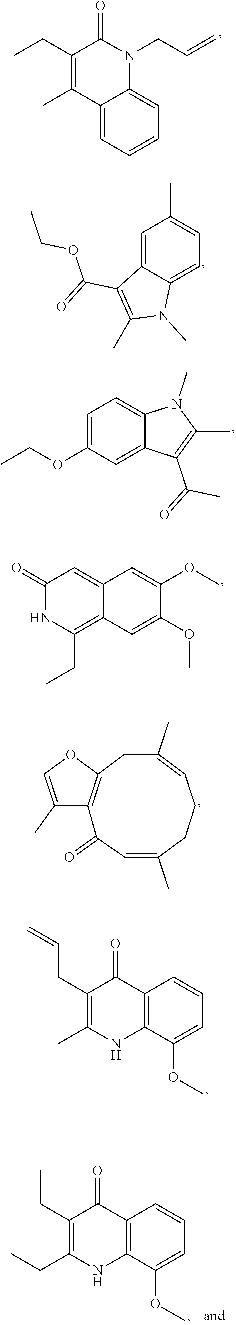

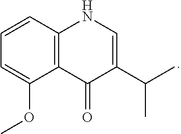 [SMILES: COc1cccc2[nH]cc(C(C)C)c(=O)c12]

In some embodiments, the compounds have a core structure selected from the group consisting of

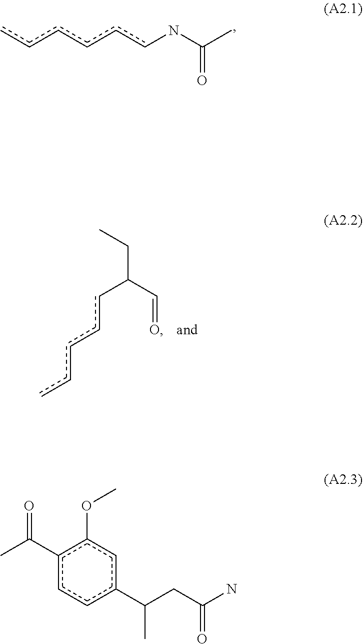

from Table A.2. In some embodiments, the compounds have a core structure of

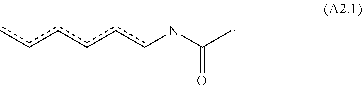

In some embodiments, the compound is selected from the group consisting of

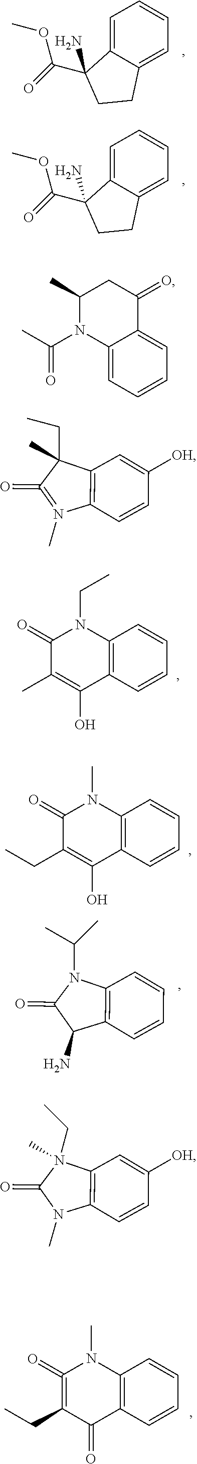

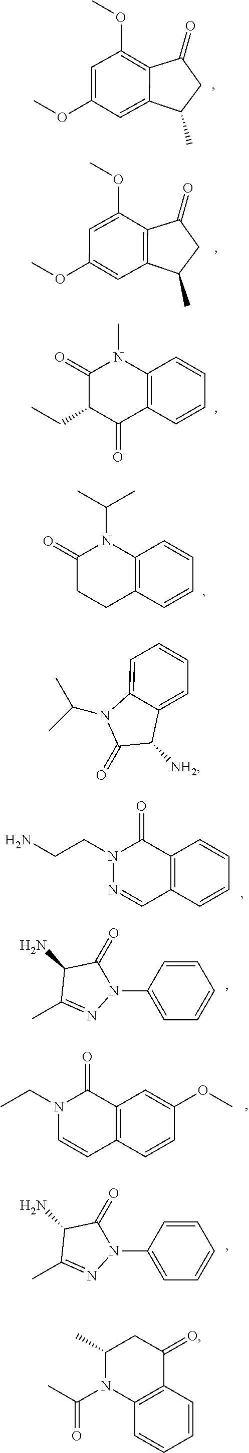

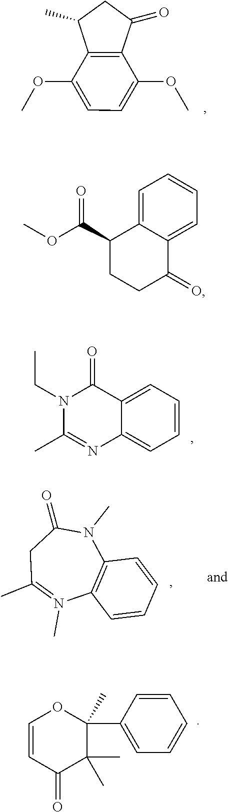

In some embodiments, the compounds have a core structure of

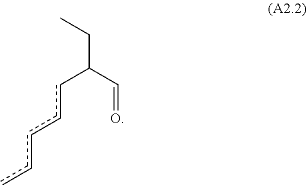

In some embodiments, the compound is selected from the group consisting of

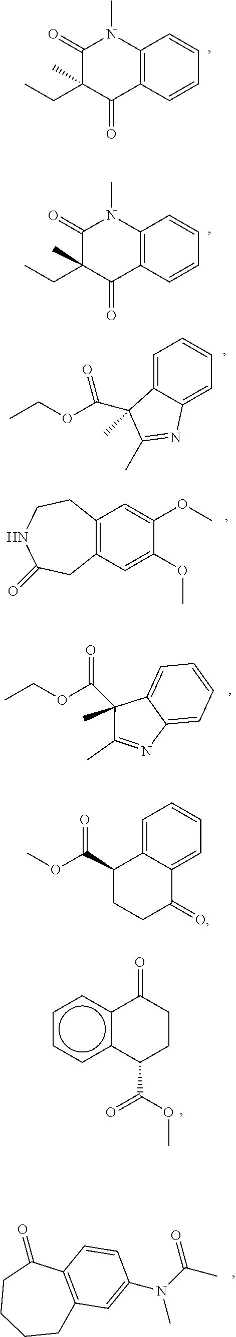

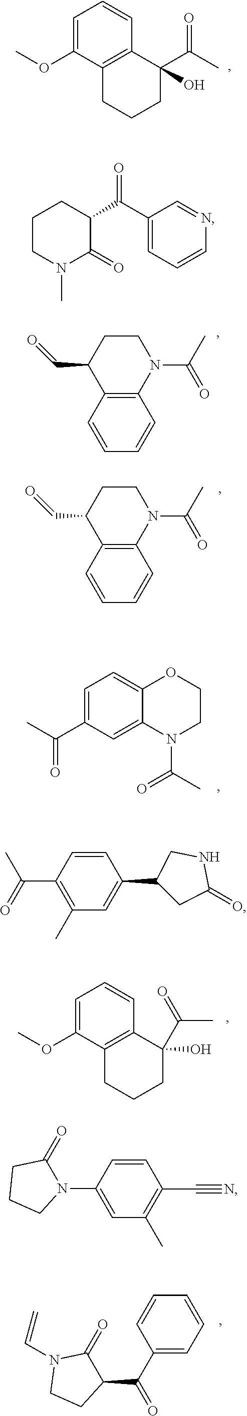

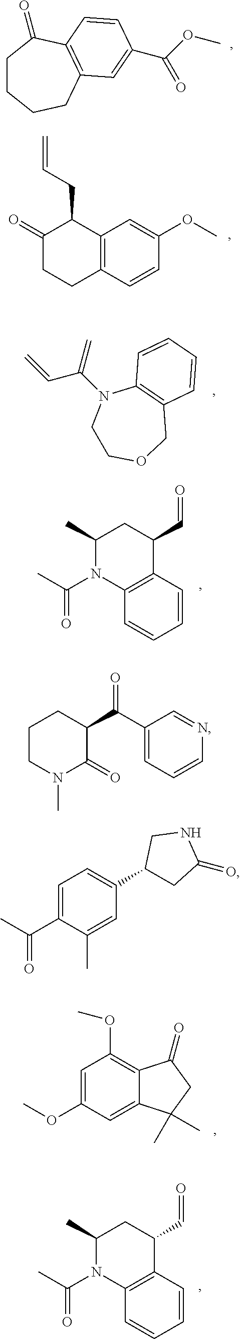

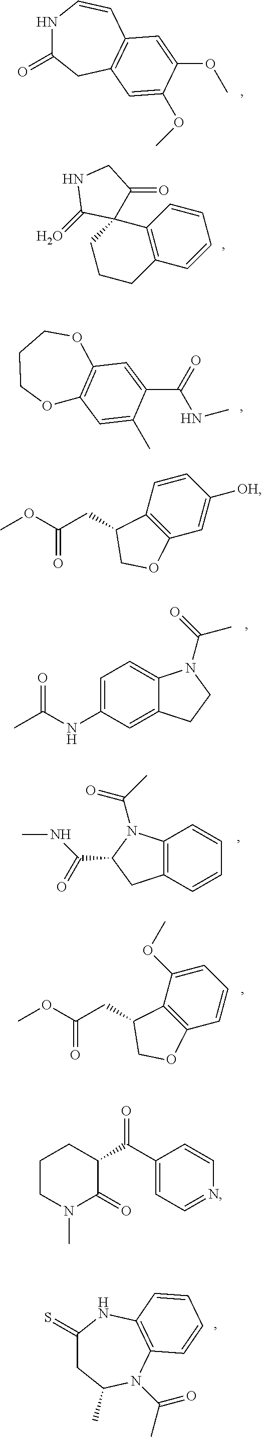

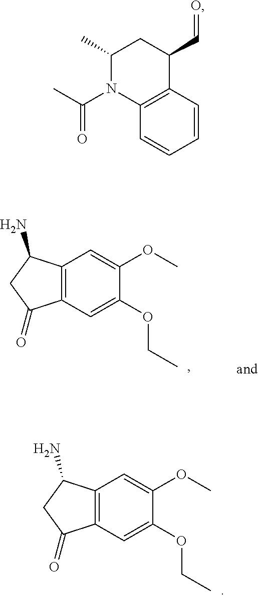 [SMILES: CC(=O)N1c2ccccc2[C@H](C=O)C[C@H]1C ; CCOc1cc2c(cc1OC)[C@H](N)CC2=O ; CCOc1cc2c(cc1OC)[C@@H](N)CC2=O]

In some embodiments, the compounds have a core structure of

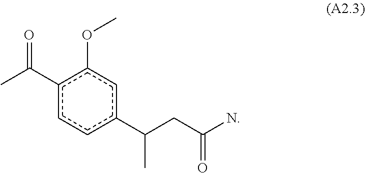

In some embodiments, the compound is selected from the group consisting of

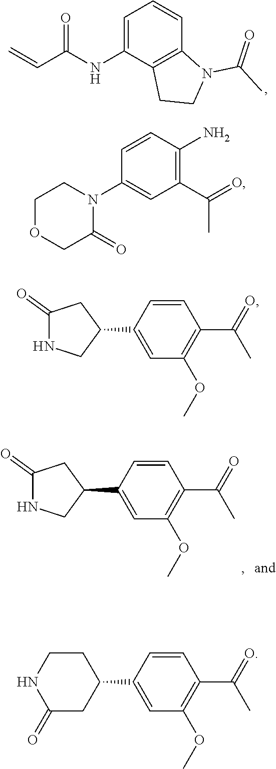

In some embodiments, the compounds have a core structure selected from the group consisting of

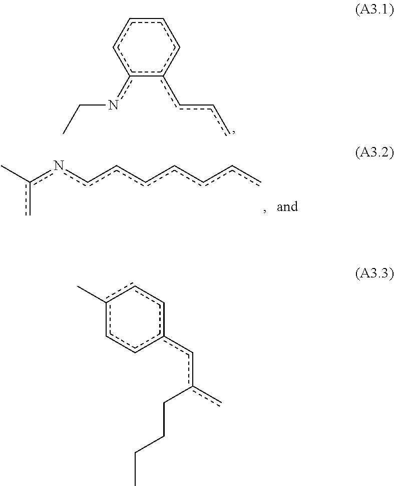

from Table A.2. In some embodiments, the compounds have a core structure of

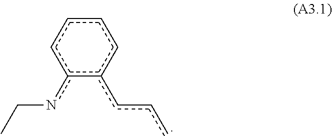

In some embodiments, the compound is selected from the group consisting of

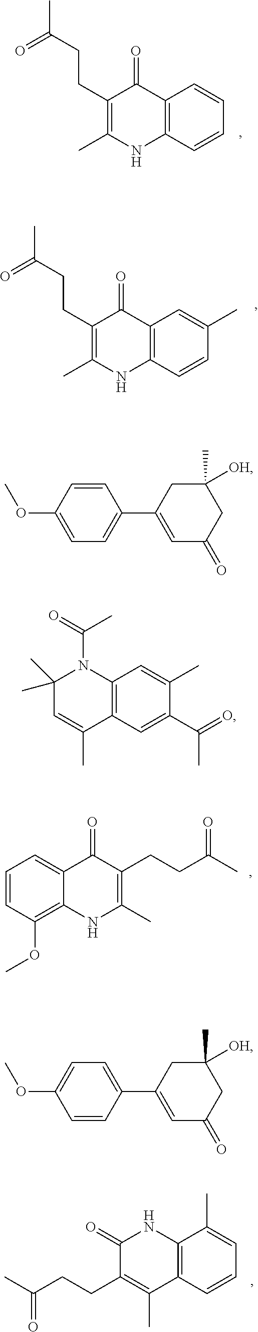

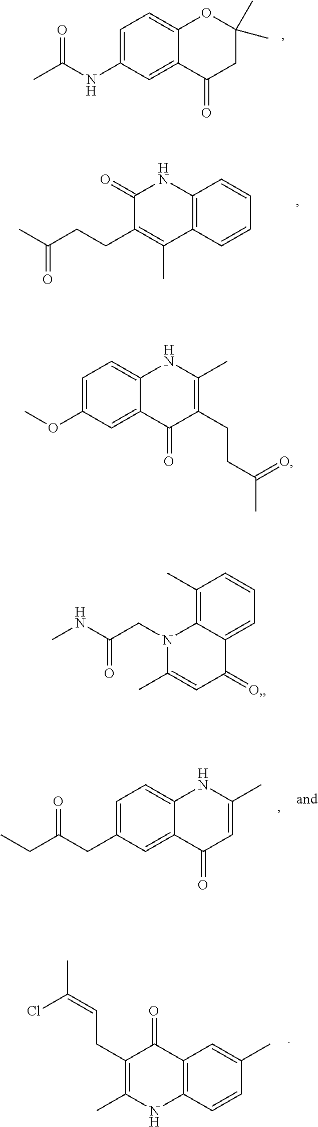

In some embodiments, the compounds have a core structure of

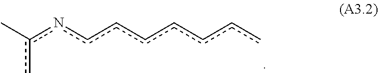

In some embodiments, the compound is selected from the group consisting of

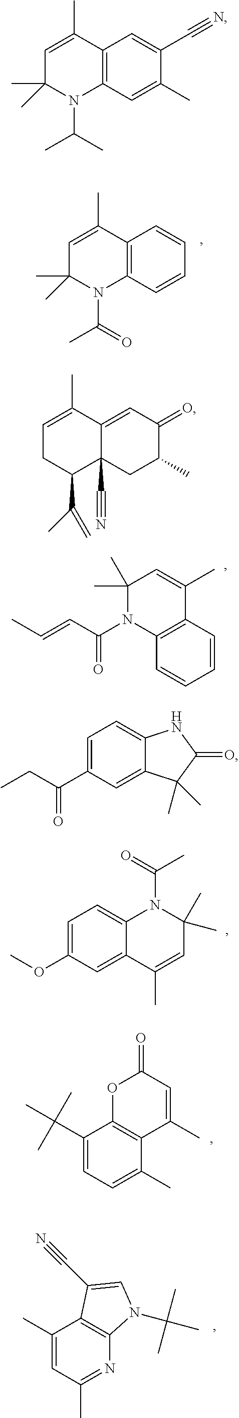

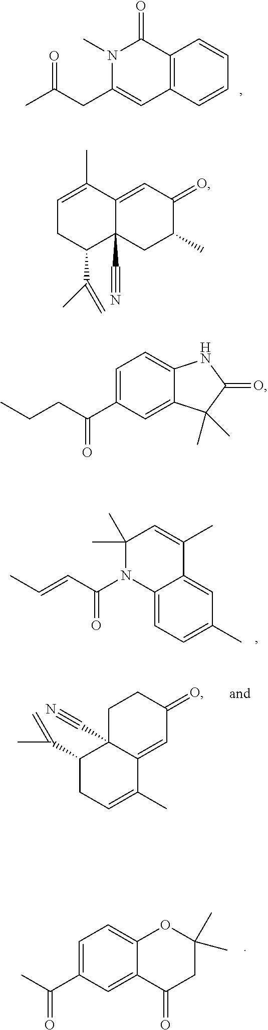

In some embodiments, the compounds have a core structure of

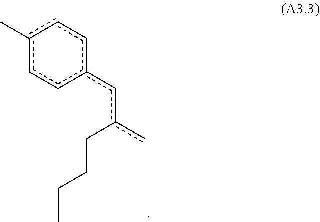

In some embodiments, the compound is selected from the group consisting of

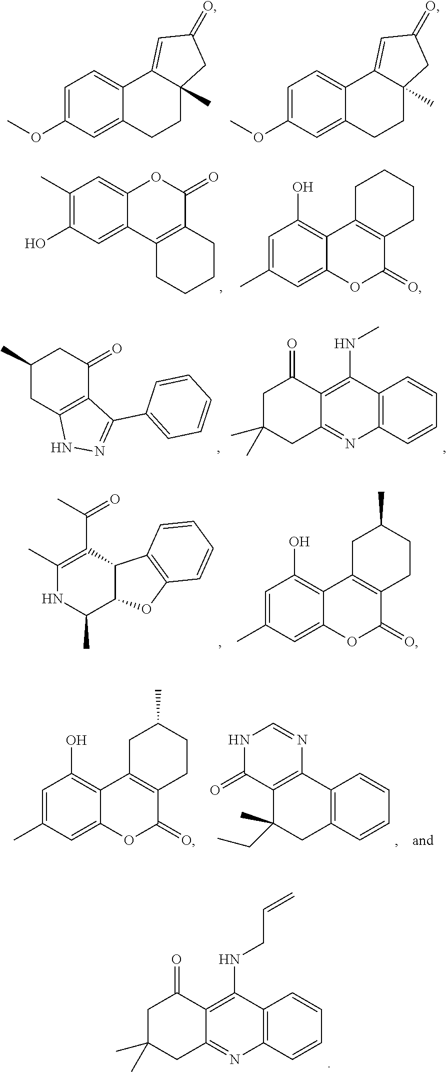

In some embodiments, the compounds have a core structure selected from the group consisting of

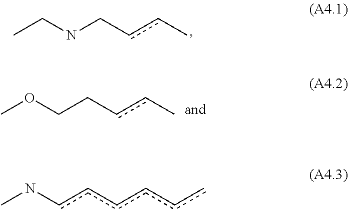

from Table A.2. In some embodiments, the compounds have a core structure of

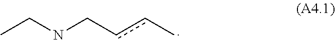

In some embodiments, the compound is selected from the group consisting of

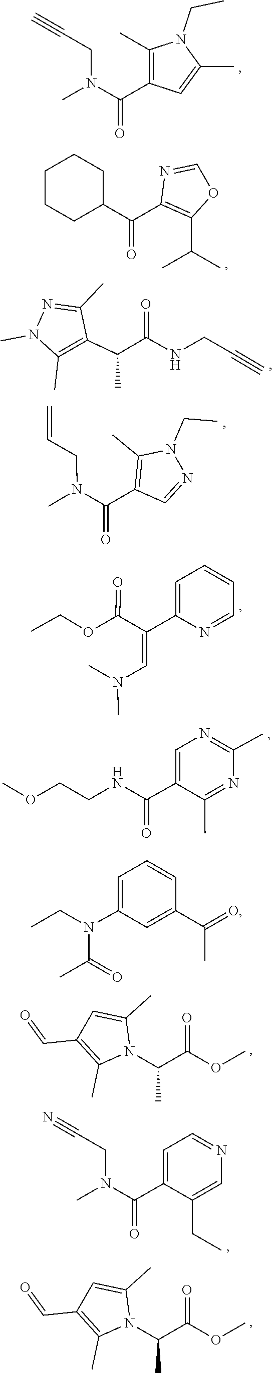

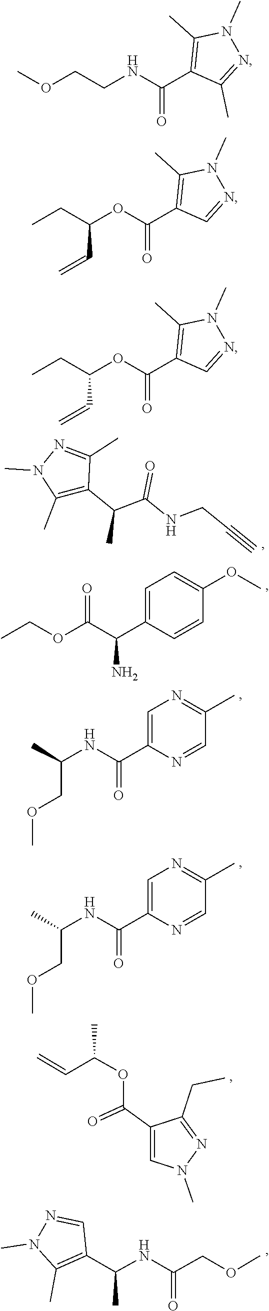

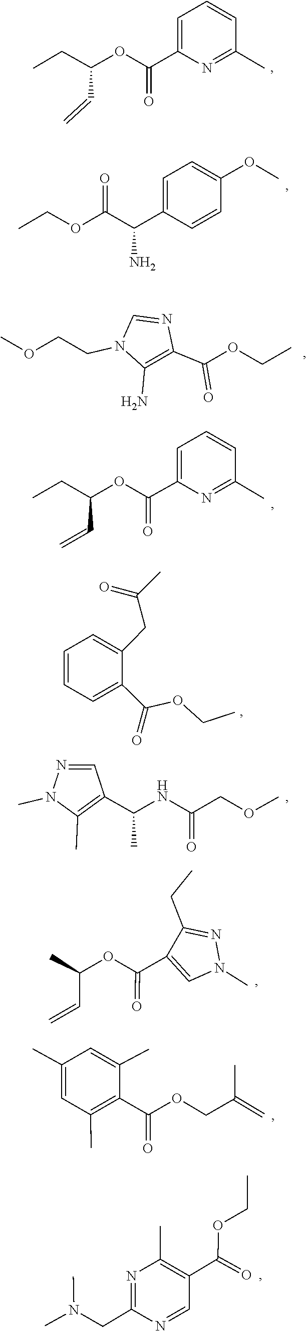

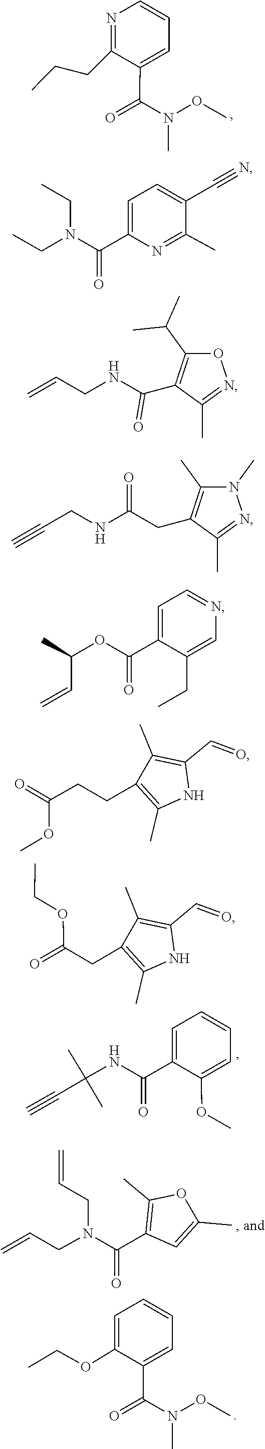

In some embodiments, the compounds have a core structure of

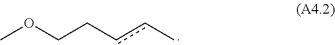

In some embodiments, the compound is selected from the group consisting of

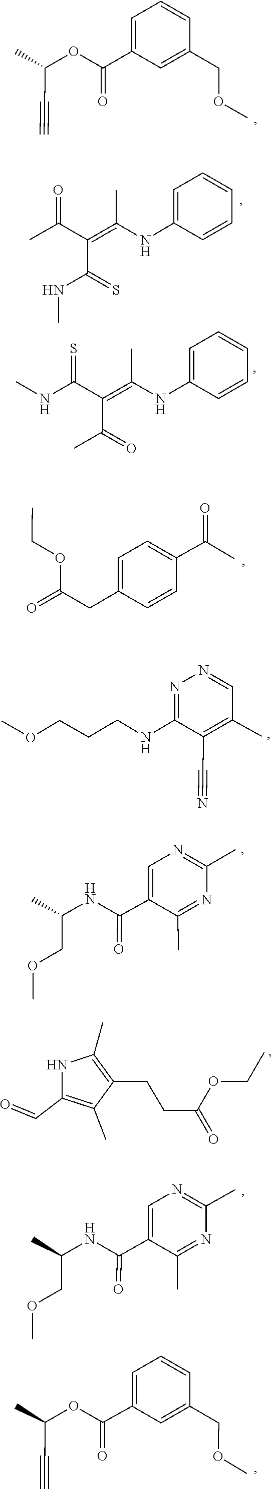

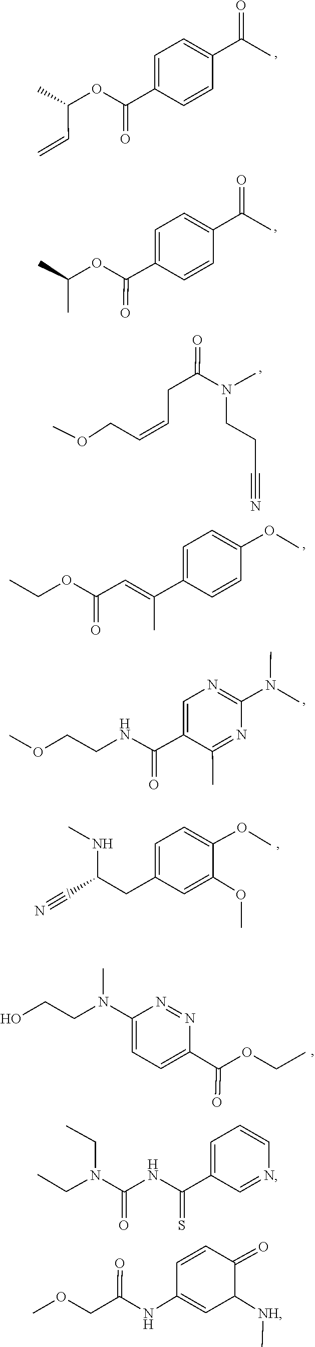

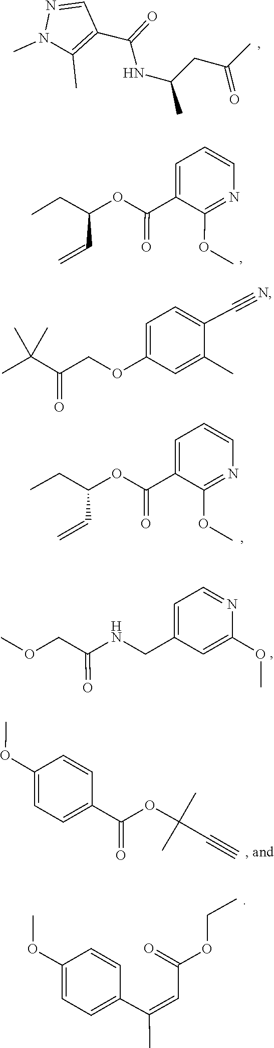

In some embodiments, the compounds have a core structure of

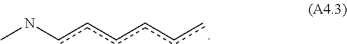

In some embodiments, the compound is selected from the group consisting of

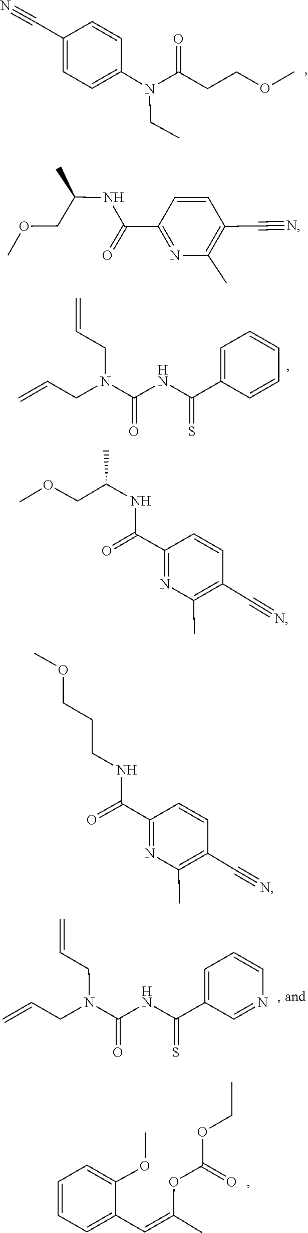

In some embodiments, the compounds have a core structure selected from the group consisting of

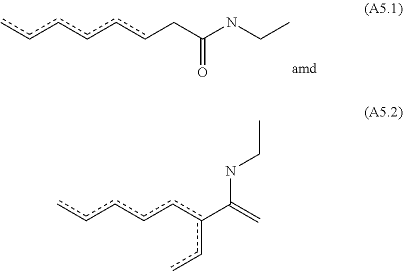

from Table A.2. In some embodiments, the compounds have a core structure of

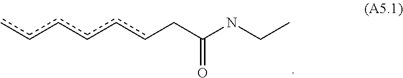

In some embodiments, the compound is selected from

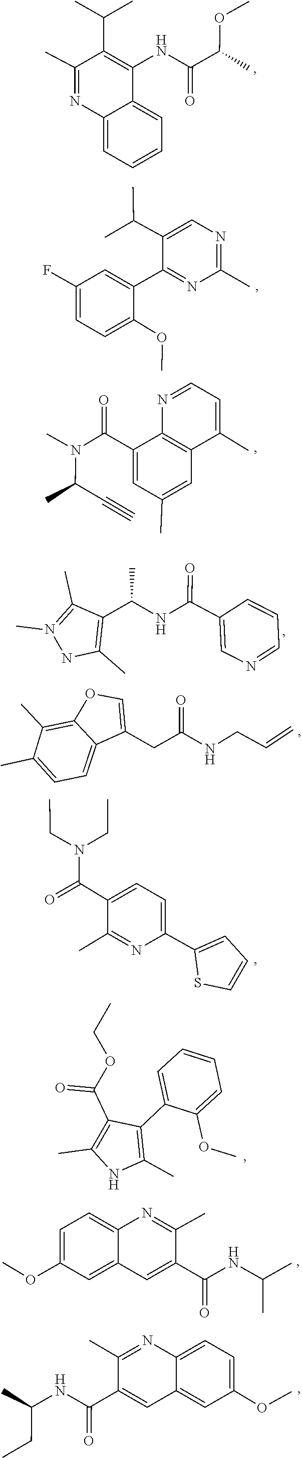

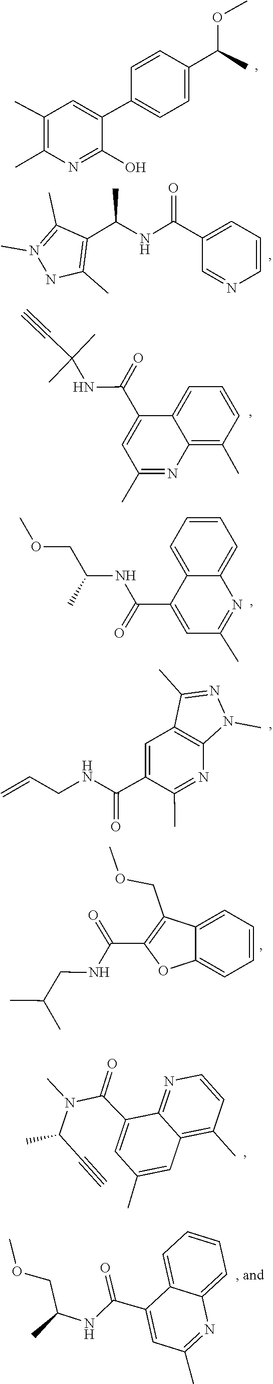

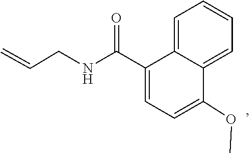 [SMILES: C=CCNC(=O)c1ccc(OC)c2ccccc12]

In some embodiments, the compounds have a core structure of

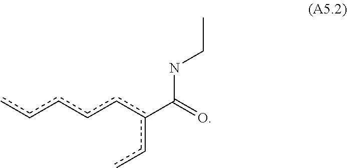

In some embodiments, the compound is selected from the group consisting of

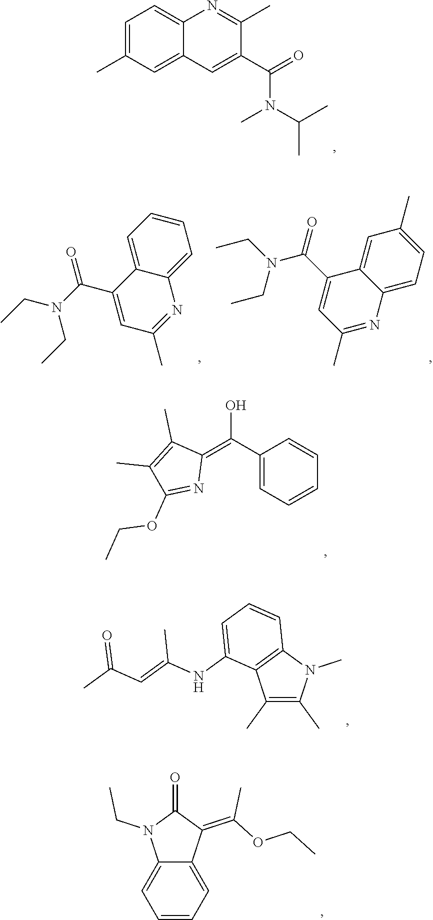

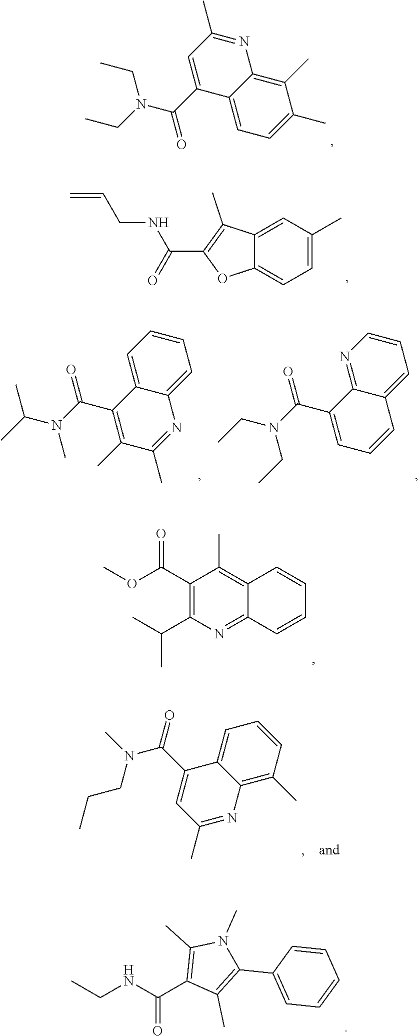

In some embodiments, the compound is

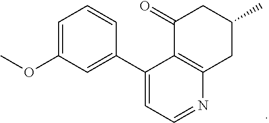

In some embodiments, the compounds have a core structure selected from the group consisting of

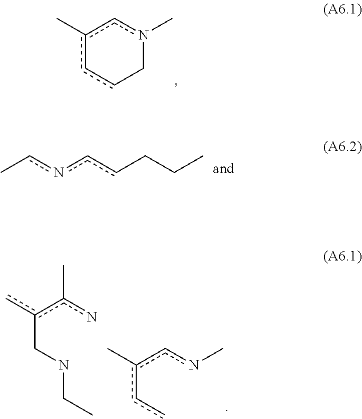

(A6.3) from Table A.2. In some embodiments, the compounds have a core structure of

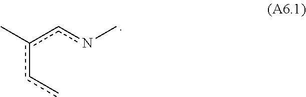

In some embodiments, the compound is selected from the group consisting of

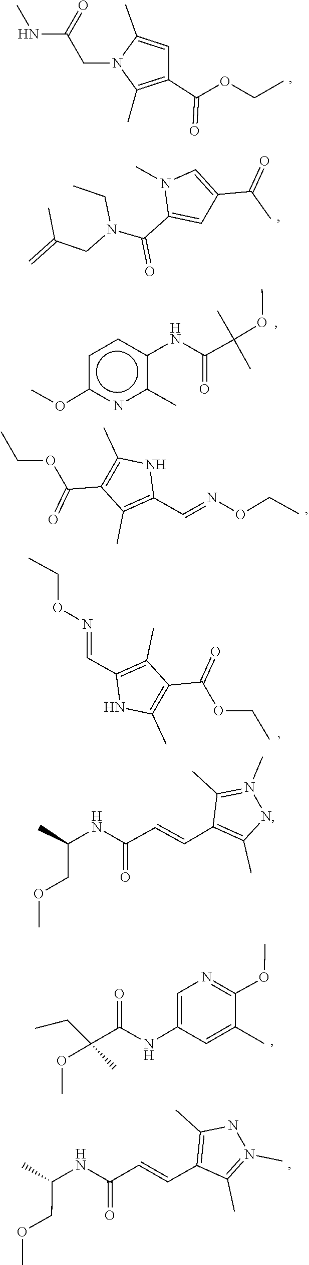

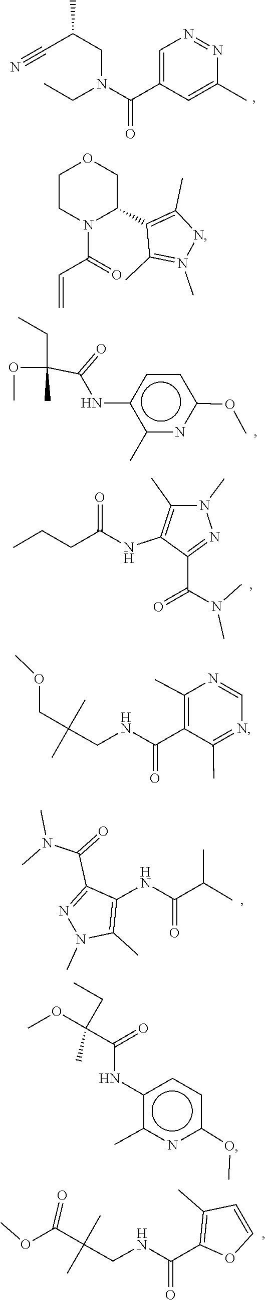

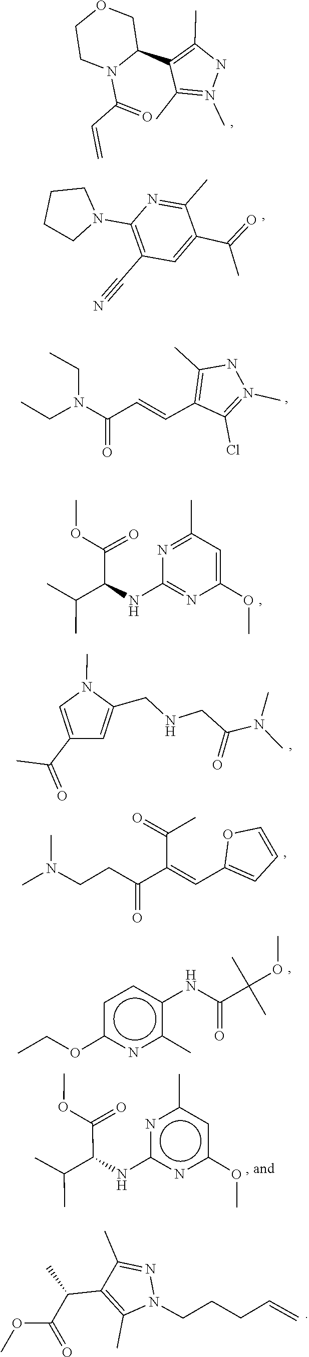

In some embodiments, the compounds have a core structure of

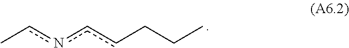

In some embodiments, the compound is selected from the group consisting of

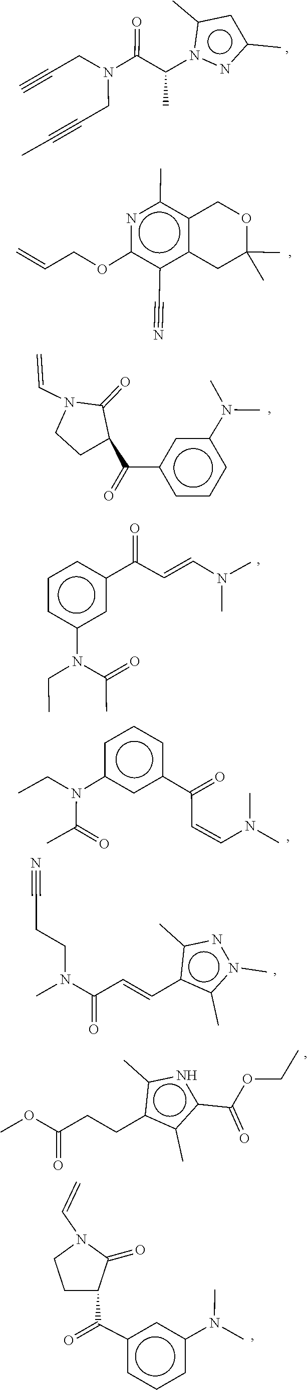

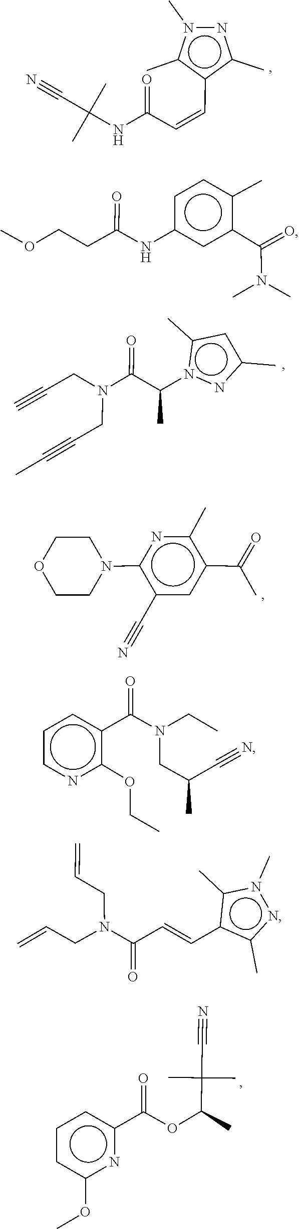

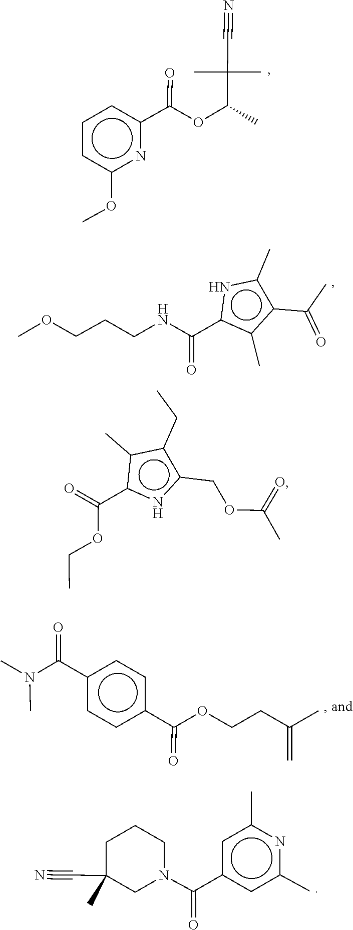

In some embodiments, the compounds have a core structure of

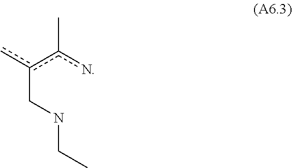

In some embodiments, the compound is selected from

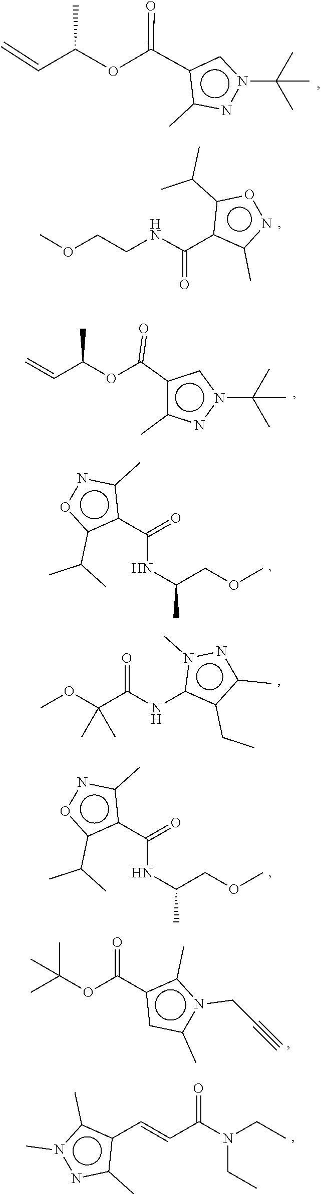

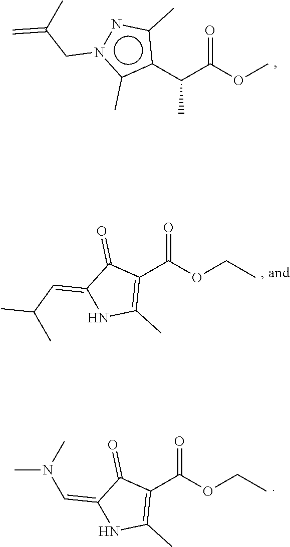

In some embodiments, the compounds have a core structure selected from the group consisting of

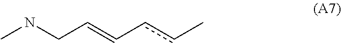

from Table A.2. In some embodiments, the compounds have a core structure of

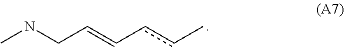

In some embodiments, the compound is selected from the group consisting of

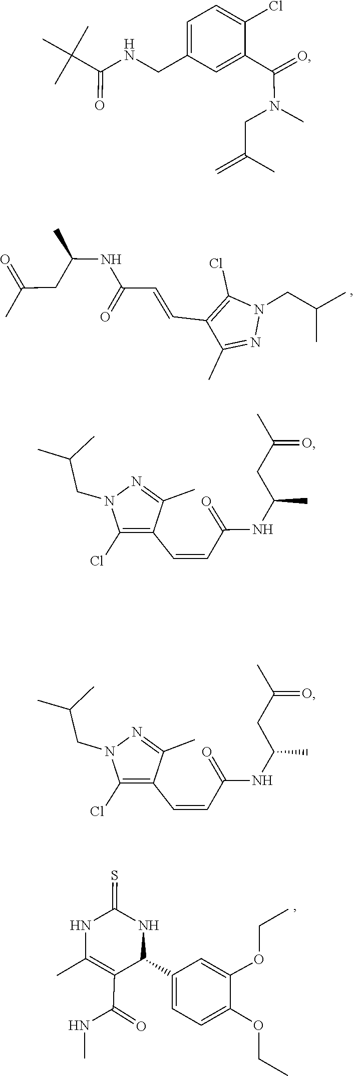

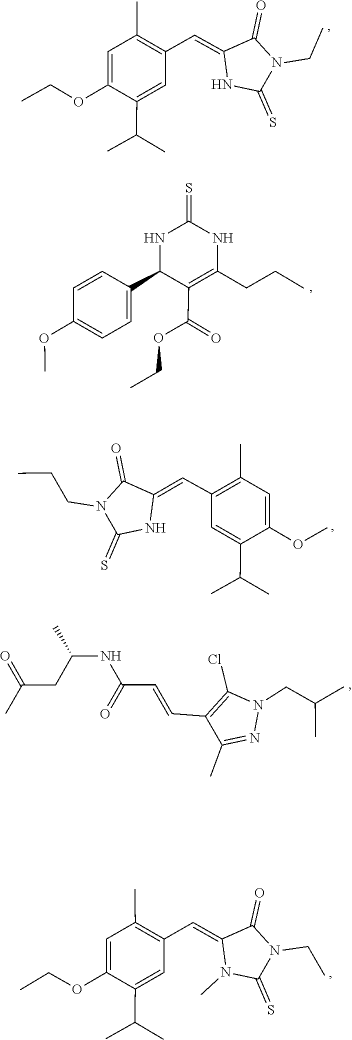

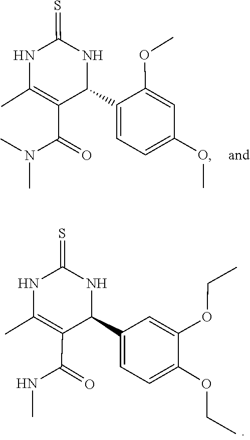

In some embodiments, the compounds have a core structure selected from the group consisting of

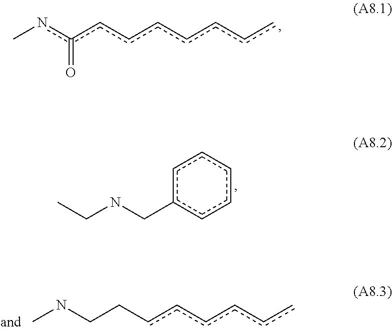

from Table A.2. In some embodiments, the compounds have a core structure of

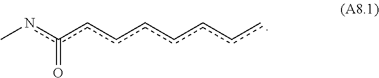

In some embodiments, the compound is selected from the group consisting of

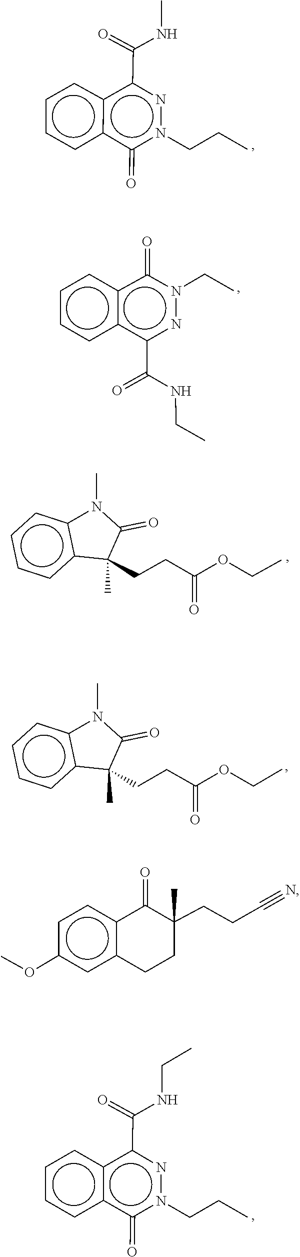

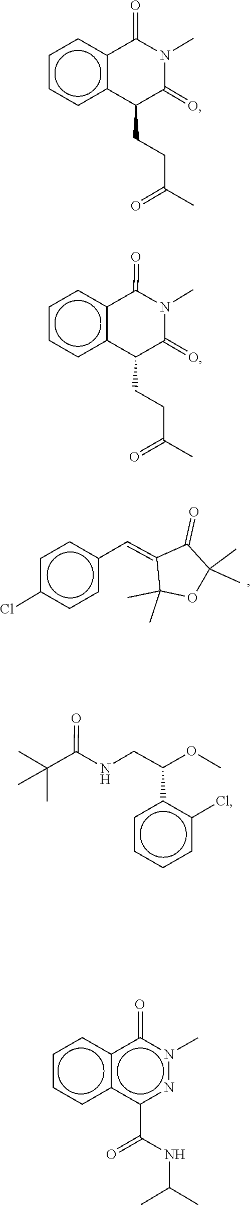

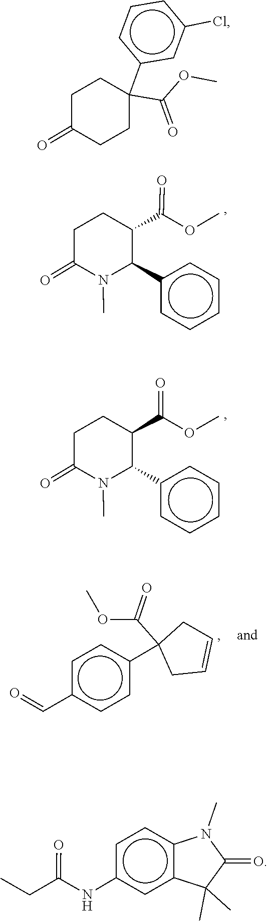

In some embodiments, the compounds have a core structure of

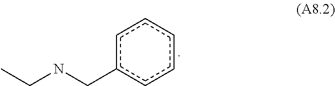

In some embodiments, the compound is selected from the group consisting of

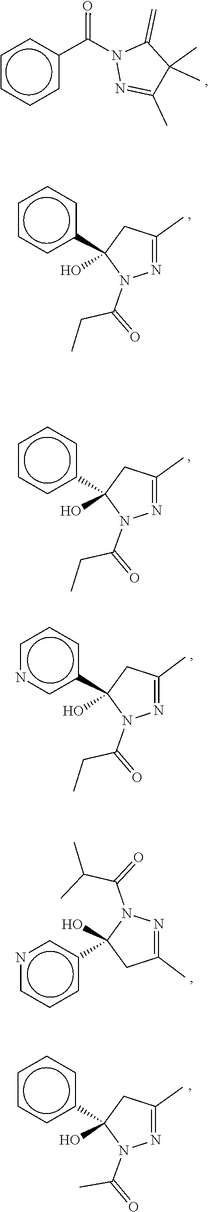

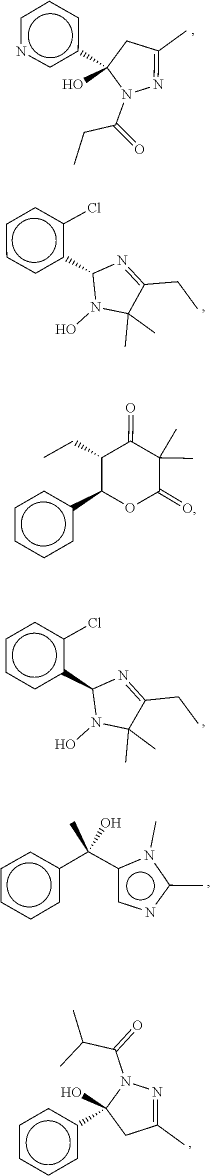

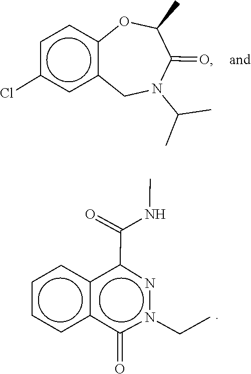

In some embodiments, the compounds have a core structure of

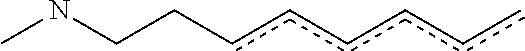

(A8.3). In some embodiments, the compound is selected from the group consisting of

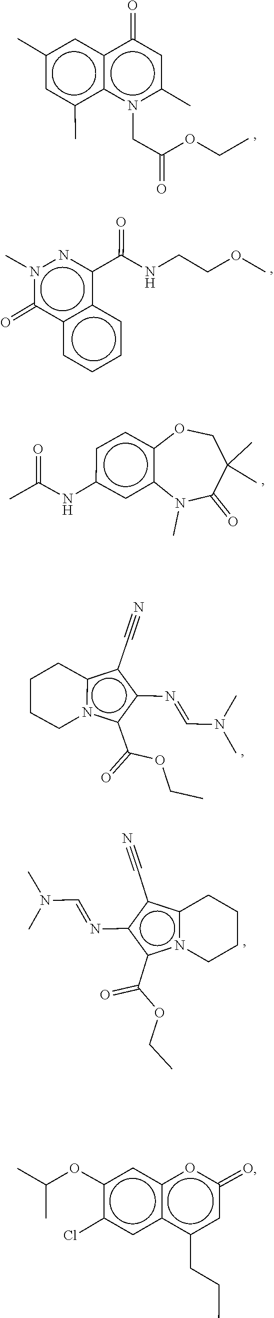

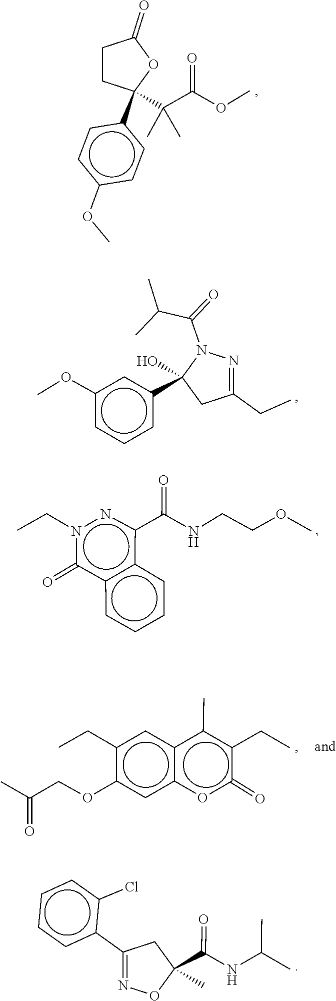

In some embodiments, the compounds have a core structure selected from the group consisting of

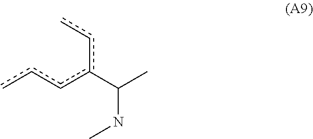

from Table A.2. In some embodiments, the compounds have a core structure of

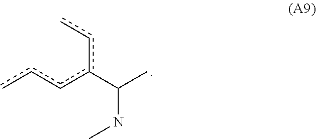

In some embodiments, the compound is selected from the group consisting of s ci

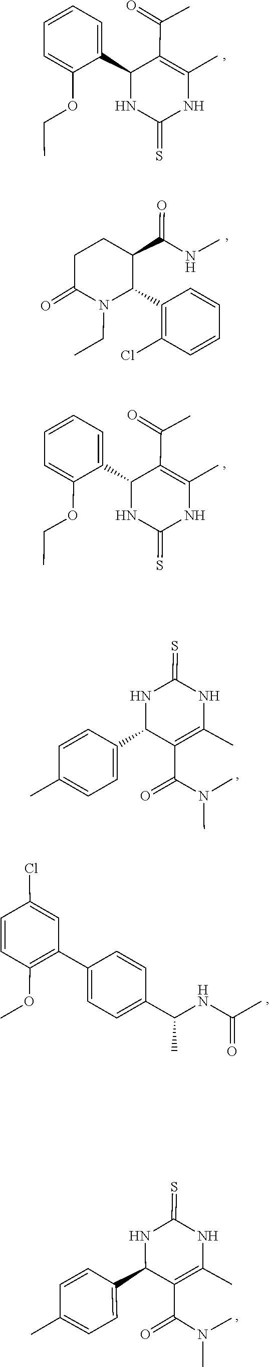

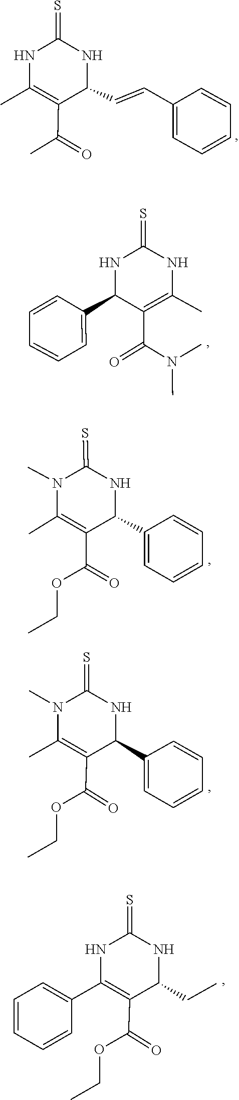

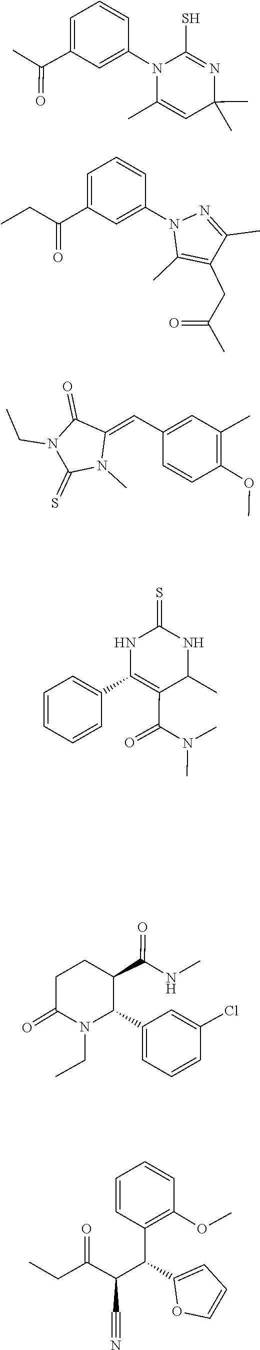

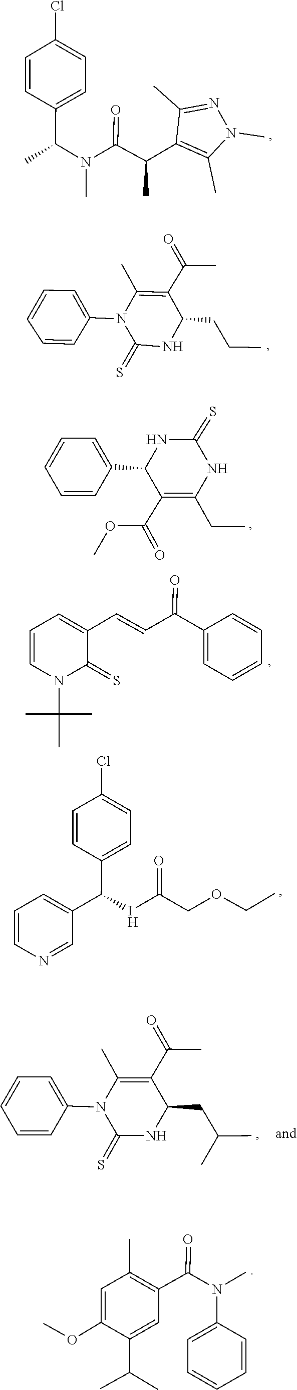

In some embodiments, the compounds have a core structure selected from the group consisting of

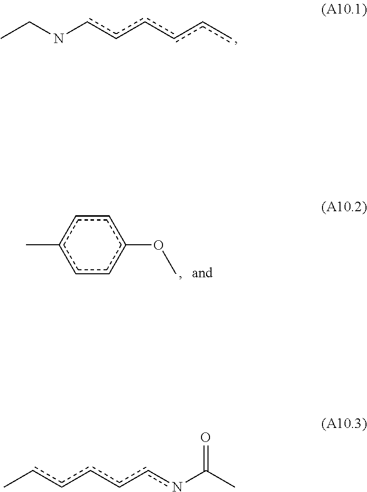

from Table A.2. In some embodiments, the compounds have a core structure of

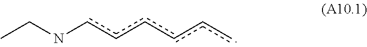

In some embodiments, the compound is selected from the group consisting of

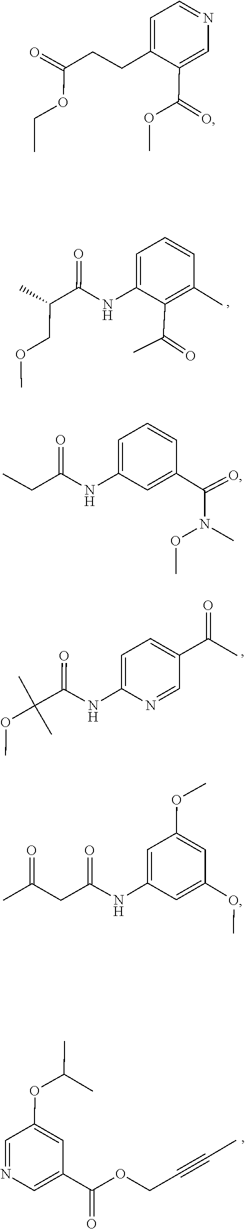

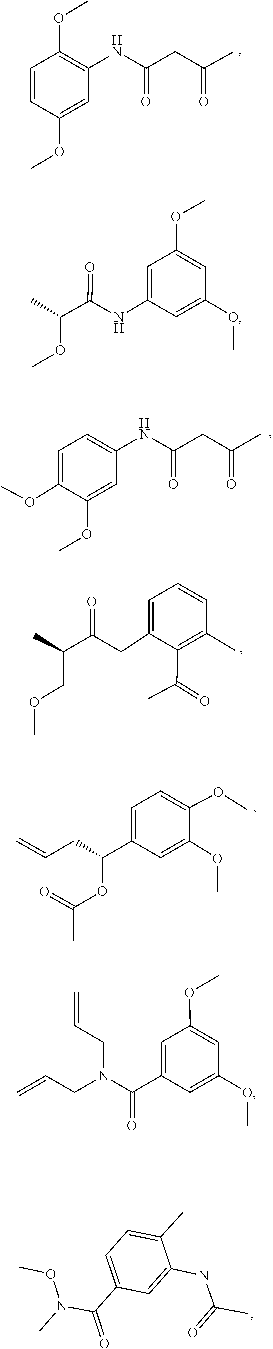

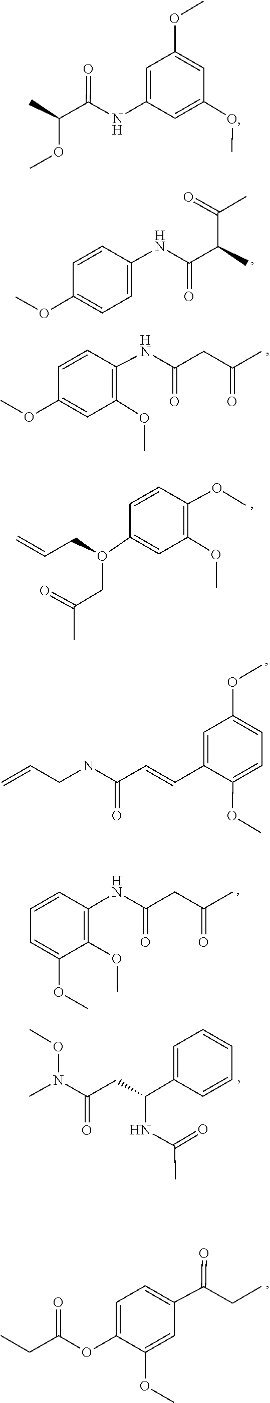

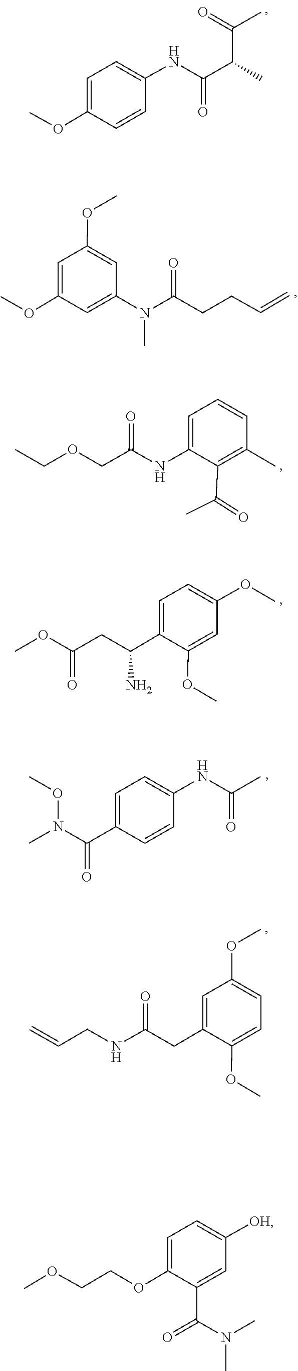

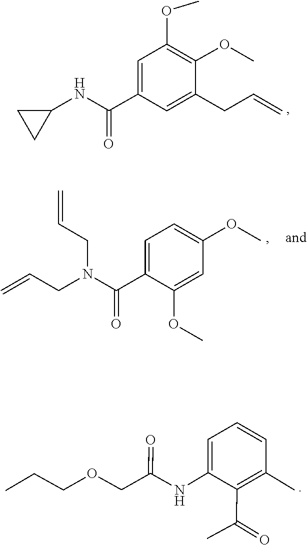

In some embodiments, the compounds have a core structure of

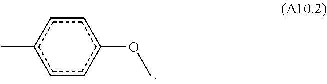

In some embodiments, the compound is selected from

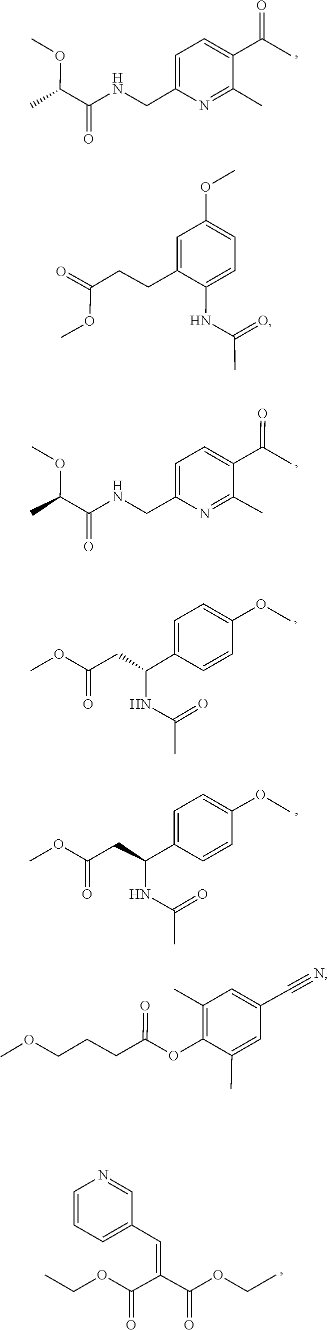

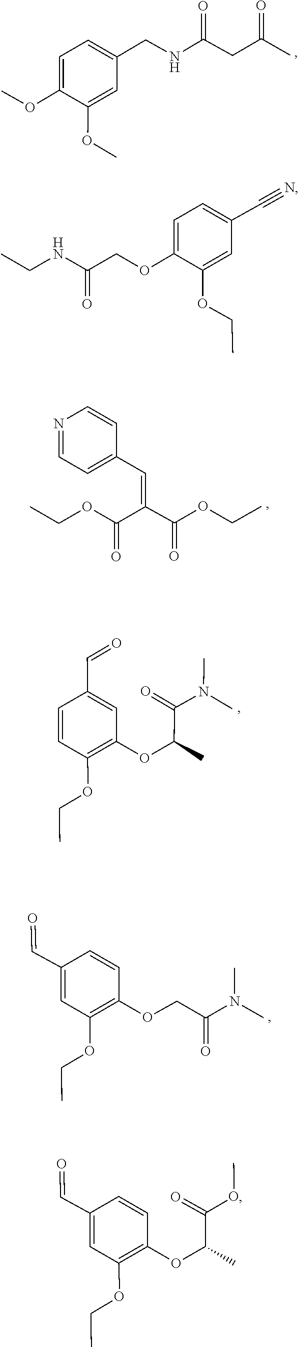

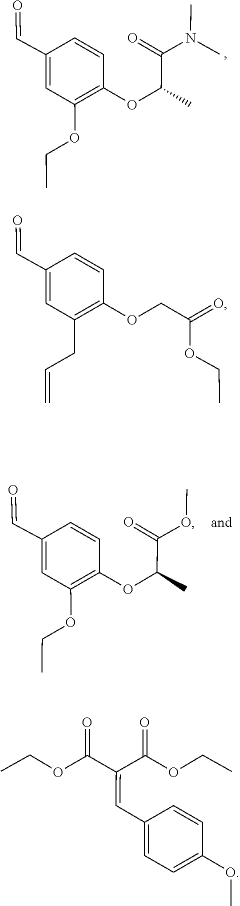

In some embodiments, the compounds have a core structure of

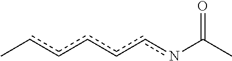

(A10.3). In some embodiments, the compound is selected from the group consisting of

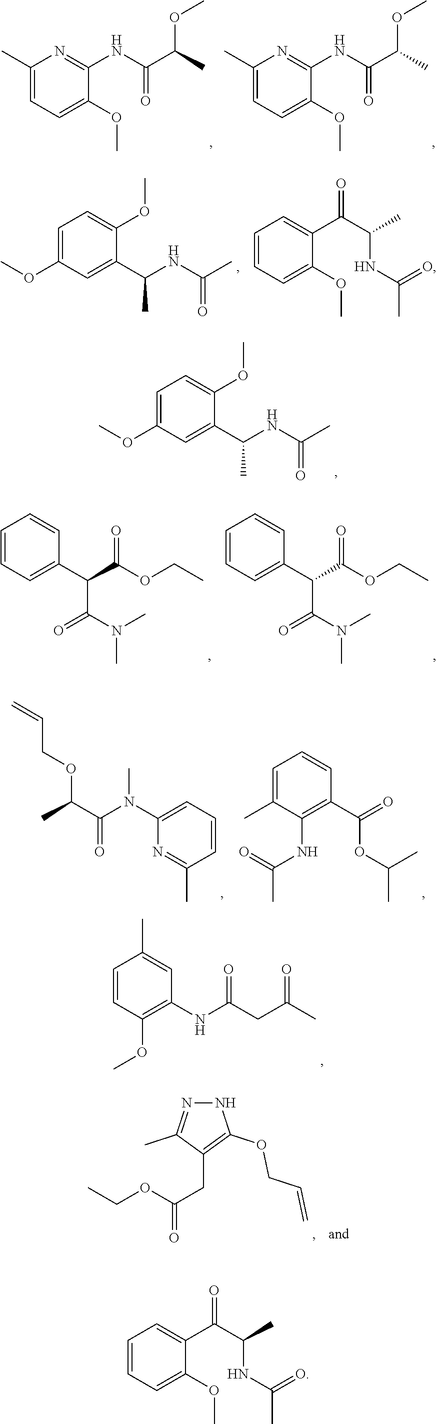

In some embodiments, the compounds have a core structure selected from the group consisting of

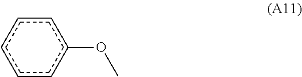

from Table A.2. In some embodiments, the compounds have a core structure of

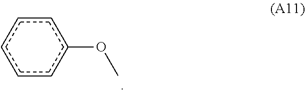

In some embodiments, the compound is selected from the group consisting of

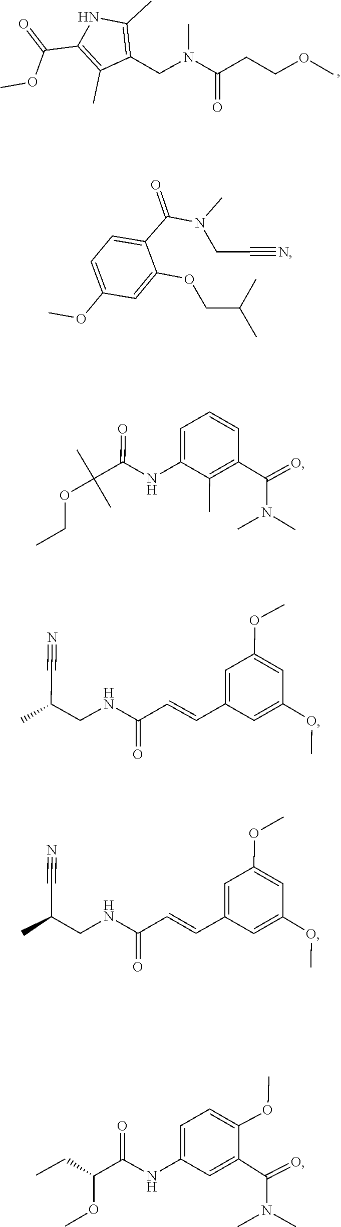

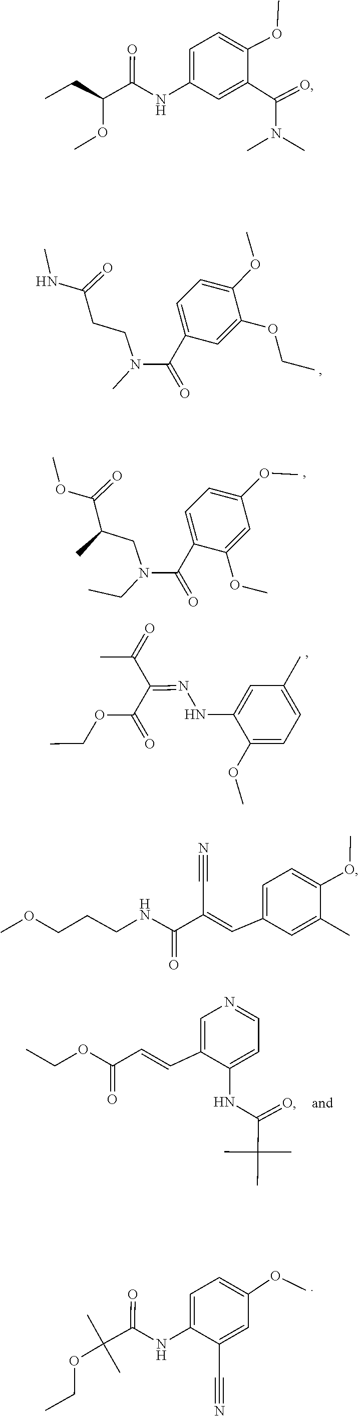

In some embodiments, the compounds have a core structure selected from the group consisting of

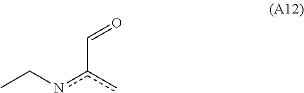

from Table A.2. In some embodiments, the compounds have a core structure of

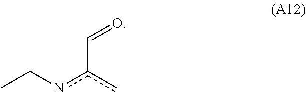

In some embodiments, the compound is selected from the group consisting of

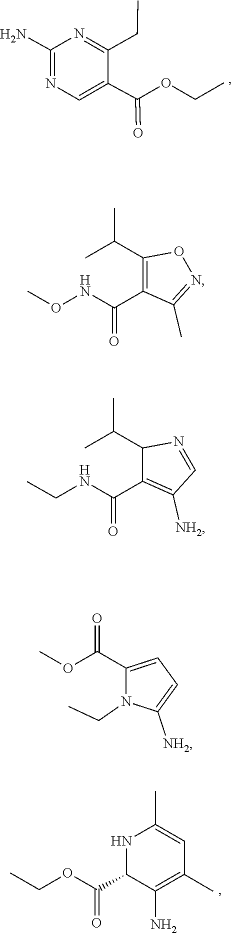

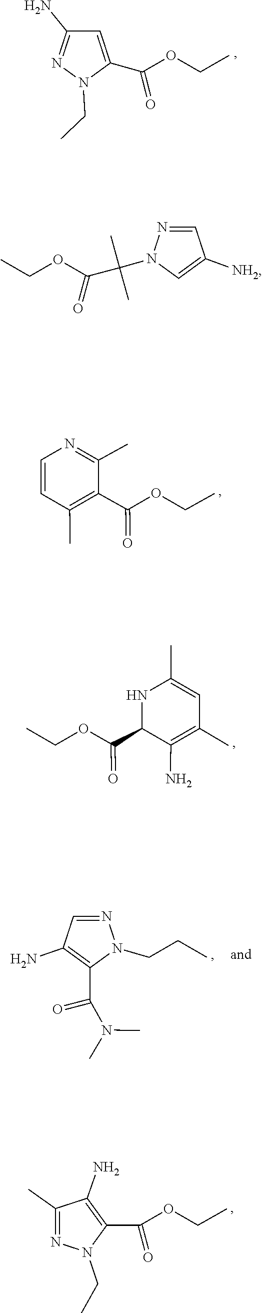

In some embodiments, the compounds have a core structure selected from the group consisting of

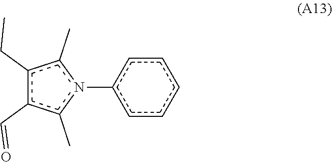

from Table A.2. In some embodiments, the compounds have a core structure of

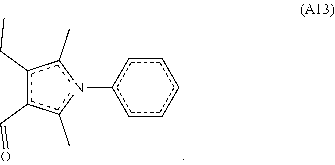

In some embodiments, the compound is selected from the group consisting of

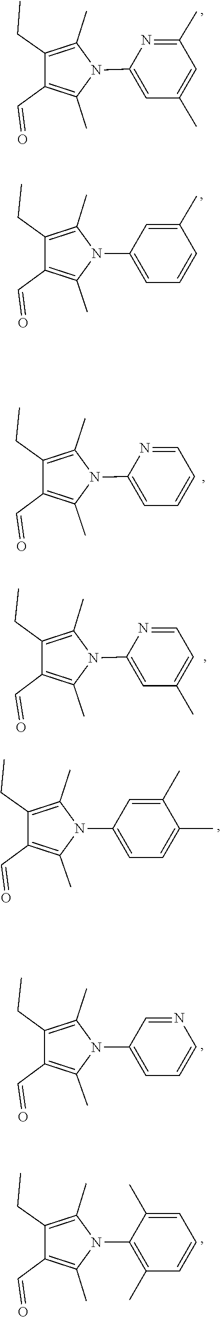

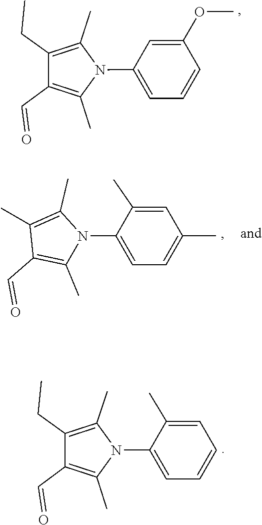

In some embodiments, the compounds have a core structure selected from the group consisting of

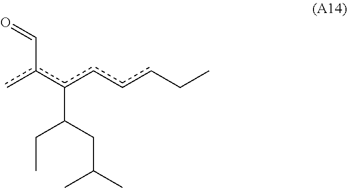

from Table A.2. In some embodiments, the compounds have a core structure of

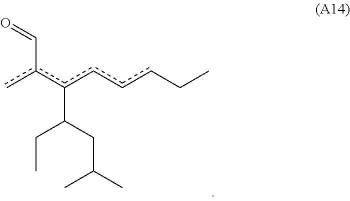

In some embodiments, the compound is selected from the group consisting of

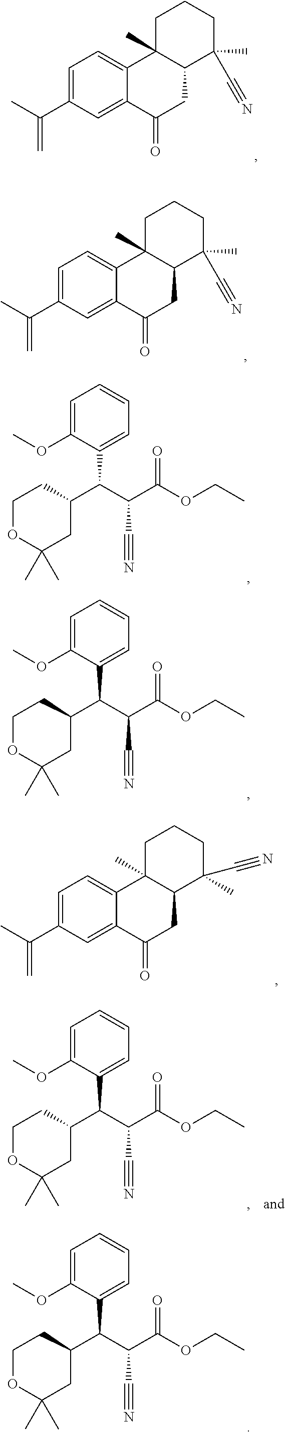

In some embodiments, the compounds have a core structure selected from the group consisting of

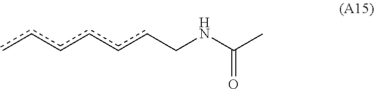

from Table A.2. In some embodiments, the compound is selected from the group consisting of

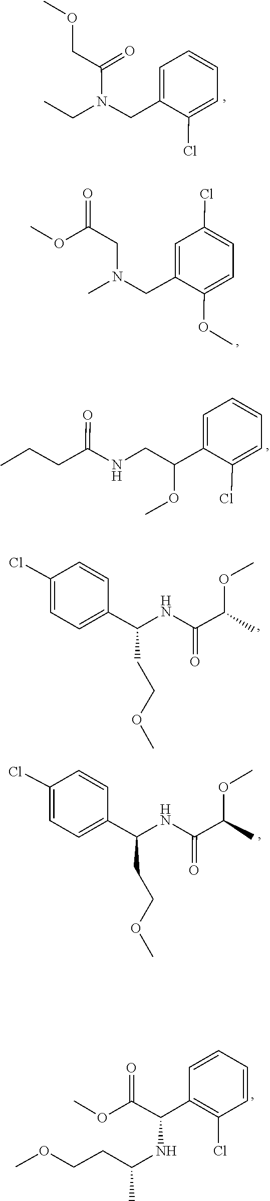

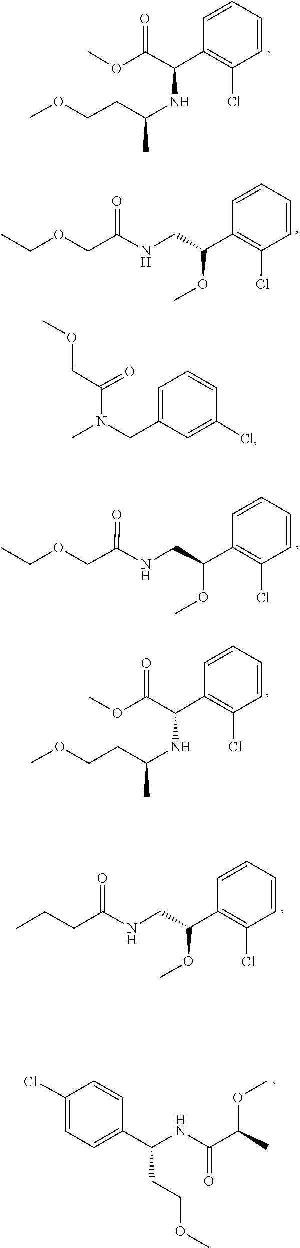

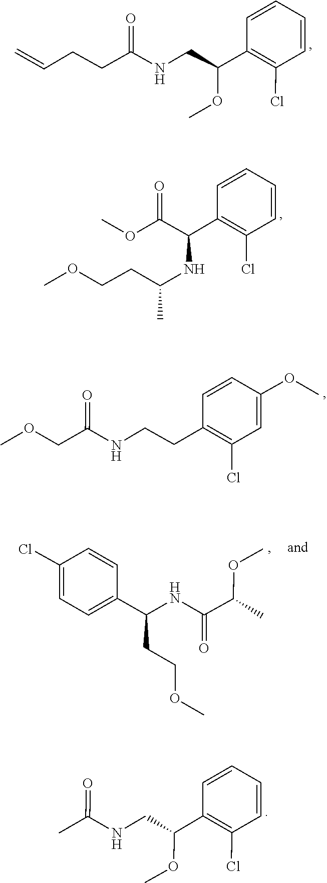

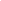

In some embodiments, the compounds identified have a core structure selected from the groups of Table B.1 or Table B.2 and conserved in the structure of compounds selected from Table B.

In some embodiments, the compounds have a core structure selected from the group consisting of

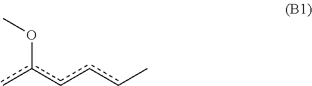

from Table B.2. In some embodiments, the compounds have a core structure of

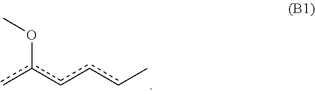

In some embodiments, the compound is selected from the group consisting of

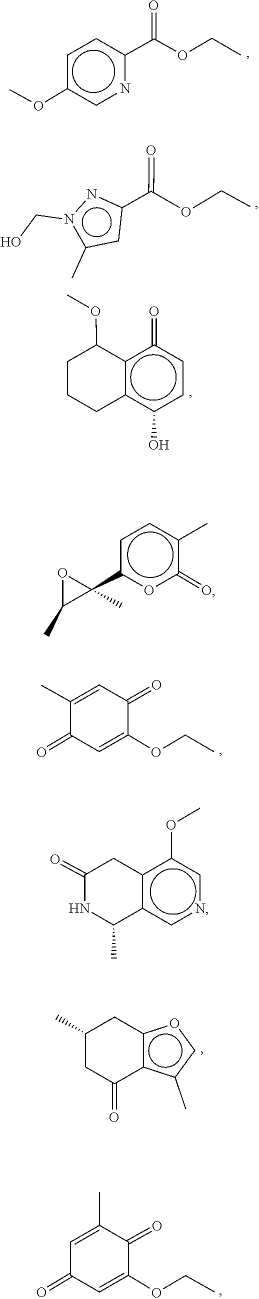

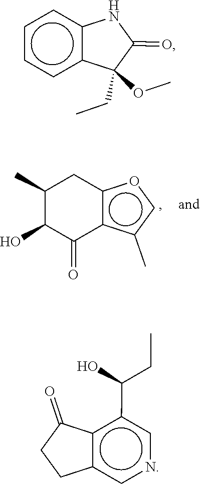

In some embodiments, the compounds have a core structure selected from the group consisting of

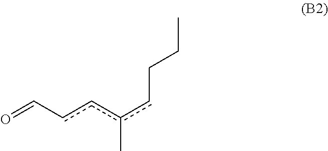

from Table B.2. In some embodiments, the compounds have a core structure of

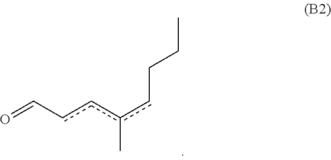

In some embodiments, the compound is selected from the group consisting of

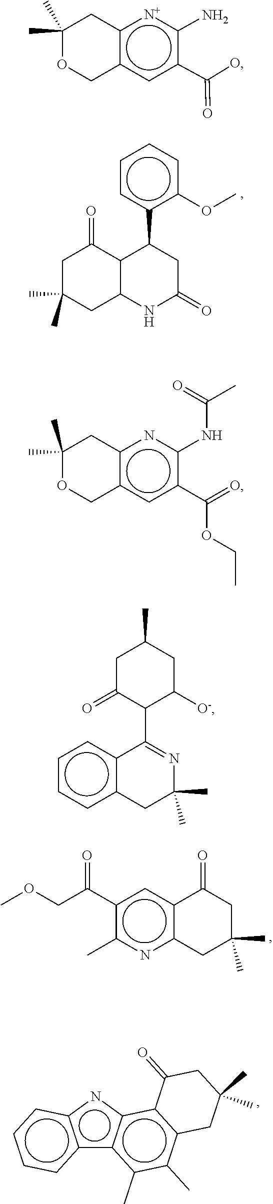

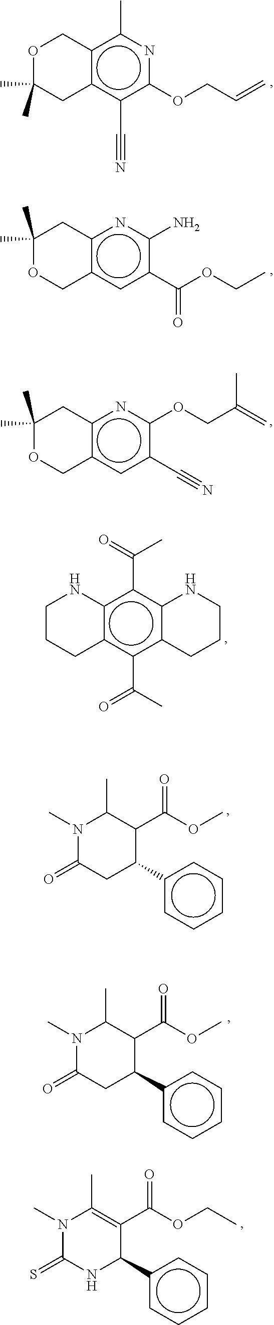

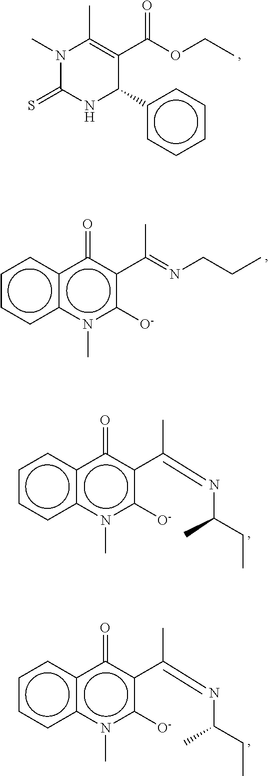

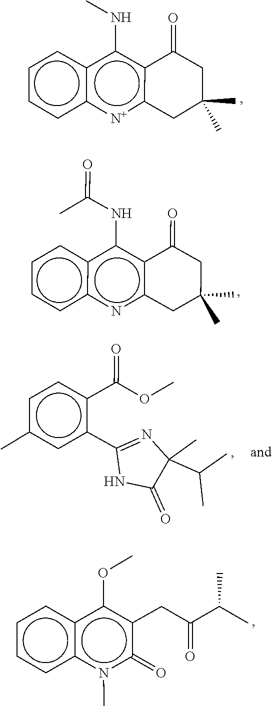

In some embodiments, the compounds have a core structure selected from the group consisting of

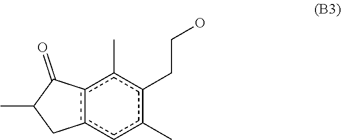

from Table B.2. In some embodiments, the compounds have a core structure of

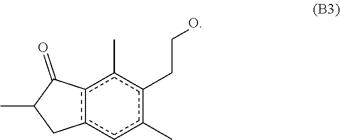

In some embodiments, the compound is selected from the group consisting of

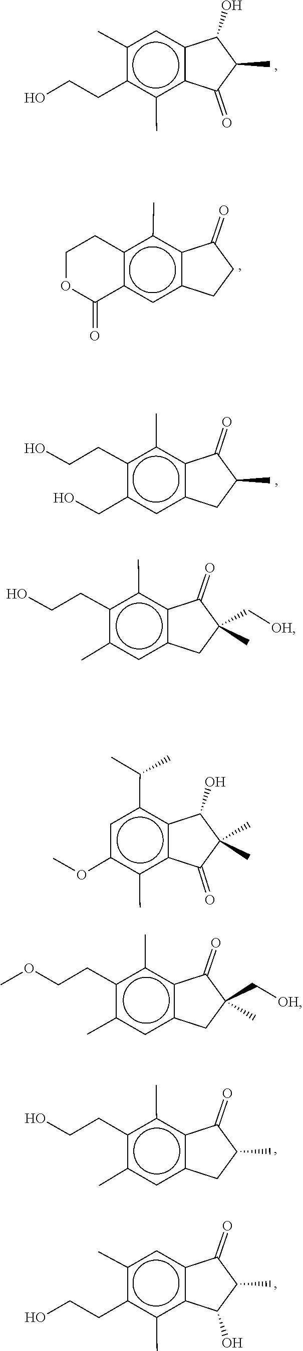

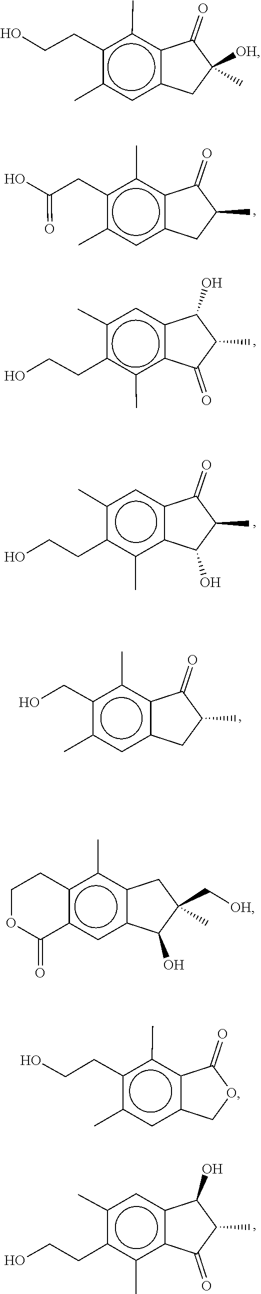

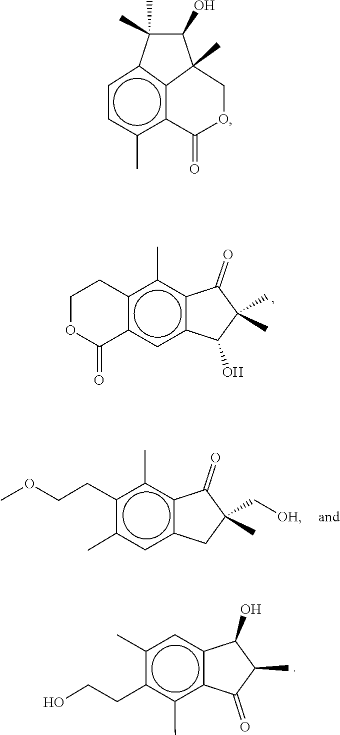

In some embodiments, the compounds have a core structure selected from the group consisting of

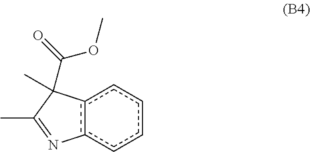

from Table B.2. In some embodiments, the compounds have a core structure of

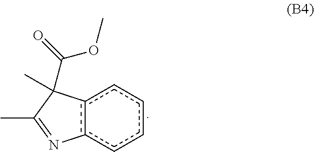

In some embodiments, the compound is selected from the group consisting of

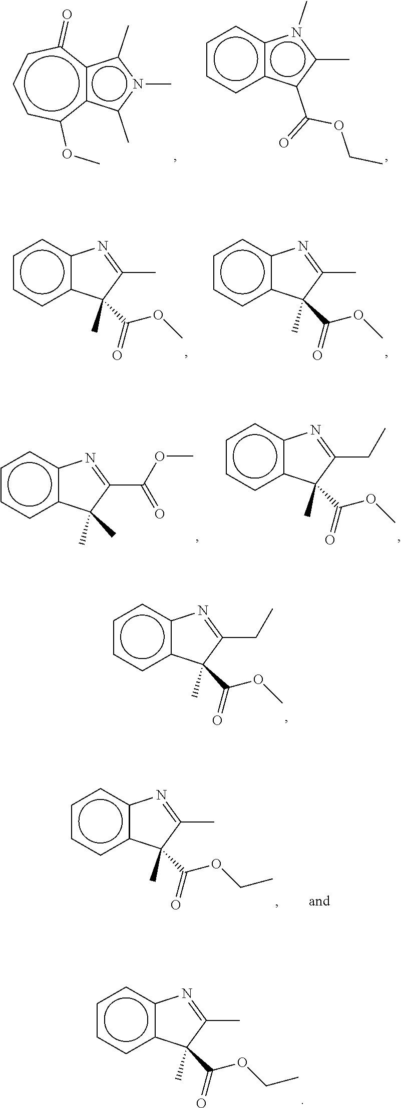

In some embodiments, the compounds have a core structure selected from the group consisting of

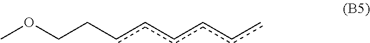

from Table B.2. In some embodiments, the compounds have a core structure of

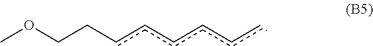

In some embodiments, the compound is selected from the group consisting of

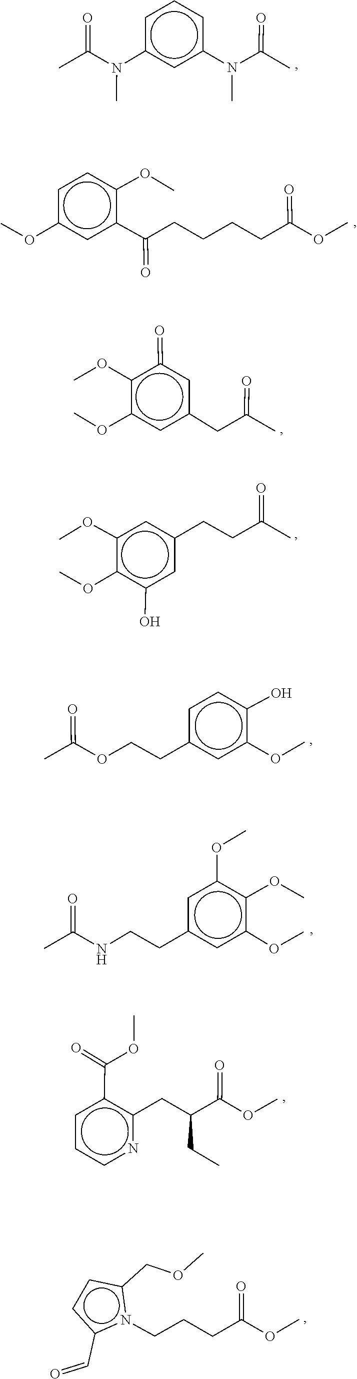

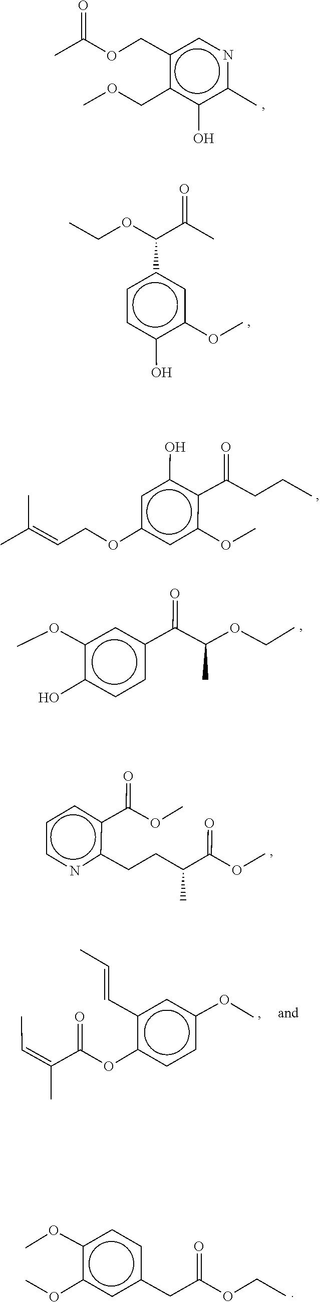

In some embodiments, the compounds have a core structure selected from the group consisting of

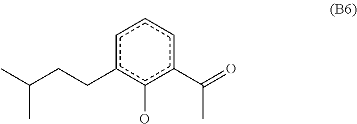

from Table B.2. In some embodiments, the compounds have a core structure of

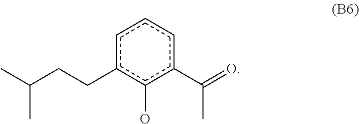

In some embodiments, the compound is selected from the group consisting of

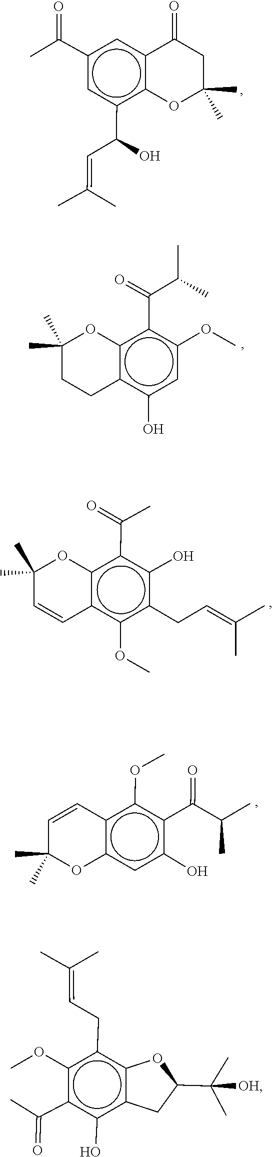

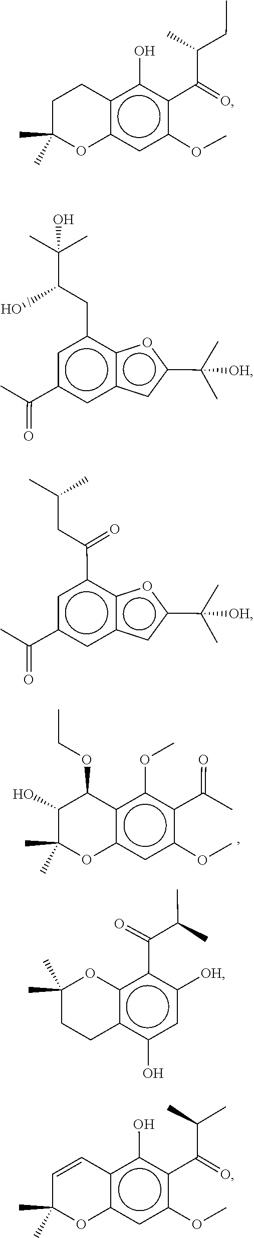

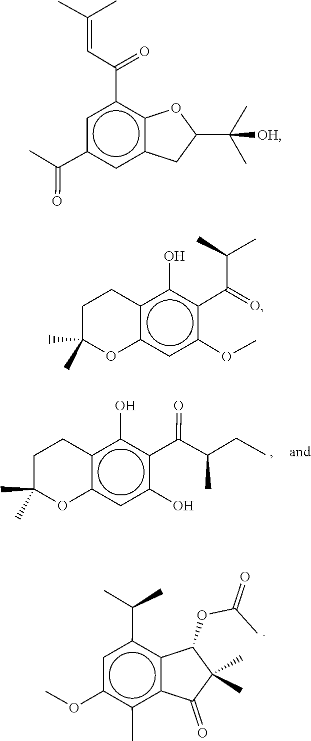

In some embodiments, the compounds have a core structure selected from the group consisting of

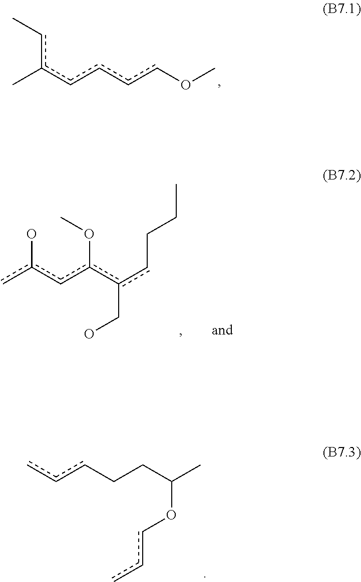

from Table B.2. In some embodiments, the compounds have a core structure of

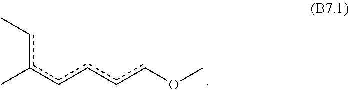

In some embodiments, the compound is selected from the group consisting of

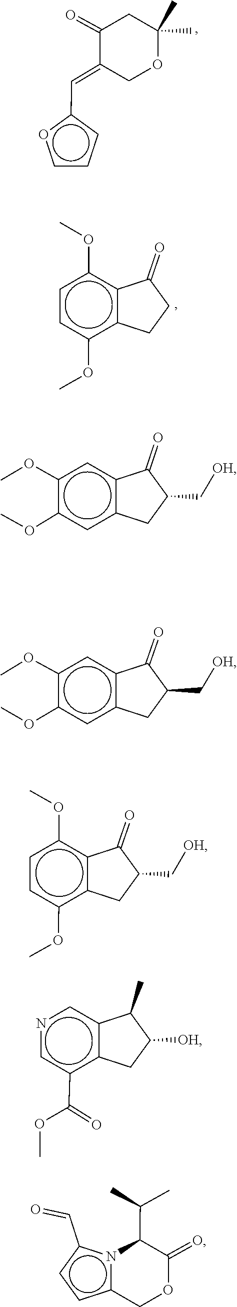

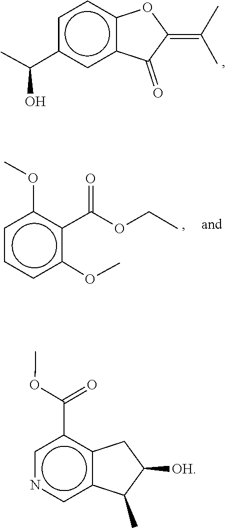

In some embodiments, the compounds have a core structure of

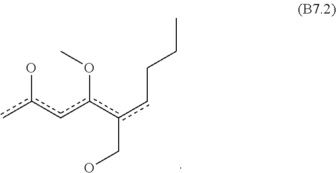

In some embodiments, the compound is selected from the group consisting of

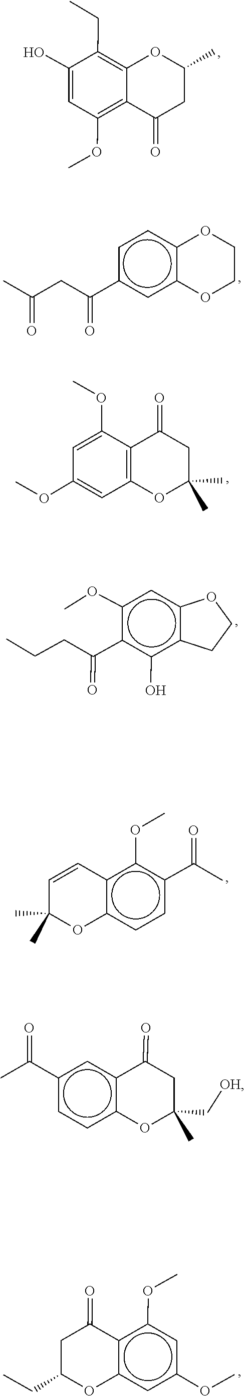

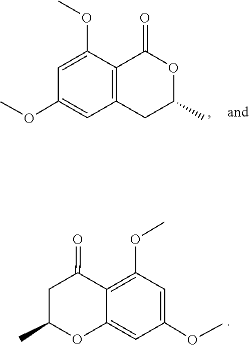

In some embodiments, the compounds have a core structure of

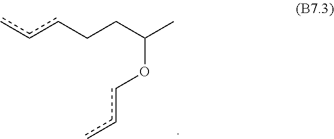

In some embodiments, the compound is selected from the group consisting of

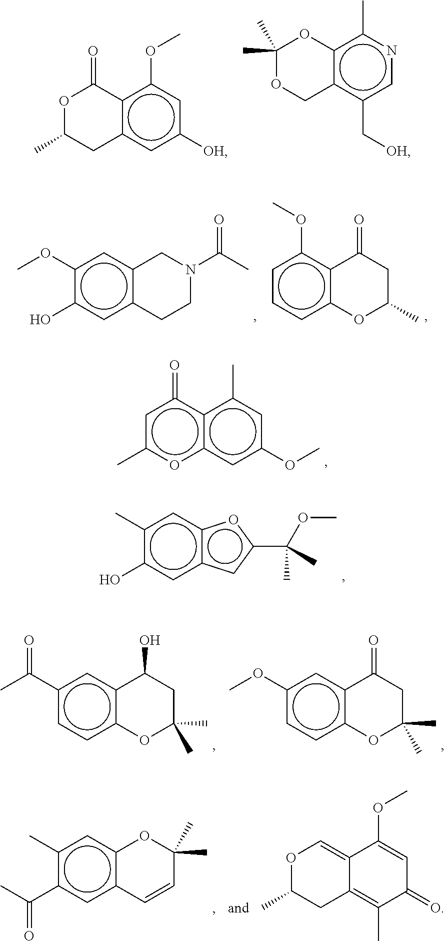

In some embodiments, the compounds have a core structure selected from the group consisting of

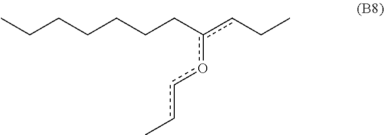

from Table B.2. In some embodiments, the compounds have a core structure of

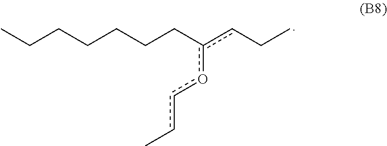

In some embodiments, the compound is selected from the group consisting of

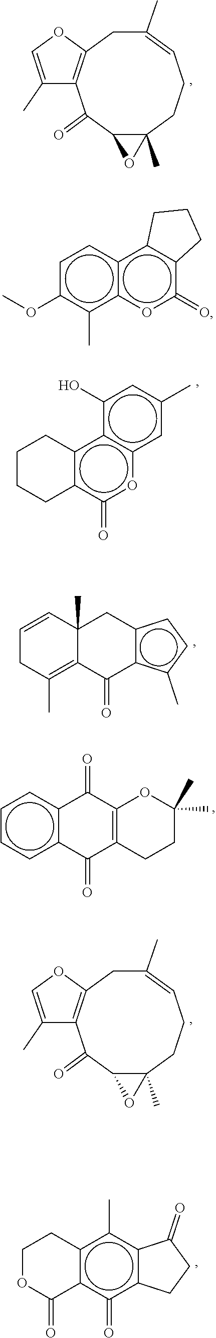

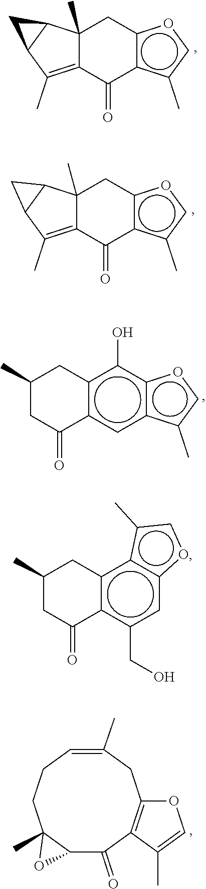

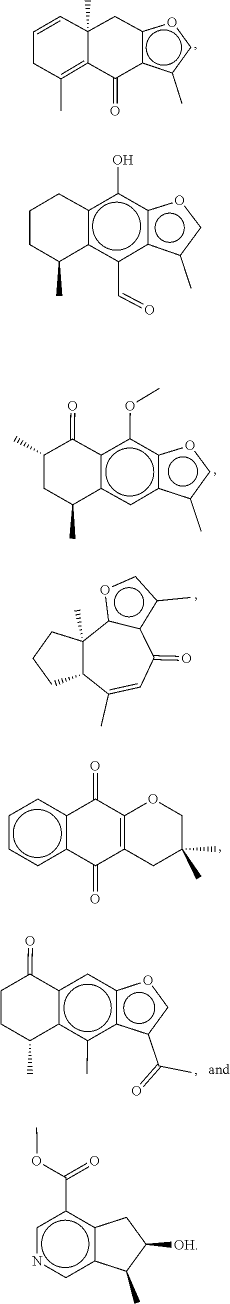

In some embodiments, the compounds have a core structure selected from the group consisting of

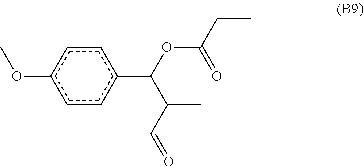

from Table B.2. In some embodiments, the compounds have a core structure of

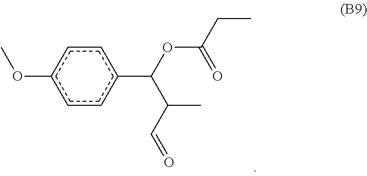

In some embodiments, the compound is selected from the group consisting of

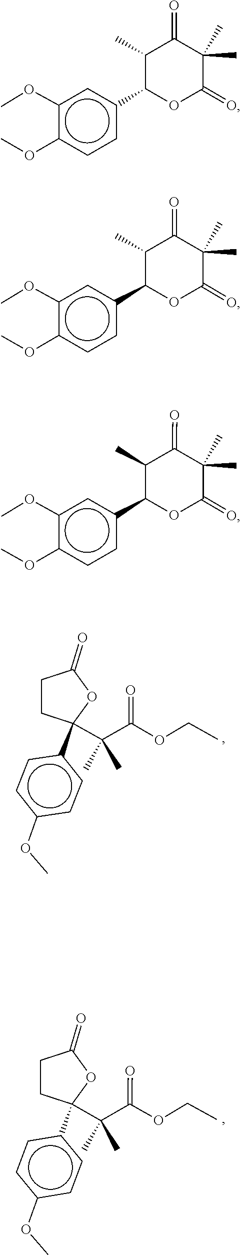

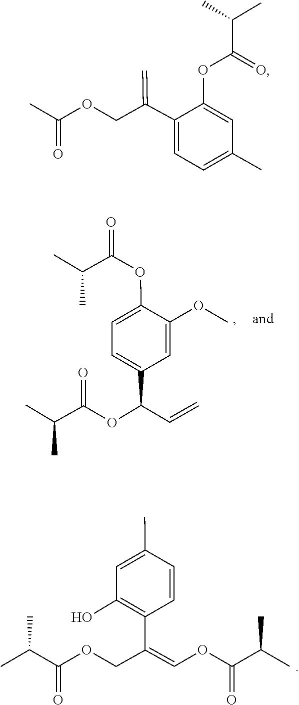

In some embodiments, the compounds have a core structure selected from the group consisting of

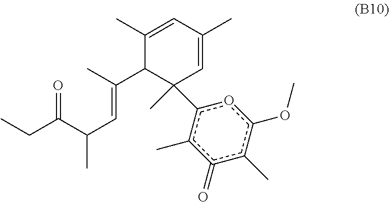

from Table B.2. In some embodiments, the compounds have a core structure of

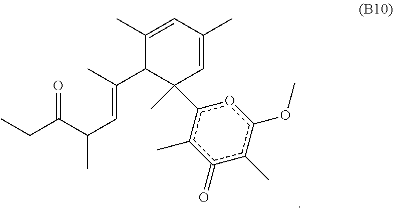

In some embodiments, the compound is selected from the group consisting of

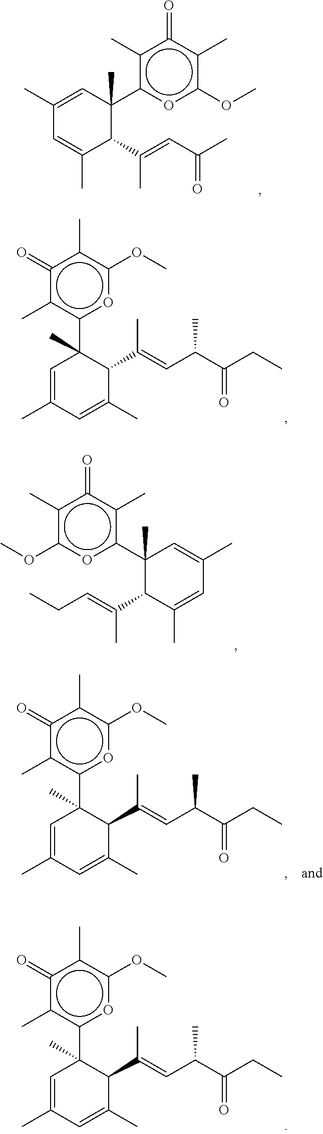

In some embodiments, the compounds have a core structure selected from the group consisting of

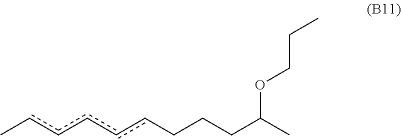

from Table B.2. In some embodiments, the compounds have a core structure of

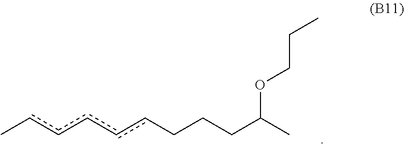

In some embodiments, the compound is selected from the group consisting of

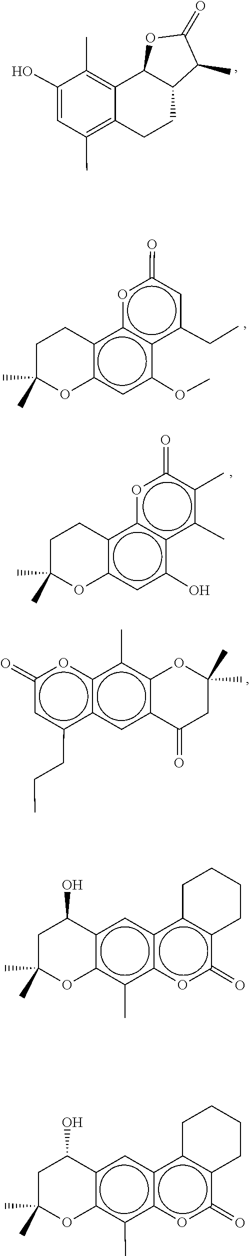

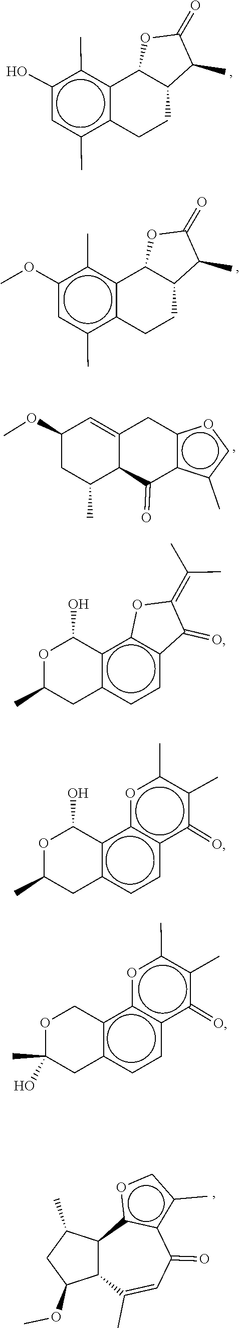

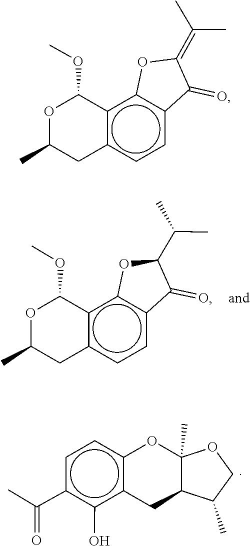

In some embodiments, the compounds have a core structure selected from the group consisting of

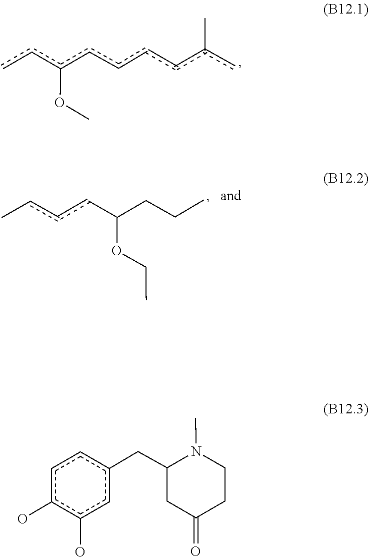

from Table B.2. In some embodiments, the compounds have a core structure of

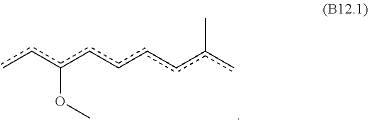

In some embodiments, the compound is selected from the group consisting of

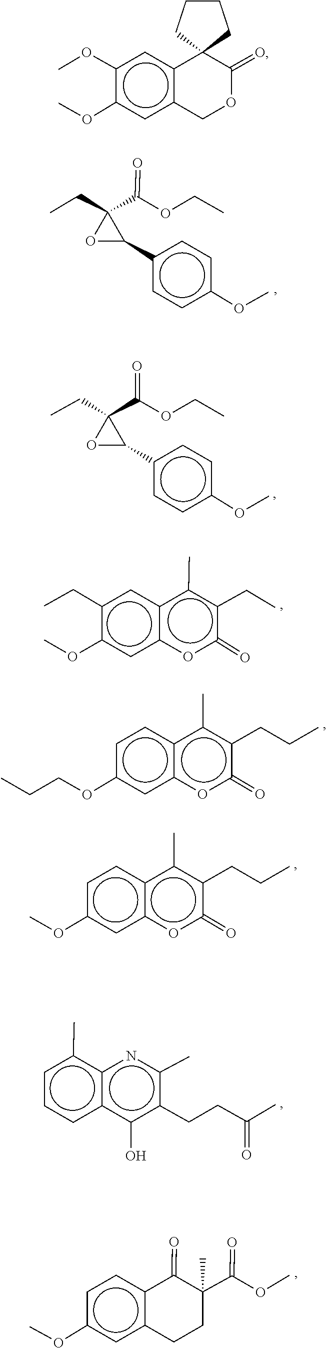

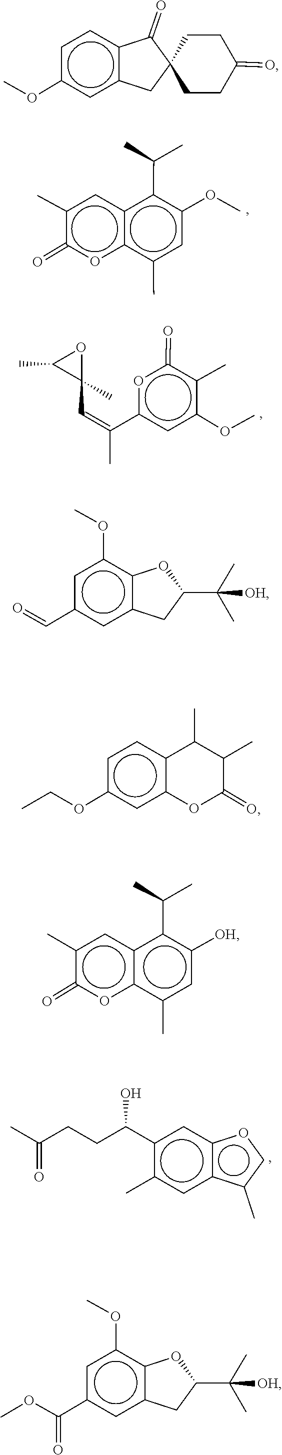

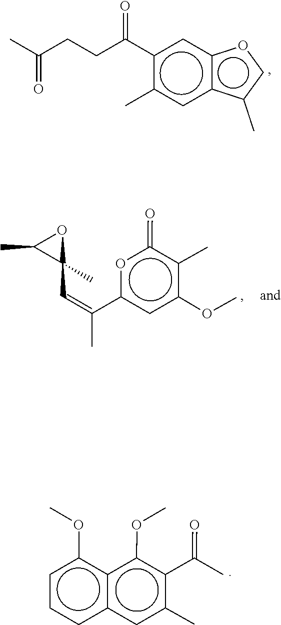

In some embodiments, the compounds have a core structure of

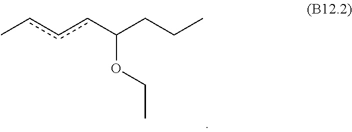

In some embodiments, the compound is selected from the group consisting of

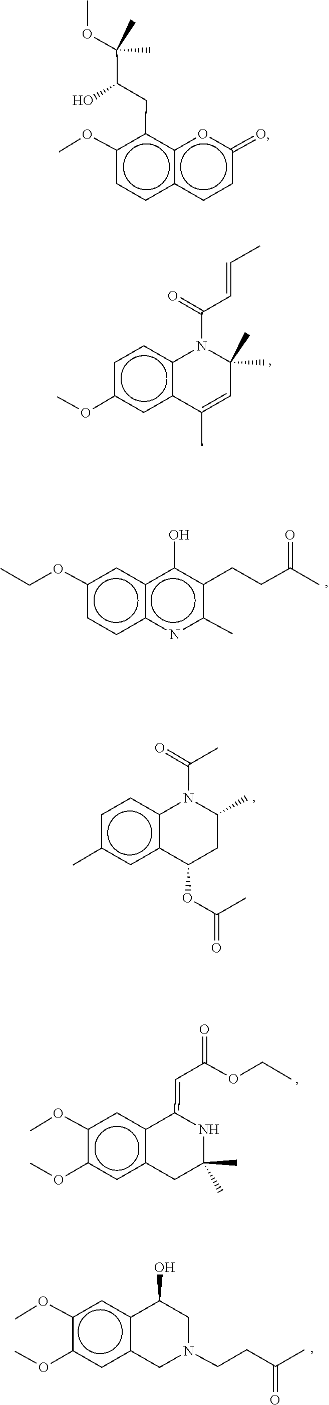

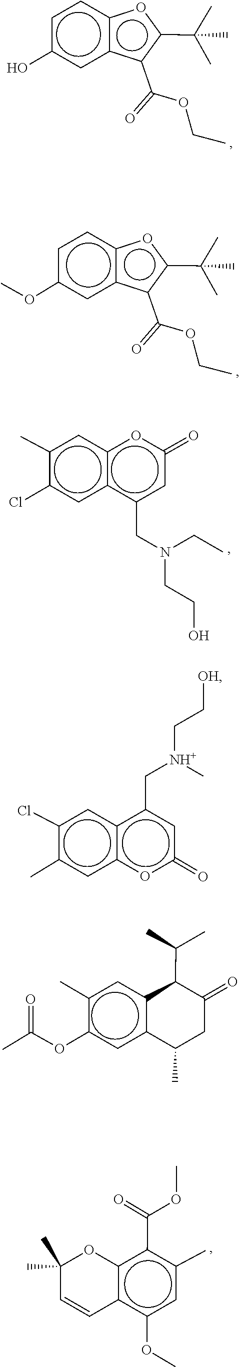

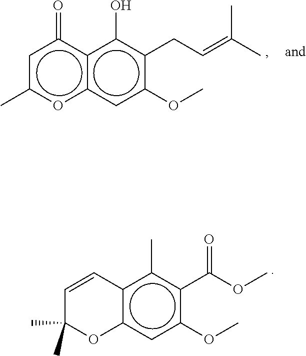

In some embodiments, the compounds have a core structure of

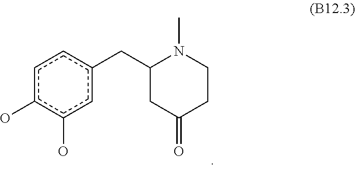

In some embodiments, the compound is selected from the group consisting of

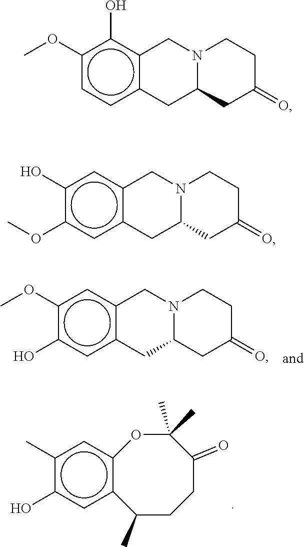

In some embodiments, the compounds have a core structure selected from the group consisting of

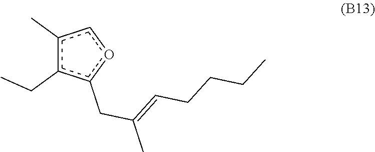

from Table B.2. In some embodiments, the compounds have a core structure of

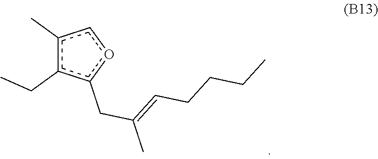

In some embodiments, the compound is selected from the group consisting of

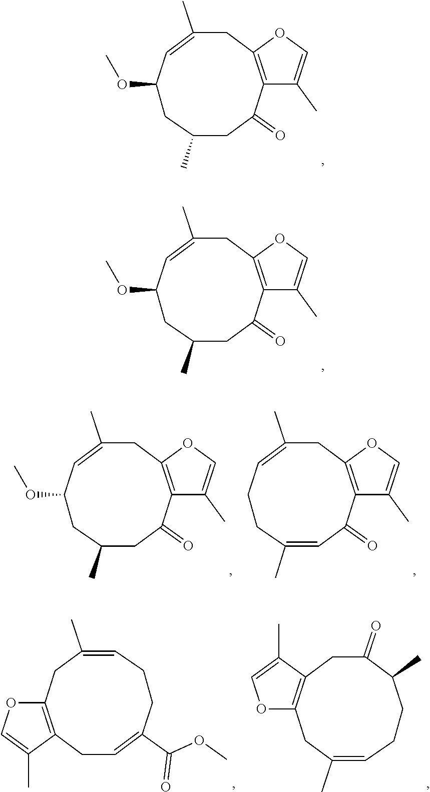

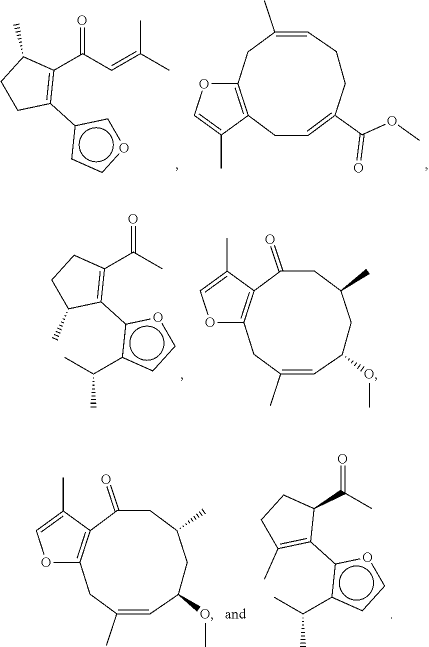

In some embodiments, the compounds have a core structure selected from the group consisting of

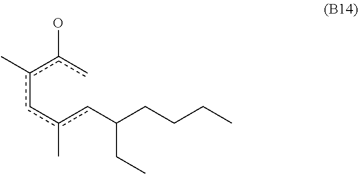

from Table B.2. In some embodiments, the compounds have a core structure of

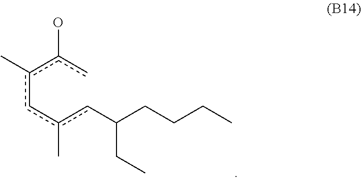

In some embodiments, the compound is selected from the group consisting of

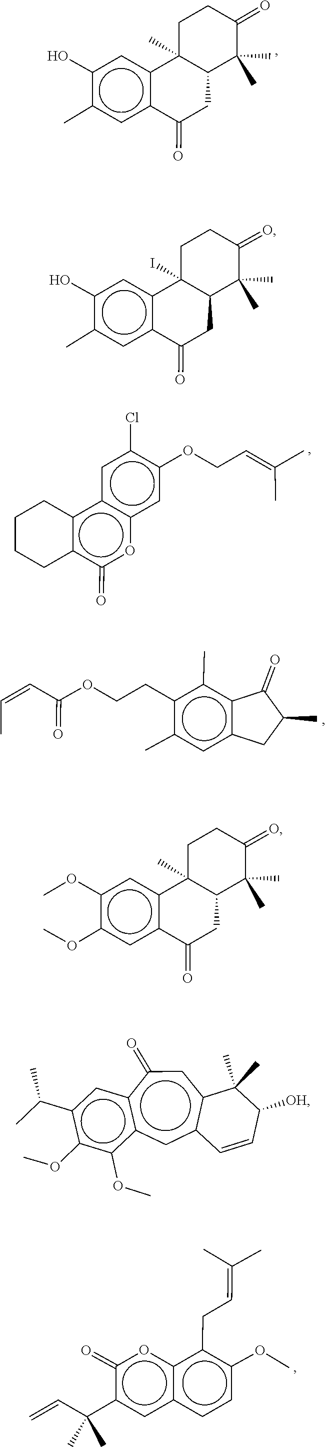

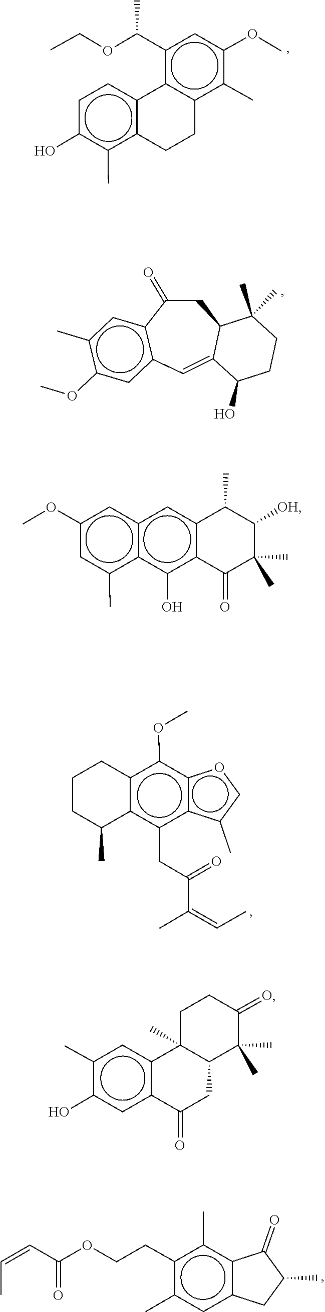

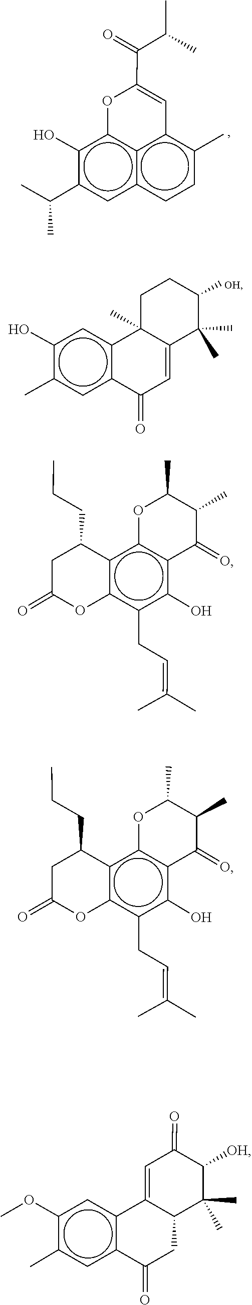

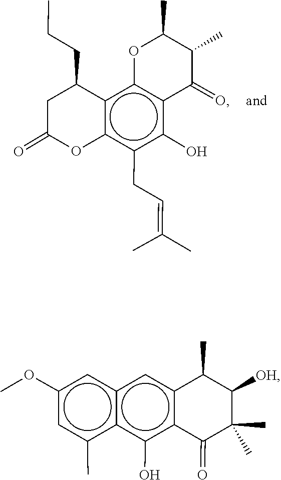

In some embodiments, the compounds have a core structure selected from the group consisting of

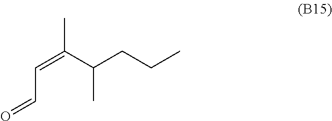

from Table B.2. In some embodiments, the compound is selected from the group consisting of

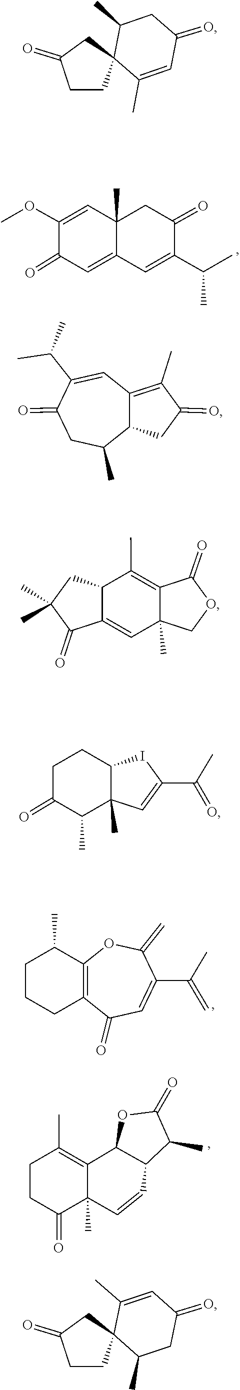

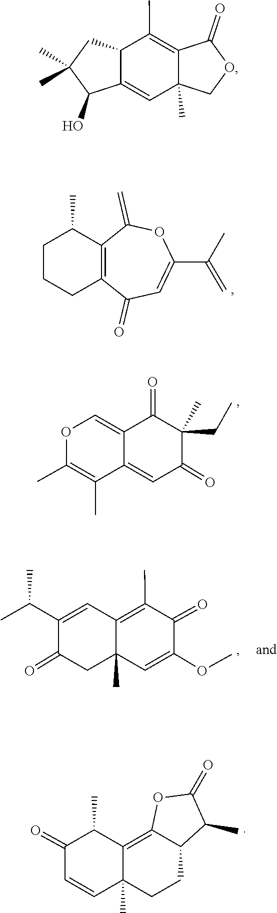

TABLE A

| Compound ID | Group | SMILES |
|---|---|---|
| ZR1 | A1.1 | C═CCn1c(═O)cc(C)c2cccc(C)c21 |
| ZR18 | A1.1 | CCCC(═O)c1c(C)c2ccccc2n1C |
| ZR20 | A1.1 | C═CCc1c(C)[nH]c2ccc(C)cc2c1═O |
| ZR58 | A1.1 | C═CCc1c(C)[nH]c2c(C)cccc2c1═O |
| ZR94 | A1.1 | Cc1c(C(═O)C(C)C)c2ccccc2n1C |
| ZR134 | A1.1 | CCc1c(C)[nH]c2cc(C)ccc2c1═O |
| ZR207 | A1.1 | CCc1[nH]c2cccc(C)c2c(═O)c1C |
| ZR322 | A1.1 | CCCn1c(═O)cc(C)c2ccccc21 |
| ZR360 | A1.1 | CCc1c(C)[nH]c2ccc(C)cc2c1═O |
| ZR385 | A1.1 | Cc1cc(═O)n(C(C)C)c2ccccc12 |
| ZR489 | A1.1 | Cc1ccc2c(c1)nc(C(C)C)c(═O)n2C |
| ZR4 | A1.2 | CCOC(═O)c1c(C)[nH]c2ccc(C)cc12 |
| ZR23 | A1.2 | Cc1nc(C)n(C)c(═O)c1-c1ccccc1 |
| ZR28 | A1.2 | Cc1nc(C)c(-c2ccccc2)c(═O)[nH]1 |
| ZR91 | A1.2 | CC1═C(C(═O)c2ccoc2)C(C)(C)CC═C1 |
| ZR97 | A1.2 | CC(C)c1cnc(-c2ccccn2)[nH]c1═O |
| ZR107 | A1.2 | Cc1nc(═O)c(-c2ccccc2)c(C)n1C |
| ZR151 | A1.2 | CCOC(═O)c1c(C)n(C)c2ccccc12 |
| ZR197 | A1.2 | CC(═O)c1c(C)cc(C)c(-c2ncc[nH]2)c1C |
| ZR219 | A1.2 | CCOC(═O)c1c(C)[nH]c2ccccc12 |
| ZR223 | A1.2 | CCOc1ccc2[nH]c(C)c(C(C)═O)c2c1 |
| ZR255 | A1.2 | C═C1C(═C(C)C)C(═O)N[C@H]1c1ccccc1 |
| ZR364 | A1.2 | C═C1C(═C(C)C)C(═O)N[C@@H]1c1ccccc1 |
| ZR378 | A1.2 | CCc1c(C)[nH]c2cc(OC)ccc2c1═O |
| ZR432 | A1.2 | COc1ccc2[nH]cc(C(C)C)c(═O)c2c1 |
| ZR458 | A1.2 | C/C═C1/C(═C(C)C)C(═O)N[C@H]1c1ccccc1 |
| ZR9 | A1.3 | C═CCn1c(═O)c(CC)c(C)c2ccccc21 |
| ZR30 | A1.3 | CCOC(═O)c1c(C)n(C)c2ccc(C)cc12 |
| ZR236 | A1.3 | CCOc1ccc2c(c1)c(C(C)═O)c(C)n2C |
| ZR307 | A1.3 | CCc1[nH]c(═O)cc2cc(OC)c(OC)cc12 |
| ZR466 | A1.3 | C/C1═C\C(═O)c2c(C)coc2C/C(C)═C/CC1 |
| ZR479 | A1.3 | C═CCc1c(C)[nH]c2c(OC)cccc2c1═O |
| ZR486 | A1.3 | CCc1[nH]c2c(OC)cccc2c(═O)c1CC |
| ZR494 | A1.3 | COc1cccc2[nH]c(C)c(C(C)C)c(═O)c12 |
| ZR2 | A2.1 | COC(═O)[C@@]1(N)CCc2ccccc21 |
| ZR8 | A2.1 | COC(═O)[C@]1(N)CCc2ccccc21 |
| ZR35 | A2.1 | CC(═O)N1c2ccccc2C(═O)C[C@@H]1C |
| ZR79 | A2.1 | CC[C@@]1(C)C(═O)N(C)c2ccc(O)cc21 |
| ZR82 | A2.1 | CCn1c(═O)c(C)c(O)c2ccccc21 |
| ZR95 | A2.1 | CCc1c(O)c2ccccc2n(C)c1═O |
| ZR120 | A2.1 | CC(C)N1C(═O)[C@H](N)c2ccccc21 |
| ZR130 | A2.1 | CC[C@]1(C)C(═O)N(C)c2ccc(O)cc21 |
| ZR136 | A2.1 | CC[C@@H]1C(═O)c2ccccc2N(C)C1═O |
| ZR170 | A2.1 | COc1cc(OC)c2c(c1)[C@@H](C)CC2═O |
| ZR172 | A2.1 | COc1cc(OC)c2c(c1)[C@H](C)CC2═O |
| ZR176 | A2.1 | CC[C@H]1C(═O)c2ccccc2N(C)C1═O |
| ZR213 | A2.1 | CC(C)N1C(═O)COc2ccccc21 |
| ZR230 | A2.1 | CC(C)N1C(═O)[C@@H](N)c2ccccc21 |
| ZR251 | A2.1 | NCCn1ncc2ccccc2c1═O |
| ZR316 | A2.1 | CC1═NN(c2ccccc2)C(═O)[C@@H]1N |
| ZR351 | A2.1 | CCn1ccc2ccc(OC)cc2c1═O |
| ZR359 | A2.1 | CC1═NN(c2ccccc2)C(═O)[C@H]1N |
| ZR382 | A2.1 | CC(═O)N1c2ccccc2C(═O)C[C@H]1C |
| ZR406 | A2.1 | COc1ccc(OC)c2c1C(═O)C[C@H]2C |
| ZR425 | A2.1 | COc1ccc(OC)c2c1C(═O)C[C@@H]2C |
| ZR435 | A2.1 | CCn1c(C)nc2ccccc2c1═O |
| ZR444 | A2.1 | CC1═[N+](C)c2ccccc2N(C)C(═O)C1 |
| ZR487 | A2.1 | CC1(C)C(═O)C═CO[C@@]1(C)c1ccccc1 |
| ZR3 | A2.2 | CC[C@]1(C)C(═O)c2ccccc2N(C)C1═O |
| ZR5 | A2.2 | CC[C@@]1(C)C(═O)c2ccccc2N(C)C1═O |
| ZR29 | A2.2 | CCOC(═O)[C@]1(C)C(C)═Nc2ccccc21 |
| ZR37 | A2.2 | COc1cc2c(cc1OC)CC(═O)NCC2 |
| ZR61 | A2.2 | CCOC(═O)[C@@]1(C)C(C)═Nc2ccccc21 |
| ZR68 | A2.2 | COC(═O)[C@@H]1CCC(═O)c2ccccc21 |
| ZR69 | A2.2 | COC(═O)[C@H]1CCC(═O)c2ccccc21 |
| ZR110 | A2.2 | CC(═O)N(C)c1ccc2c(c1)CCCCC2═O |
| ZR117 | A2.2 | CCc1cc2cc(OC)ccc2[nH]c1═O |
| ZR124 | A2.2 | COc1cccc2c1CCC[C@@]2(O)C(C)═O |
| ZR128 | A2.2 | CN1CCC[C@H](C(═O)c2cccnc2)C1═O |
| ZR142 | A2.2 | CC(═O)N1CC[C@H](C═O)c2ccccc21 |
| ZR148 | A2.2 | CC(═O)N1CC[C@@H](C═O)c2ccccc21 |
| ZR150 | A2.2 | CC(═O)c1ccc2c(c1)N(C(C)═O)CCO2 |
| ZR159 | A2.2 | CC(═O)c1ccc([C@H]2CNC(═O)C2)cc1C |
| ZR163 | A2.2 | COc1cccc2c1CCC[C@]2(O)C(C)═O |
| ZR173 | A2.2 | Cc1cc(N2CCCC2═O)Ccc1C#N |
| ZR195 | A2.2 | C═CN1CC[C@H](C(═O)c2ccccc2)C1═O |
| ZR209 | A2.2 | COC(═O)c1ccc2c(c1)CCCCC2═O |
| ZR211 | A2.2 | C═CC[C@@H]1C(═O)CCc2ccc(OC)cc21 |
| ZR217 | A2.2 | C═CC(═O)N1CCOCc2ccccc21 |
| ZR234 | A2.2 | CC(═O)N1c2ccccc2[C@H](C═O)C[C@@H]1C |
| ZR237 | A2.2 | CN1CCC[C@@H](C(═O)c2cccnc2)C1═O |
| ZR246 | A2.2 | CC(═O)c1ccc([C@@H]2CNC(═O)C2)cc1C |
| ZR292 | A2.2 | COc1cc(OC)c2c(c1)C(C)(C)CC2═O |
| ZR313 | A2.2 | CC(═O)N1c2ccccc2[C@@H](C═O)C[C@@H]1C |
| ZR318 | A2.2 | COc1cc2c(cc1OC)CC(═O)NC═C2 |
| ZR325 | A2.2 | O═C1CNC(═O)[C@@]12CCCc1ccccc12 |
| ZR330 | A2.2 | CNC(═O)c1cc2c(cc1C)OCCCO2 |
| ZR345 | A2.2 | COC(═O)C[C@H]1COc2cc(O)ccc21 |
| ZR402 | A2.2 | CC(═O)Nc1ccc2c(c1)CCN2C(C)═O |
| ZR423 | A2.2 | CNC(═O)[C@H]1Cc2ccccc2N1C(C)═O |
| ZR427 | A2.2 | COC(═O)C[C@H]1COc2cccc(OC)c21 |
| ZR451 | A2.2 | CN1CCC[C@H](C(═O)c2ccncc2)C1═O |
| ZR463 | A2.2 | CC(═O)N1c2ccccc2NC(═S)C[C@H]1C |
| ZR468 | A2.2 | CC(═O)N1c2ccccc2[C@H](C═O)C[C@H]1C |
| ZR471 | A2.2 | CCOc1cc2c(cc1OC)[C@H](N)CC2═O |
| ZR474 | A2.2 | CCOc1cc2c(cc1OC)[C@@H](N)CC2═O |
| ZR337 | A2.3 | C═CC(═O)Nc1cccc2c1CCN2C(C)═O |
| ZR346 | A2.3 | CC(═O)c1cc(N2CCOCC2═O)ccc1N |
| ZR350 | A2.3 | COc1cc([C@@H]2CNC(═O)C2)ccc1C(C)═O |
| ZR389 | A2.3 | COc1cc([C@H]2CNC(═O)C2)ccc1C(C)═O |
| ZR492 | A2.3 | COc1cc([C@H]2CCNC(═O)C2)ccc1C(C)═O |
| ZR6 | A3.1 | CC(═O)CCc1c(C)[nH]c2ccccc2c1═O |
| ZR11 | A3.1 | CC(═O)CCc1c(C)[nH]c2ccc(C)cc2c1═O |
| ZR104 | A3.1 | COc1ccc(C2═CC(═O)C[C@](C)(O)C2)cc1 |
| ZR122 | A3.1 | CC(═O)c1cc2c(cc1C)N(C(C)═O)C(C)(C)C═C2C |
| ZR135 | A3.1 | COc1cccc2c(═O)c(CCC(C)═O)c(C)[nH]c12 |
| ZR184 | A3.1 | COc1ccc(C2═CC(═O)C[C@@](C)(O)C2)cc1 |
| ZR189 | A3.1 | CC(═O)CCc1c(C)c2cccc(C)c2[nH]c1═O |
| ZR228 | A3.1 | CC(═O)Nc1ccc2c(c1)C(═O)CC(C)(C)O2 |
| ZR243 | A3.1 | CC(═O)CCc1c(C)c2ccccc2[nH]c1═O |
| ZR352 | A3.1 | COc1ccc2[nH]c(C)c(CCC(C)═O)c(═O)c2c1 |
| ZR371 | A3.1 | CNC(═O)Cn1c(C)cc(═O)c2cccc(C)c21 |
| ZR424 | A3.1 | CCC(═O)Cc1ccc2[nH]c(C)cc(═O)c2c1 |
| ZR467 | A3.1 | C/C(Cl)═C/Cc1c(C)[nH]c2ccc(C)cc2c1═O |
| ZR21 | A3.2 | CC1═CC(C)(C)N(C(C)C)c2cc(C)c(C#N)cc21 |
| ZR43 | A3.2 | CC(═O)N1c2ccccc2C(C)═CC1(C)C |
| ZR133 | A3.2 | C═C(C)[C@H]1CC═C(C)C2═CC(═O)[C@H](C)C[C@@]21C#N |
| ZR194 | A3.2 | C/C═C/C(═O)N1c2ccccc2C(C)═CC1(C)C |
| ZR196 | A3.2 | CCC(═O)c1ccc2c(c1)C(C)(C)C(═O)N2 |
| ZR221 | A3.2 | COc1ccc2c(c1)C(C)═CC(C)(C)N2C(C)═O |
| ZR254 | A3.2 | Cc1ccc(C(C)(C)C)c2oc(═O)cc(C)c12 |
| ZR258 | A3.2 | Cc1cc(C)c2c(C#N)cn(C(C)(C)C)c2n1 |
| ZR268 | A3.2 | CC(═O)Cc1cc2ccccc2c(═O)n1C |
| ZR369 | A3.2 | C═C(C)[C@@H]1CC═C(C)C2═CC(═O)[C@H](C)C[C@@]21C#N |
| ZR383 | A3.2 | CCCC(═O)c1ccc2c(c1)C(C)(C)C(═O)N2 |
| ZR404 | A3.2 | C/C═C/C(═O)N1c2ccc(C)cc2C(C)═CC1(C)C |
| ZR454 | A3.2 | C═C(C)[C@H]1CC═C(C)C2═CC(═O)CC[C@@]21C#N |
| ZR482 | A3.2 | CC(═O)c1ccc2c(c1)C(═O)CC(C)(C)O2 |
| ZR121 | A3.3 | COc1ccc2c(c1)CC[C@@]1(C)CC(═O)C═C21 |
| ZR123 | A3.3 | COc1ccc2c(c1)CC[C@]1(C)CC(═O)C═C21 |
| ZR164 | A3.3 | Cc1cc2oc(═O)c3c(c2cc1O)CCCC3 |
| ZR190 | A3.3 | Cc1cc(O)c2c3c(c(═O)oc2c1)CCCC3 |
| ZR212 | A3.3 | C[C@H]1CC(═O)c2c(-c3ccccc3)n[nH]c2C1 |
| ZR226 | A3.3 | CNc1c2c(nc3ccccc13)CC(C)(C)CC2═O |
| ZR249 | A3.3 | CC(═O)C1═C(C)N[C@H](C)[C@H]2Oc3ccccc3[C@@H]12 |
| ZR282 | A3.3 | Cc1cc(O)c2c3c(c(═O)oc2c1)CC[C@H](C)C3 |
| ZR309 | A3.3 | Cc1cc(O)c2c3c(c(═O)oc2c1)CC[C@@H](C)C3 |
| ZR462 | A3.3 | CC[C@@]1(C)Cc2ccccc2-c2nc[nH]c(═O)c21 |
| ZR478 | A3.3 | C═CCNc1c2c(nc3ccccc13)CC(C)(C)CC2═O |
| ZR7 | A4.1 | C#CCN(C)C(═O)c1cc(C)n(CC)c1C |
| ZR31 | A4.1 | C#CCN(CC)C(═O)c1ncoc1C(C)C |
| ZR51 | A4.1 | C#CCNC(═O)[C@H](C)c1c(C)nn(C)c1C |
| ZR60 | A4.1 | C═CCN(C)C(═O)c1cnn(CC)c1C |
| ZR62 | A4.1 | CCOC(═O)/C(═C\N(C)C)c1ccccn1 |
| ZR81 | A4.1 | COCCNC(═O)c1cnc(C)nc1C |
| ZR87 | A4.1 | CCN(C(C)═O)c1cccc(C(C)═O)c1 |
| ZR89 | A4.1 | COC(═O)[C@H](C)n1c(C)cc(C═O)c1C |
| ZR100 | A4.1 | C#CCN(C)C(═O)c1ccncc1CC |
| ZR102 | A4.1 | COC(═O)[C@@H](C)n1c(C)cc(C═O)c1C |
| ZR109 | A4.1 | COCCNC(═O)c1c(C)nn(C)c1C |
| ZR119 | A4.1 | C═C[C@@H](CC)OC(═O)c1cnn(C)c1C |
| ZR127 | A4.1 | C═C[C@H](CC)OC(═O)c1cnn(C)c1C |
| ZR131 | A4.1 | C#CCNC(═O)[C@@H](C)c1c(C)nn(C)c1C |
| ZR199 | A4.1 | CCOC(═O)[C@H](N)c1ccc(OC)cc1 |
| ZR202 | A4.1 | COC[C@@H](C)NC(═O)c1cnc(C)cn1 |
| ZR208 | A4.1 | COC[C@H](C)NC(═O)c1cnc(C)cn1 |
| ZR214 | A4.1 | C═C[C@H](C)OC(═O)c1cn(C)nc1CC |
| ZR233 | A4.1 | COCC(═O)N[C@@H](C)c1cnn(C)c1C |
| ZR244 | A4.1 | C═C[C@H](CC)OC(═O)c1cccc(C)n1 |
| ZR245 | A4.1 | CCOC(═O)[C@@H](N)c1ccc(OC)cc1 |
| ZR260 | A4.1 | CCOC(═O)c1ncn(CCOC)c1N |
| ZR266 | A4.1 | C═C[C@@H](CC)OC(═O)c1cccc(C)n1 |
| ZR287 | A4.1 | CCOC(═O)c1ccccc1CC(C)═O |
| ZR297 | A4.1 | COCC(═O)N[C@H](C)c1cnn(C)c1C |
| ZR301 | A4.1 | C═C[C@@H](C)OC(═O)c1cn(C)nc1CC |
| ZR302 | A4.1 | C═C(C)COC(═O)c1c(C)cc(C)cc1C |
| ZR333 | A4.1 | CCOC(═O)c1cnc(CN(C)C)nc1C |
| ZR348 | A4.1 | CCCc1ncccc1C(═O)N(C)OC |
| ZR370 | A4.1 | CCN(CC)C(═O)c1ccc(C#N)c(C)n1 |
| ZR392 | A4.1 | C═CCNC(═O)c1c(C)noc1C(C)C |
| ZR395 | A4.1 | C#CCNC(═O)Cc1c(C)nn(C)c1C |
| ZR418 | A4.1 | C═C[C@@H](C)OC(═O)c1ccncc1CC |
| ZR422 | A4.1 | COC(═O)CCc1c(C)[nH]c(C═O)c1C |
| ZR441 | A4.1 | CCOC(═O)Cc1c(C)[nH]c(C═O)c1C |
| ZR448 | A4.1 | C#CC(C)(C)NC(═O)c1ccccc1OC |
| ZR449 | A4.1 | C═CCN(CC═C)C(═O)c1cc(C)oc1C |
| ZR491 | A4.1 | CCOc1ccccc1C(═O)N(C)OC |
| ZR19 | A4.2 | C#C[C@H](C)OC(═O)c1cccc(COC)c1 |
| ZR55 | A4.2 | CNC(═S)/C(C(C)═O)═C(/C)Nc1ccccc1 |
| ZR56 | A4.2 | CNC(═S)/C(C(C)═O)═C(\C)Nc1ccccc1 |
| ZR138 | A4.2 | CCOC(═O)Cc1ccc(C(C)═O)cc1 |
| ZR149 | A4.2 | COCCCNc1nnc(C)c(C)c1C#N |
| ZR180 | A4.2 | COC[C@H](C)NC(═O)c1cnc(C)nc1C |
| ZR191 | A4.2 | CCOC(═O)CCc1c(C)[nH]c(C═O)c1C |
| ZR220 | A4.2 | COC[C@@H](C)NC(═O)c1cnc(C)nc1C |
| ZR247 | A4.2 | C#C[C@@H](C)OC(═O)c1cccc(COC)c1 |
| ZR252 | A4.2 | C═C[C@H](C)OC(═O)c1ccc(C(C)═O)cc1 |
| ZR261 | A4.2 | C═C[C@@H](C)OC(═O)c1ccc(C(C)═O)cc1 |
| ZR286 | A4.2 | COc1ccc(C(═O)N(C)CCC#N)cc1 |
| ZR304 | A4.2 | CCOC(═O)/C═C(\C)c1ccc(OC)cc1 |
| ZR327 | A4.2 | COCCNC(═O)c1cnc(N(C)C)nc1C |
| ZR357 | A4.2 | CN[C@@H](C#N)Cc1ccc(OC)c(OC)c1 |
| ZR368 | A4.2 | CCOC(═O)c1ccc(N(C)CCO)nn1 |
| ZR374 | A4.2 | CCN(CC)C(═O)NC(═S)c1cccnc1 |
| ZR430 | A4.2 | CCn1cc(NC(═O)COC)ccc1═O |
| ZR445 | A4.2 | CC(═O)C[C@@H](C)NC(═O)c1cnn(C)c1C |
| ZR452 | A4.2 | C═C[C@@H](CC)OC(═O)c1cccnc1OC |
| ZR457 | A4.2 | Cc1cc(OCC(═O)C(C)(C)C)ccc1C#N |
| ZR459 | A4.2 | C═C[C@H](CC)OC(═O)c1cccnc1OC |
| ZR481 | A4.2 | COCC(═O)NCc1ccnc(OC)c1 |
| ZR493 | A4.2 | C#CC(C)(C)OC(═O)c1ccc(OC)cc1 |
| ZR495 | A4.2 | CCOC(═O)/C═C(/C)c1ccc(OC)cc1 |
| ZR118 | A4.3 | CCN(C(═O)CCOC)c1ccc(C#N)cc1 |
| ZR269 | A4.3 | COC[C@@H](C)NC(═O)c1ccc(C#N)c(C)n1 |
| ZR285 | A4.3 | C═CCN(CC═C)C(═O)NC(═S)c1ccccc1 |
| ZR298 | A4.3 | COC[C@H](C)NC(═O)c1ccc(C#N)c(C)n1 |
| ZR437 | A4.3 | COCCCNC(═O)c1ccc(C#N)c(C)n1 |
| ZR446 | A4.3 | C═CCN(CC═C)C(═O)NC(═S)c1cccnc1 |
| ZR497 | A4.3 | CCOC(═O)O/C(C)═C\c1ccccc1OC |
| ZR10 | A5.1 | CO[C@H](C)C(═O)Nc1c(C(C)C)c(C)nc2ccccc12 |
| ZR101 | A5.1 | COc1ccc(F)cc1-c1nc(C)ncc1C(C)C |
| ZR139 | A5.1 | C#C[C@@H](C)N(C)C(═O)c1cc(C)cc2c(C)ccnc12 |
| ZR179 | A5.1 | Cc1nn(C)c(C)c1[C@H](C)NC(═O)c1cccnc1 |
| ZR215 | A5.1 | C═CCNC(═O)Cc1coc2c(C)c(C)ccc12 |
| ZR235 | A5.1 | CCN(CC)C(═O)c1ccc(-c2cccs2)nc1C |
| ZR303 | A5.1 | CCOC(═O)c1c(C)[nH]c(C)c1-c1ccccc1OC |
| ZR320 | A5.1 | CCN(C)C(═O)c1cncc(-c2ccccc2C)c1 |
| ZR323 | A5.1 | COc1ccc2nc(C)c(C(═O)NC(C)C)cc2c1 |
| ZR342 | A5.1 | CC[C@@H](C)NC(═O)c1cc2cc(OC)ccc2nc1C |
| ZR355 | A5.1 | CO[C@@H](C)c1ccc(-c2cc(C)c(C)nc2O)cc1 |
| ZR361 | A5.1 | Cc1nn(C)c(C)c1[C@@H](C)NC(═O)c1cccnc1 |
| ZR373 | A5.1 | C#CC(C)(C)NC(═O)c1cc(C)nc2c(C)cccc12 |
| ZR377 | A5.1 | COC[C@@H](C)NC(═O)c1cc(C)nc2ccccc12 |
| ZR393 | A5.1 | C═CCNC(═O)c1cc2c(C)nn(C)c2nc1C |
| ZR455 | A5.1 | COCc1c(C(═O)NCC(C)C)oc2ccccc12 |
| ZR490 | A5.1 | C#C[C@H](C)N(C)C(═O)c1cc(C)cc2c(C)ccnc12 |
| ZR498 | A5.1 | COC[C@H](C)NC(═O)c1cc(C)nc2ccccc12 |
| ZR499 | A5.1 | C═CCNC(═O)c1ccc(OC)c2ccccc12 |
| ZR38 | A5.2 | Cc1ccc2nc(C)c(C(═O)N(C)C(C)C)cc2c1 |
| ZR49 | A5.2 | CCN(CC)C(═O)c1cc(C)nc2ccccc12 |
| ZR93 | A5.2 | CCN(CC)C(═O)c1cc(C)nc2ccc(C)cc12 |
| ZR125 | A5.2 | CCOC1═N/C(═C(/O)c2ccccc2)C(C)═C1C |
| ZR141 | A5.2 | CC(═O)/C═C(\C)Nc1cccc2c1c(C)c(C)n2C |
| ZR146 | A5.2 | CCO/C(C)═C1/C(═O)N(CC)c2ccccc21 |
| ZR204 | A5.2 | CCN(CC)C(═O)c1cc(C)nc2c(C)c(C)ccc12 |
| ZR256 | A5.2 | C═CCNC(═O)c1oc2ccc(C)cc2c1C |
| ZR289 | A5.2 | Cc1nc2ccccc2c(C(═O)N(C)C(C)C)c1C |
| ZR326 | A5.2 | CCN(CC)C(═O)c1cccc2cccnc12 |
| ZR349 | A5.2 | COC(═O)c1c(C(C)C)nc2ccccc2c1C |
| ZR365 | A5.2 | CCCN(C)C(═O)c1cc(C)nc2c(C)cccc12 |
| ZR407 | A5.2 | CCNC(═O)c1c(C)c(-c2ccccc2)n(C)c1C |
| ZR201 | | COc1cccc(-c2ccnc3c2C(═O)C[C@H](C)C3)c1 |
| ZR12 | A6.1 | CCOC(═O)c1cc(C)n(CC(═O)NC)c1C |
| ZR24 | A6.1 | C═C(C)CN(CC)C(═O)c1cc(C(C)═O)cn1C |
| ZR42 | A6.1 | COc1ccc(NC(═O)C(C)(C)OC)c(C)n1 |
| ZR44 | A6.1 | CCO/N═C/c1[nH]c(C)c(C(═O)OCC)c1C |
| ZR45 | A6.1 | CCON═Cc1[nH]c(C)c(C(═O)OCC)c1C |
| ZR54 | A6.1 | COC[C@@H](C)NC(═O)/C═C/c1c(C)nn(C)c1C |
| ZR76 | A6.1 | CC[C@](C)(OC)C(═O)Nc1cnc(OC)c(C)c1 |
| ZR77 | A6.1 | COC[C@H](C)NC(═O)/C═C/c1c(C)nn(C)c1C |
| ZR78 | A6.1 | CCN(C[C@@H](C)C#N)C(═O)c1cnnc(C)c1 |
| ZR187 | A6.1 | C═CC(═O)N1CCOC[C@@H]1c1c(C)nn(C)c1C |
| ZR218 | A6.1 | CC[C@@](C)(OC)C(═O)Nc1ccc(OC)nc1C |
| ZR239 | A6.1 | CCCC(═O)Nc1c(C(═O)N(C)C)nn(C)c1C |
| ZR241 | A6.1 | COCC(C)(C)CNC(═O)c1c(C)ncnc1C |
| ZR264 | A6.1 | Cc1c(NC(═O)C(C)C)c(C(═O)N(C)C)nn1C |
| ZR277 | A6.1 | CC[C@](C)(OC)C(═O)Nc1ccc(OC)nc1C |
| ZR284 | A6.1 | COC(═O)C(C)(C)CNC(═O)c1occc1C |
| ZR306 | A6.1 | C═CC(═O)N1CCOC[C@H]1c1c(C)nn(C)c1C |
| ZR319 | A6.1 | CC(═O)c1cc(C#N)c(N2CCCC2)nc1C |
| ZR341 | A6.1 | CCN(CC)C(═O)/C═C/c1c(C)nn(C)c1Cl |
| ZR386 | A6.1 | COC(═O)[C@@H](Nc1nc(C)cc(OC)n1)C(C)C |
| ZR391 | A6.1 | CC(═O)c1cc(CNCC(═O)N(C)C)n(C)c1 |
| ZR397 | A6.1 | CC(═O)/C(═C\c1ccco1)C(═O)CCN(C)C |
| ZR433 | A6.1 | CCOc1ccc(NC(═O)C(C)(C)OC)c(C)n1 |
| ZR453 | A6.1 | COC(═O)[C@H](Nc1nc(C)cc(OC)n1)C(C)C |
| ZR460 | A6.1 | C═CCCCn1nc(C)c([C@@H](C)C(═O)OC)c1C |
| ZR15 | A6.2 | C#CCN(CC#CC)C(═O)[C@@H](C)n1nc(C)cc1C |
| ZR22 | A6.2 | C═CCOc1nc(C)c2c(c1C#N)CC(C)(C)OC2 |
| ZR32 | A6.2 | C═CN1CC[C@H](C(═O)c2cccc(N(C)C)c2)C1═O |
| ZR46 | A6.2 | CCN(C(C)═O)c1cccc(C(═O)/C═C/N(C)C)c1 |
| ZR67 | A6.2 | CCN(C(C)═O)c1cccc(C(═O)/C═C\N(C)C)c1 |
| ZR70 | A6.2 | Cc1nn(C)c(C)c1/C═C/C(═O)N(C)CCC#N |
| ZR86 | A6.2 | CCOC(═O)c1[nH]c(C)c(CCC(═O)OC)c1C |
| ZR116 | A6.2 | C═CN1CC[C@@H](C(═O)c2cccc(N(C)C)c2)C1═O |
| ZR126 | A6.2 | Cc1nn(C)c(C)c1/C═C\C(═O)NC(C)(C)C#N |
| ZR140 | A6.2 | COCCC(═O)Nc1ccc(C)c(C(═O)N(C)C)c1 |
| ZR154 | A6.2 | C#CCN(CC#CC)C(═O)[C@H](C)n1nc(C)cc1C |
| ZR161 | A6.2 | CC(═O)c1cc(C#N)c(N2CCOCC2)nc1C |
| ZR167 | A6.2 | CCOc1ncccc1C(═O)N(CC)C[C@H](C)C#N |
| ZR238 | A6.2 | C═CCN(CC═C)C(═O)/C═C/c1c(C)nn(C)c1C |
| ZR293 | A6.2 | COc1cccc(C(═O)O[C@H](C)C(C)(C)C#N)n1 |
| ZR300 | A6.2 | COccccc(C(═O)O[C@@H](C)C(C)(C)C#N)n1 |
| ZR380 | A6.2 | COCCCNC(═O)c1[nH]c(C)c(C(C)═O)c1C |
| ZR410 | A6.2 | CCOC(═O)c1[nH]c(COC(C)═O)c(CC)c1C |
| ZR483 | A6.2 | C═C(C)CCOC(═O)c1ccc(C(═O)N(C)C)cc1 |
| ZR496 | A6.2 | Cc1cc(C(═O)N2CCC[C@@](C)(C#N)C2)cc(C)n1 |
| ZR47 | A6.3 | C═C[C@H](C)OC(═O)c1cn(C(C)(C)C)nc1C |
| ZR48 | A6.3 | COCCNC(═O)c1c(C)noc1C(C)C |
| ZR71 | A6.3 | C═C[C@@H](C)OC(═O)c1cn(C(C)(C)C)nc1C |
| ZR165 | A6.3 | COC[C@@H](C)NC(═O)c1c(C)noc1C(C)C |
| ZR177 | A6.3 | CCc1c(C)nn(C)c1NC(═O)C(C)(C)OC |
| ZR181 | A6.3 | COC[C@H](C)NC(═O)c1c(C)noc1C(C)C |
| ZR203 | A6.3 | C#CCn1c(C)cc(C(═O)OC(C)(C)C)c1C |
| ZR280 | A6.3 | CCN(CC)C(═O)/C═C/c1c(C)nn(C)c1C |
| ZR465 | A6.3 | C═C(C)Cn1nc(C)c([C@@H](C)C(═O)OC)c1C |
| ZR476 | A6.3 | CCOC(═O)C1═C(C)N/C(═C\N(C)C)C1═O |
| ZR477 | A6.3 | CCOC(═O)C1═C(C)N/C(═C/N(C)C)C1═O |
| ZR13 | A7 | C═C(C)CN(C)C(═O)c1cc(CNC(═O)C(C)(C)C)ccc1Cl |
| ZR41 | A7 | CC(═O)C[C@@H](C)NC(═O)/C═C/c1c(C)nn(CC(C)C)c1Cl |
| ZR155 | A7 | CC(═O)C[C@@H](C)NC(═O)/C═C\c1c(C)nn(CC(C)C)c1Cl |
| ZR156 | A7 | CC(═O)C[C@H](C)NC(═O)/C═C\c1c(C)nn(CC(C)C)c1Cl |
| ZR253 | A7 | CCOc1ccc([C@H]2NC(═S)NC(C)═C2C(═O)NC)cc1OCC |
| ZR265 | A7 | CCOc1cc(C)c(/C═C2\NC(═S)N(CC)C2═O)cc1C(C)C |
| ZR273 | A7 | CCCC1═C(C(═O)OCC)[C@@H](c2cccc(OC)c2)NC(═S)N1 |
| ZR290 | A7 | CCCN1C(═O)/C(═C/c2cc(C(C)C)c(OC)cc2C)NC1═S |
| ZR396 | A7 | CC(═O)C[C@H](C)NC(═O)/C═C/c1c(C)nn(CC(C)C)c1Cl |
| ZR412 | A7 | CCOc1cc(C)c(/C═C2/C(═O)N(CC)C(═S)N2C)cc1C(C)C |
| ZR419 | A7 | COc1ccc([C@H]2NC(═S)NC(C)═C2C(═O)N(C)C)c(OC)c1 |
| ZR488 | A7 | CCOc1ccc([C@@H]2NC(═S)NC(C)═C2C(═O)NC)cc1OCC |
| ZR14 | A8.1 | CCCn1nc(C(═O)NC)c2ccccc2c1═O |
| ZR16 | A8.1 | CCNC(═O)c1nn(CC)c(═O)c2ccccc12 |
| ZR26 | A8.1 | CCOC(═O)CC[C@]1(C)C(═O)N(C)c2ccccc21 |
| ZR27 | A8.1 | CCOC(═O)CC[C@@]1(C)C(═O)N(C)c2ccccc21 |
| ZR57 | A8.1 | COc1ccc2c(c1)CC[C@@](C)(CCC#N)C2═O |
| ZR103 | A8.1 | CCCn1nc(C(═O)NCC)c2ccccc2c1═O |
| ZR160 | A8.1 | CC(═O)CC[C@@H]1C(═O)N(C)C(═O)c2ccccc21 |
| ZR162 | A8.1 | CC(═O)CC[C@H]1C(═O)N(C)C(═O)c2ccccc21 |
| ZR169 | A8.1 | CC1(C)OC(C)(C)/C(═C\c2ccc(Cl)cc2)C1═O |
| ZR274 | A8.1 | CO[C@@H](CNC(═O)C(C)(C)C)c1ccccc1Cl |
| ZR321 | A8.1 | CC(C)NC(═O)c1nn(C)c(═O)c2ccccc12 |
| ZR336 | A8.1 | COC(═O)C1(c2cccc(Cl)c2)CCC(═O)CC1 |
| ZR438 | A8.1 | COC(═O)[C@H]1CCC(═O)N(C)[C@@H]1c1ccccc1 |
| ZR440 | A8.1 | COC(═O)[C@@H]1CCC(═O)N(C)[C@H]1c1ccccc1 |
| ZR447 | A8.1 | COC(═O)C1(c2ccc(C═O)cc2)CC═CC1 |
| ZR500 | A8.1 | CCC(═O)Nc1ccc2c(c1)C(C)(C)C(═O)N2C |
| ZR33 | A8.2 | C═C1N(C(═O)c2ccccc2)N═C(C)C1(C)C |
| ZR74 | A8.2 | CCC(═O)N1N═C(C)C[C@]1(O)c1ccccc1 |
| ZR80 | A8.2 | CCC(═O)N1N═C(C)C[C@@]1(O)c1ccccc1 |
| ZR111 | A8.2 | CCC(═O)N1N═C(C)C[C@]1(O)c1cccnc1 |
| ZR231 | A8.2 | CC1═NN(C(═O)C(C)C)[C@@](O)(c2cccnc2)C1 |
| ZR248 | A8.2 | CC(═O)N1N═C(C)C[C@@]1(O)c1ccccc1 |
| ZR250 | A8.2 | CCC(═O)N1N═C(C)C[C@@]1(O)c1cccnc1 |
| ZR259 | A8.2 | CCC1═N[C@@H](c2ccccc2Cl)N(O)C1(C)C |
| ZR267 | A8.2 | CC[C@@H]1C(═O)C(C)(C)C(═O)O[C@H]1c1ccccc1 |
| ZR279 | A8.2 | CCC1═N[C@H](c2ccccc2Cl)N(O)C1(C)C |
| ZR344 | A8.2 | Cc1ncc([C@@](C)(O)c2ccccc2)n1C |
| ZR415 | A8.2 | CC1═NN(C(═O)C(C)C)[C@@](O)(c2ccccc2)C1 |
| ZR429 | A8.2 | CC(C)N1Cc2cc(Cl)ccc2O[C@@H](C)C1═O |
| ZR485 | A8.2 | CCn1nc(C(═O)NC)c2ccccc2c1═O |
| ZR145 | A8.3 | CCOC(═O)Cn1c(C)cc(═O)c2cc(C)cc(C)c21 |
| ZR178 | A8.3 | COCCNC(═O)c1nn(C)c(═O)c2ccccc12 |
| ZR278 | A8.3 | CC(═O)Nc1ccc2c(c1)N(C)C(═O)C(C)(C)CO2 |
| ZR295 | A8.3 | CCOC(═O)c1c(/N═C/N(C)C)c(C#N)c2n1CCCC2 |
| ZR296 | A8.3 | CCOC(═O)c1c(N═CN(C)C)c(C#N)c2n1CCCC2 |
| ZR308 | A8.3 | CCCc1cc(═O)oc2cc(OC(C)C)c(Cl)cc12 |
| ZR334 | A8.3 | COC(═O)C(C)(C)[C@]1(c2ccc(OC)cc2)CCC(═O)O1 |
| ZR335 | A8.3 | CCC1═NN(C(═O)C(C)C)[C@](O)(c2cccc(OC)c2)C1 |
| ZR338 | A8.3 | CCn1nc(C(═O)NCCOC)c2ccccc2c1═O |
| ZR401 | A8.3 | CCc1cc2c(C)c(CC)c(═O)oc2cc1OCC(C)═O |
| ZR416 | A8.3 | CC(C)NC(═O)[C@]1(C)CC(c2ccccc2Cl)═NO1 |
| ZR17 | A9 | CCOc1ccccc1[C@@H]1NC(═S)NC(C)═C1C(C)═O |
| ZR25 | A9 | CCN1C(═O)CC[C@@H](C(═O)NC)[C@@H]1c1ccccc1Cl |
| ZR50 | A9 | CCOc1ccccc1[C@H]1NC(═S)NC(C)═C1C(C)═O |
| ZR85 | A9 | CC1═C(C(═O)N(C)C)[C@H](c2ccc(C)cc2)NC(═S)N1 |
| ZR106 | A9 | COc1ccc(Cl)cc1-c1ccc([C@@H](C)NC(C)═O)cc1 |
| ZR132 | A9 | CC1═C(C(═O)N(C)C)[C@@H](c2ccc(C)cc2)NC(═S)N1 |
| ZR144 | A9 | CC(═O)C1═C(C)NC(═S)N[C@@H]1/C═C/c1ccccc1 |
| ZR232 | A9 | CC1═C(C(═O)N(C)C)[C@@H](c2ccccc2)NC(═S)N1 |
| ZR270 | A9 | CCOC(═O)C1═C(C)N(C)C(═S)N[C@@H]1c1ccccc1 |
| ZR291 | A9 | CCOC(═O)C1═C(C)N(C)C(═S)N[C@H]1c1ccccc1 |
| ZR314 | A9 | CCOC(═O)C1═C(c2ccccc2)NC(═S)N[C@@H]1CC |
| ZR315 | A9 | CC(═O)c1cccc(N2C(C)═CC(C)(C)N═C2S)c1 |
| ZR343 | A9 | CCC(═O)c1cccc(—n2nc(C)c(CC(C)═O)c2C)c1 |
| ZR347 | A9 | CCN1C(═O)/C(═C/c2ccc(OC)c(C)c2)N(C)C1═S |
| ZR358 | A9 | CC1═C(C(═O)N(C)C)[C@H](c2ccccc2)NC(═S)N1 |
| ZR363 | A9 | CCN1C(═O)CC[C@@H](C(═O)NC)[C@@H]1c1cccc(Cl)c1 |
| ZR376 | A9 | CCC(═O)[C@H](C#N)[C@@H](c1ccco1)c1ccccc1OC |
| ZR384 | A9 | Cc1nn(C)c(C)c1[C@@H](C)C(═O)N(C)[C@H](C)c1ccc(Cl)cc1 |
| ZR390 | A9 | CCC[C@@H]1NC(═S)N(c2ccccc2)C(C)═C1C(C)═O |
| ZR394 | A9 | CCC1═C(C(═O)OC)[C@H](c2ccccc2)NC(═S)N1 |
| ZR408 | A9 | CC(C)(C)n1cccc(/C═C/C(═O)c2ccccc2)c1═S |
| ZR409 | A9 | CCOCC(═O)N(CC)[C@@H](c1ccc(Cl)cc1)c1cccnc1 |
| ZR414 | A9 | CCC[C@H]1NC(═S)N(c2ccccc2)C(C)═C1C(C)═O |
| ZR470 | A9 | COc1cc(C)c(C(═O)N(C)c2ccccc2)cc1C(C)C |
| ZR34 | A10.1 | CCOC(═O)CCc1ccncc1C(═O)OC |
| ZR52 | A10.1 | COC[C@H](C)C(═O)Nc1cccc(C)c1C(C)═O |
| ZR73 | A10.1 | CCC(═O)Nc1cccc(C(═O)N(C)OC)c1 |
| ZR88 | A10.1 | COC(C)(C)C(═O)Nc1ccc(C(C)═O)cn1 |
| ZR90 | A10.1 | COc1cc(NC(═O)CC(C)═O)cc(OC)c1 |
| ZR112 | A10.1 | CC#CCOC(═O)c1cncc(OC(C)C)c1 |
| ZR113 | A10.1 | COc1ccc(OC)c(NC(═O)CC(C)═O)c1 |
| ZR137 | A10.1 | COc1cc(NC(═O)[C@@H](C)OC)cc(OC)c1 |
| ZR143 | A10.1 | COc1ccc(NC(═O)CC(C)═O)cc1OC |
| ZR147 | A10.1 | COC[C@@H](C)C(═O)Nc1cccc(C)c1C(C)═O |
| ZR168 | A10.1 | C═CC[C@@H](OC(C)═O)c1ccc(OC)c(OC)c1 |
| ZR182 | A10.1 | C═CCN(CC═C)C(═O)c1cc(OC)cc(OC)c1 |
| ZR192 | A10.1 | CON(C)C(═O)c1ccc(C)c(NC(C)═O)c1 |
| ZR193 | A10.1 | COc1cc(NC(═O)[C@H](C)OC)cc(OC)c1 |
| ZR222 | A10.1 | COc1ccc(NC(═O)[C@H](C)C(C)═O)cc1 |
| ZR227 | A10.1 | COc1ccc(NC(═O)CC(C)═O)c(OC)c1 |
| ZR257 | A10.1 | C═CC[C@H](OC(C)═O)c1ccc(OC)c(OC)c1 |
| ZR272 | A10.1 | C═CCNC(═O)/C═C/c1cc(OC)ccc1OC |
| ZR275 | A10.1 | COc1cccc(NC(═O)CC(C)═O)c1OC |
| ZR299 | A10.1 | CON(C)C(═O)C[C@@H](NC(C)═O)c1ccccc1 |
| ZR312 | A10.1 | CCC(═O)Oc1ccc(C(═O)CC)cc1OC |
| ZR356 | A10.1 | COc1ccc(NC(═O)[C@@H](C)C(C)═O)cc1 |
| ZR387 | A10.1 | C═CCCC(═O)N(C)c1cc(OC)cc(OC)c1 |
| ZR388 | A10.1 | CCOCC(═O)Nc1cccc(C)c1C(C)═O |
| ZR400 | A10.1 | CCOC(═O)c1cc(C)nn(CCOC)c1═O |
| ZR411 | A10.1 | COC(═O)C[C@@H](N)c1ccc(OC)cc1OC |
| ZR421 | A10.1 | CON(C)C(═O)c1ccc(NC(C)═O)cc1 |
| ZR442 | A10.1 | C═CCNC(═O)Cc1cc(OC)ccc1OC |
| ZR456 | A10.1 | COCCOc1ccc(O)cc1C(═O)N(C)C |
| ZR461 | A10.1 | C═CCc1cc(C(═O)NC2CC2)cc(OC)c1OC |
| ZR480 | A10.1 | C═CCN(CC═C)C(═O)c1ccc(OC)cc1OC |
| ZR484 | A10.1 | CCCOCC(═O)Nc1cccc(C)c1C(C)═O |
| ZR39 | A10.2 | CO[C@@H](C)C(═O)NCc1ccc(C(C)═O)c(C)n1 |
| ZR53 | A10.2 | COC(═O)CCc1cc(OC)ccc1NC(C)═O |
| ZR63 | A10.2 | CO[C@H](C)C(═O)NCc1ccc(C(C)═O)c(C)n1 |
| ZR65 | A10.2 | COC(═O)C[C@@H](NC(C)═O)c1ccc(OC)cc1 |
| ZR92 | A10.2 | COC(═O)C[C@H](NC(C)═O)c1ccc(OC)cc1 |
| ZR96 | A10.2 | COCCCC(═O)Oc1c(C)cc(C#N)cc1C |
| ZR152 | A10.2 | CCOC(═O)C(═Cc1cccnc1)C(═O)OCC |
| ZR153 | A10.2 | COc1ccc(CNC(═O)CC(C)═O)cc1OC |
| ZR183 | A10.2 | CCNC(═O)COc1ccc(C#N)cc1OCC |
| ZR271 | A10.2 | CCOC(═O)C(═Cc1ccncc1)C(═O)OCC |
| ZR294 | A10.2 | CCOc1cc(C═O)ccc1O[C@H](C)C(═O)N(C)C |
| ZR311 | A10.2 | CCOc1cc(C═O)ccc1OCC(═O)N(C)C |
| ZR353 | A10.2 | CCOc1cc(C═O)ccc1O[C@@H](C)C(═O)OC |
| ZR405 | A10.2 | CCOc1cc(C═O)ccc1O[C@@H](C)C(═O)N(C)C |
| ZR420 | A10.2 | C═CCc1cc(C═O)ccc1OCC(═O)OCC |
| ZR436 | A10.2 | CCOc1cc(C═O)ccc1O[C@H](C)C(═O)OC |
| ZR469 | A10.2 | CCOC(═O)C(═Cc1ccc(OC)cc1)C(═O)OCC |
| ZR59 | A10.3 | COc1ccc(C)nc1NC(═O)[C@H](C)OC |
| ZR66 | A10.3 | COc1ccc(C)nc1NC(═O)[C@@H](C)OC |
| ZR166 | A10.3 | COc1ccc(OC)c([C@H](C)NC(C)═O)c1 |
| ZR198 | A10.3 | COc1ccccc1C(═O)[C@H](C)NC(C)═O |
| ZR224 | A10.3 | COc1ccc(OC)c([C@@H](C)NC(C)═O)c1 |
| ZR225 | A10.3 | CCOC(═O)[C@@H](C(═O)N(C)C)c1ccccc1 |
| ZR242 | A10.3 | CCOC(═O)[C@H](C(═O)N(C)C)c1ccccc1 |
| ZR288 | A10.3 | C═CCO[C@H](C)C(═O)N(C)c1cccc(C)n1 |
| ZR310 | A10.3 | CC(═O)Nc1c(C)cccc1C(═O)OC(C)C |
| ZR329 | A10.3 | COc1ccc(C)cc1NC(═O)CC(C)═O |
| ZR362 | A10.3 | C═CCOc1[nH]nc(C)c1CC(═O)OCC |
| ZR403 | A10.3 | COc1ccccc1C(═O)[C@@H](C)NC(C)═O |
| ZR36 | A11 | COCCC(═O)N(C)Cc1c(C)[nH]c(C(═O)OC)c1C |
| ZR40 | A11 | COc1ccc(C(═O)N(C)CC#N)c(OCC(C)C)c1 |
| ZR75 | A11 | CCOC(C)(C)C(═O)Nc1cccc(C(═O)N(C)C)c1C |
| ZR114 | A11 | COc1cc(/C═C/C(═O)NC[C@H](C)C#N)cc(OC)c1 |
| ZR115 | A11 | COc1cc(/C═C/C(═O)NC[C@@H](C)C#N)cc(OC)c1 |
| ZR158 | A11 | CC[C@@H](OC)C(═O)Nc1ccc(OC)c(C(═O)N(C)C)c1 |
| ZR175 | A11 | CC[C@H](OC)C(═O)Nc1ccc(OC)c(C(═O)N(C)C)c1 |
| ZR186 | A11 | CCOc1cc(C(═O)N(C)CCC(═O)NC)ccc1OC |
| ZR262 | A11 | CCN(C[C@@H](C)C(═O)OC)C(═O)c1ccc(OC)cc1OC |
| ZR331 | A11 | CCOC(═O)/C(═N\Nc1cc(C)ccc1OC)C(C)═O |
| ZR379 | A11 | COCCCNC(═O)/C(C#N)═C/c1ccc(OC)c(C)c1 |
| ZR398 | A11 | CCOC(═O)/C═C/c1cnccc1NC(═O)C(C)(C)C |
| ZR439 | A11 | CCOC(C)(C)C(═O)Nc1ccc(OC)cc1C#N |
| ZR64 | A12 | CCOC(═O)c1cnc(N)nc1CC |
| ZR72 | A12 | CONC(═O)c1c(C)noc1C(C)C |
| ZR98 | A12 | CCNC(═O)c1c(N)cnn1C(C)C |
| ZR108 | A12 | CCn1c(N)ccc1C(═O)OC |
| ZR188 | A12 | CCOC(═O)[C@@H]1NC(C)═CC(C)═C1N |
| ZR210 | A12 | CCOC(═O)c1cc(N)nn1CC |
| ZR281 | A12 | CCOC(═O)C(C)(C)n1cc(N)cn1 |
| ZR324 | A12 | CCOC(═O)c1c(C)ccnc1C |
| ZR443 | A12 | CCOC(═O)[C@H]1NC(C)═CC(C)═C1N |
| ZR450 | A12 | CCCn1ncc(N)c1C(═O)N(C)C |
| ZR472 | A12 | CCOC(═O)c1c(N)c(C)nn1CC |
| ZR83 | A13 | CCc1c(C═O)c(C)n(-c2cc(C)cc(C)c2)c1C |
| ZR84 | A13 | CCc1c(C═O)c(C)n(-c2cccc(C)c2C)c1C |
| ZR99 | A13 | CCc1c(C═O)c(C)n(-c2ccc(C)cc2)c1C |
| ZR129 | A13 | CCc1c(C═O)c(C)n(-c2cc(C)ccc2C)c1C |
| ZR157 | A13 | CCc1c(C═O)c(C)n(-c2ccc(C)cn2)c1C |
| ZR185 | A13 | CCc1c(C═O)c(C)n(-c2cccc(C)n2)c1C |
| ZR200 | A13 | CCc1c(C═O)c(C)n(-c2cccc(C)c2)c1C |
| ZR216 | A13 | CCc1c(C═O)c(C)n(-c2ccccn2)c1C |
| ZR229 | A13 | CCc1c(C═O)c(C)n(-c2cc(C)ccn2)c1C |
| ZR240 | A13 | CCc1c(C═O)c(C)n(-c2ccc(C)c(C)c2)c1C |
| ZR283 | A13 | CCc1c(C═O)c(C)n(-c2cccnc2)c1C |
| ZR305 | A13 | CCc1c(C═O)c(C)n(-c2c(C)cccc2C)c1C |
| ZR332 | A13 | CCc1c(C═O)c(C)n(-c2cccc(OC)c2)c1C |
| ZR354 | A13 | CCc1c(C═O)c(C)n(-c2ccc(C)cc2C)c1C |
| ZR381 | A13 | CCc1c(C═O)c(C)n(-c2ccccc2C)c1C |
| ZR105 | A14 | C═C(C)c1ccc2c(c1)C(═O)C[C@H]1[C@](C)(C#N)CCC[C@@]21C |
| ZR205 | A14 | C═C(C)c1ccc2c(c1)C(═O)C[C@@H]1[C@](C)(C#N)CCC[C@@]21C |
| ZR367 | A14 | CCOC(═O)[C@H](C#N)[C@@H](c1ccccc1OC)[C@H]1CCOC(C)(C)C1 |
| ZR399 | A14 | CCOC(═O)[C@@H](C#N)[C@H](c1ccccc1OC)[C@@H]1CCOC(C)(C)C1 |
| ZR431 | A14 | C═C(C)c1ccc2c(c1)C(═O)C[C@H]1[C@]2(C)CCC[C@@]1(C)C#N |
| ZR464 | A14 | CCOC(═O)[C@H](C#N)[C@H](c1ccccc1OC)[C@H]1CCOC(C)(C)C1 |
| ZR473 | A14 | CCOC(═O)[C@H](C#N)[C@H](c1ccccc1OC)[C@@H]1CCOC(C)(C)C1 |
| ZR171 | A15 | CCN(Cc1ccccc1Cl)C(═O)COC |
| ZR174 | A15 | COC(═O)CN(C)Cc1cc(Cl)ccc1OC |
| ZR206 | A15 | C═CCCC(═O)NC[C@@H](OC)c1ccccc1Cl |
| ZR263 | A15 | COCC[C@@H](NC(═O)[C@@H](C)OC)c1ccc(Cl)cc1 |
| ZR276 | A15 | COCC[C@H](NC(═O)[C@H](C)OC)c1ccc(Cl)cc1 |
| ZR317 | A15 | COCC[C@@H](C)N[C@H](C(═O)OC)c1ccccc1Cl |
| ZR328 | A15 | COCC[C@H](C)N[C@@H](C(═O)OC)c1ccccc1Cl |
| ZR339 | A15 | CCOCC(═O)NC[C@@H](OC)c1ccccc1Cl |
| ZR340 | A15 | COCC(═O)N(C)Cc1cccc(Cl)c1 |
| ZR366 | A15 | CCOCC(═O)NC[C@H](OC)c1ccccc1Cl |
| ZR372 | A15 | COCC[C@H](C)N[C@H](C(═O)OC)c1ccccc1Cl |
| ZR375 | A15 | CCCC(═O)NC[C@@H](OC)c1ccccc1Cl |
| ZR413 | A15 | COCC[C@@H](NC(═O)[C@H](C)OC)c1ccc(Cl)cc1 |
| ZR417 | A15 | C═CCCC(═O)NC[C@H](OC)c1ccccc1Cl |
| ZR426 | A15 | COCC[C@@H](C)N[C@@H](C(═O)OC)c1ccccc1Cl |
| ZR428 | A15 | COCC(═O)NCCc1ccc(OC)cc1Cl |
| ZR434 | A15 | COCC[C@H](NC(═O)[C@@H](C)OC)c1ccc(Cl)cc1 |
| ZR475 | A15 | CO[C@H](CNC(C)═O)c1ccccc1Cl |

TABLE A.1
Images of 6 conserved cores of several compounds in Table A.

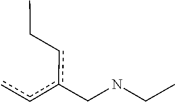

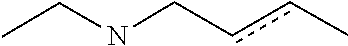

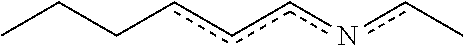

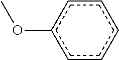

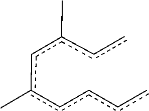

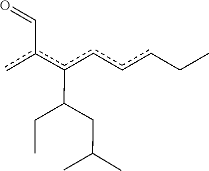

TABLE A.2
2 Structures of conserved core of several groups of compounds in Table A.

| Group | Core Structure |
|---|---|
| A1.1 | 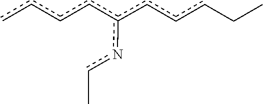 |
| A1.2 | 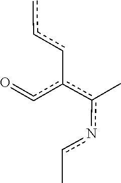 |
| A1.3 | 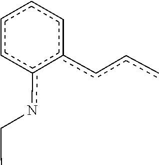 |
| A2.1 | 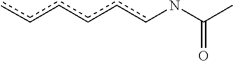 |
| A2.2 | 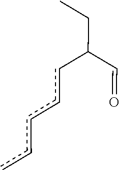 |
| A2.3 | 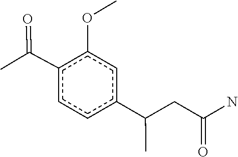 |
| A3.1 | 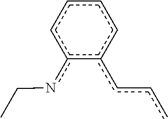 |
| A3.2 | 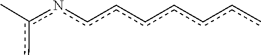 |
| A3.3 | 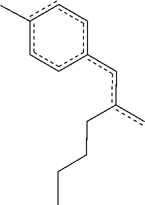 |
| A4.1 | 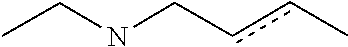 |
| A4.2 | 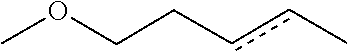 |
| A4.3 | 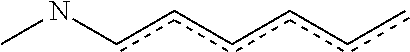 |
| A5.1 | 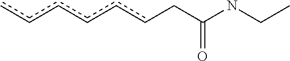 |
| A5.2 | 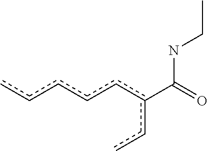 |
| A6.1 | 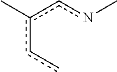 |
| A6.2 | 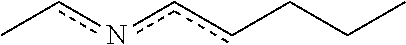 |
| A6.3 | 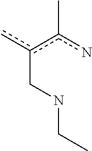 |
| A7 | 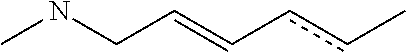 |
| A8.1 | 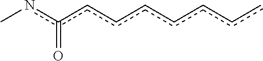 |
| A8.2 | 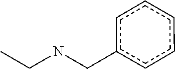 |
| A8.3 | 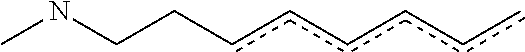 |
| A9 | 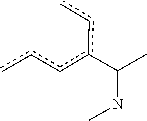 |
| A10.1 | 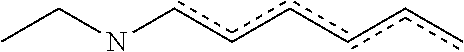 |
| A10.2 | 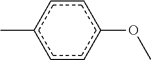 |
| A10.3 | 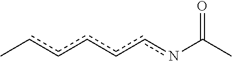 |
| A11 | 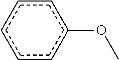 |
| A12 | 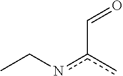 |
| A13 | 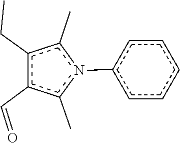 |
| A14 | 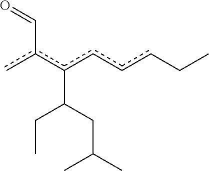 |
| A15 | 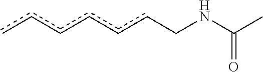 |

TABLE B

| Com- | | |
|---|---|---|
| pound ID | Group | SMILES |
| NR0125155 | B1 | CCOC(═O)c1ccc(cn1)OC |
| NR0126694 | B1 | CCOC(═O)c1cc(n(n1)CO)C |
| NR0267404 | B1 | c12c([C@H](CCC2═O)O)cccc1OC |
| NR0279863 | B1 | [C@@]1(O[C@@H]1C)(c1oc(═O)c(cc1)C)C |
| NR0315700 | B1 | C1═C(C(═O)C═C(C1═O)C)OCC |
| NR0327396 | B1 | c12c([C@@H](NC(═O)C2)C)cncc1OC |
| NR0333355 | B1 | c12c(C[C@H](CC2═O)C)occ1C |
| NR0344725 | B1 | C1(═CC(═O)C═C(C1═O)C)OCC |
| NR0350800 | B1 | [C@]1(c2c(NC1═O)cccc2)(OC)CC |
| NR0376327 | B1 | c12c(C[C@@H]([C@@H](C1═O)O)C)occ2C |
| NR0379358 | B1 | c12c([C@H](CC)O)cncc1CCC2═O |
| NR0044097 | B2 | C[C@]1(Cc2c(cc(c([n+]2)N)C(═O)[O−])CO1)C |
| NR0047023 | B2 | C[C@@]1(CC2═C([C@H](CC(═O)N2)c2ccccc2OC)C(═O)C1)C |
| NR0047653 | B2 | CCOC(═O)c1cc2c(nc1NC(═O)C)C[C@](OC2)(C)C |
| NR0065044 | B2 | C[C@H]1CC(═C(C2=N[C@](Cc3c2cccc3)(C)C)C(═O)C1)[O−] |
| NR0074832 | B2 | CCOC(═O)c1cc2c(nc1C)C[C@@](CC2═O)(C)C |
| NR0075036 | B2 | Cc1c2c3ccccc3nc2c2c(n1C)C[C@@](CC2═O)(C)C |
| NR0087381 | B2 | Cc1c2c(c(c(n1)OCC═C)C#N)C[C@](OC2)(C)C |
| NR0093187 | B2 | CCOC(═O)c1cc2c(nc1N)C[C@](OC2)(C)C |
| NR0099165 | B2 | CC(═C)COc1c(cc2c(n1)C[C@](OC2)(C)C)C#N |
| NR0123554 | B2 | CC(═O)c1c2c(c(c3c1CCCN3)C(═O)C)NCCC2 |
| NR0124999 | B2 | CC1═C([C@@H](CC(═O)N1C)c1ccccc1)C(═O)OC |
| NR0125000 | B2 | CC1═C([C@H](CC(═O)N1C)c1ccccc1)C(═O)OC |
| NR0125215 | B2 | CCOC(═O)C1═C(N(C(=S)N[C@@H]1c1ccccc1)C)C |
| NR0125216 | B2 | CCOC(═O)C1═C(N(C(=S)N[C@H]1c1ccccc1)C)C |
| NR0129020 | B2 | CCC/N═C(/c1c(═O)c2ccccc2n(c1[O−])C)C |
| NR0129021 | B2 | CC[C@@H](C)/N═C(\c1c(═O)c2ccccc2n(c1[O−])C)C |
| NR0129022 | B2 | CC[C@H](C)/N═C(\c1c(═O)c2ccccc2n(c1[O−])C)C |
| NR0131472 | B2 | C[C@]1(Cc2c(c(c3ccccc3[n+]2)NC)C(═O)C1)C |
| NR0141474 | B2 | CC(═O)Nc1c2ccccc2nc2c1C(═O)C[C@@](C2)(C)C |
| NR0213862 | B2 | C1(=NC(C(═O)N1)(C(C)C)C)c1cc(ccc1C(═O)OC)C |
| NR0394059 | B2 | c12c(c(c(═O)n(c1cccc2)C)CC(═O)[C@H](C)C)OC |
| NR0157773 | B3 | Cc1cc2c(c(c1CCO)C)C(═O)[C@@H]([C@H]2O)C |
| NR0159002 | B3 | Cc1cc2c(c(c1CCO)C)C(═O)[C@@](C2)(C)CO |
| NR0234310 | B3 | c12c(cc(c(c1C)CCO)CO)C[C@@H](C2═O)C |
| NR0234958 | B3 | [C@]1(C(═O)c2c(C1)cc(c(c2C)CCO)C)(CO)C |
| NR0245839 | B3 | c12c(C(=O)[C@]([C@H]1O)(C)C)c(c(cc2[C@@H](C)C)OC)C |
| NR0266911 | B3 | c1(c(cc2c(c1C)C(═O)[C@@](C2)(C)CO)C)CCOC |
| NR0277472 | B3 | c12c(cc(c(c1C)CCO)C)C[C@H](C2═O)C |
| NR0278246 | B3 | c12c(C(═O)[C@@H]([C@@H]2O)C)cc(c(c1C)CCO)C |
| NR0309630 | B3 | c12C(═O)[C@](Cc1cc(c(c2C)CCO)C)(O)C |
| NR0319104 | B3 | c12c(cc(c(c1C)CC(═O)O)C)C[C@@H](C2═O)C |
| NR0325443 | B3 | c12c([C@@H]([C@@H](C2═O)C)O)cc(c(c1C)CCO)C |
| NR0340230 | B3 | c12c(C(═O)[C@H]([C@@H]2O)C)cc(c(c1C)CCO)C |
| NR0351917 | B3 | c12c(cc(c(c1C)CO)C)C[C@H](C2═O)C |
| NR0352723 | B3 | c12c(c(c3c(c2)C(=O)OCC3)C)C[C@]([C@H]1O)(CO)C |
| NR0365273 | B3 | c12c(cc(c(c1C)CCO)C)COC2═O |
| NR0377154 | B3 | c12c([C@H]([C@@H](C2═O)C)O)cc(c(c1C)CCO)C |
| NR0382953 | B3 | [C@]12(c3c([C@]([C@H]1O)(C)C)ccc(c3C(═O)OC2)C)C |
| NR0391441 | B3 | c12c([C@H]([C@](C1═O)(C)C)O)cc1c(c2C)CCOC1═O |
| NR0395222 | B3 | c12C(═O)[C@@](Cc1cc(c(c2C)CCOC)C)(CO)C |
| NR0396964 | B3 | c12c([C@H]([C@H](C2═O)C)O)cc(c(c1C)CCO)C |
| NR0044830 | B4 | Cc1c2c(═O)cccc(c2c(n1C)C)OC |
| NR0117406 | B4 | CCOC(═O)c1c(n(c2c1cccc2)C)C |
| NR0125713 | B4 | CC1=Nc2ccccc2[C@@]1(C)C(═O)OC |
| NR0125714 | B4 | CC1=Nc2ccccc2[C@]1(C)C(═O)OC |
| NR0125718 | B4 | C[C@]1(c2ccccc2N═C1C(═O)OC)C |
| NR0125722 | B4 | CCC1=Nc2ccccc2[C@@]1(C)C(═O)OC |
| NR0125723 | B4 | CCC1=Nc2ccccc2[C@]1(C)C(═O)OC |
| NR0125724 | B4 | CCOC(═O)[C@@]1(c2ccccc2N═C1C)C |
| NR0125725 | B4 | CCOC(═O)[C@]1(c2ccccc2N═C1C)C |
| NR0124251 | B5 | CC(═O)N(C)c1cccc(c1)N(C)C(═O)C |
| NR0127793 | B5 | COc1ccc(c(c1)C(═O)CCCCC(═O)OC)OC |
| NR0156680 | B5 | CC(═O)CC1═CC(═C(C(═O)C1)OC)OC |
| NR0159258 | B5 | CC(═O)CCc1cc(c(c(c1)OC)OC)O |
| NR0178126 | B5 | CC(═O)OCCc1ccc(c(c1)OC)O |
| NR0231396 | B5 | c1(c(cc(cc1OC)CCNC(═O)C)OC)OC |
| NR0275940 | B5 | c1(c(C[C@@H](C(═O)OC)CC)nccc1)C(═O)OC |
| NR0286899 | B5 | n1(c(ccc1C═O)COC)CCCC(═O)OC |
| NR0299464 | B5 | c1(c(c(ncc1COC(═O)C)C)O)COC |
| NR0305718 | B5 | c1([C@@H](C(═O)C)OCC)cc(c(cc1)O)OC |
| NR0319487 | B5 | c1(c(cc(cc1O)OC/C═C(\C)C)OC)C(═O)CCC |
| NR0324098 | B5 | c1(C(═O)[C@@H](OCC)C)cc(c(cc1)O)OC |
| NR0335556 | B5 | c1(c(C(═O)OC)cccn1)CC[C@H](C(═O)OC)C |
| NR0343433 | B5 | c1(c(cc(cc1)OC)/C═C/C)OC(═O)/C(═C\C)C |
| NR0355106 | B5 | c1(c(ccc(c1)CC(═O)OCC)OC)OC |
| NR0225693 | B6 | c12c(c(cc(c2)C(═O)C)[C@H](/C═C(\C)C)O)O[C@@](CC1═O) |
| | | (C)C |
| NR0242527 | B6 | c12c(c(cc(c1CC[C@](O2)(C)C)O)OC)C(═O)[C@@H](C)C |
| NR0244322 | B6 | c1(c2c(c(c(c1O)C/C═C(\C)C)OC)C═C[C@@](O2)(C)C)C(═O)C |
| NR0257265 | B6 | c1(c(c2c(cc1O)O[C@@](C═C2)(C)C)OC)C(═O)[C@H](C)C |
| NR0282312 | B6 | c12c(c(c(c(c1O)C(═O)C)OC)C/C═C(\C)C)O[C@H](C2)[C@@](O) |
| | | (C)C |
| NR0296302 | B6 | c12c(c(c(c(c1)OC)C(═O)[C@@H](CC)C)O)CC[C@](O2)(C)C |
| NR0316888 | B6 | c12c(cc(o2)[C@](O)(C)C)cc(cc1C[C@@H]([C@](O)(C)C)O)C |
| | | (═O)C |
| NR0340597 | B6 | c12c(cc(cc1cc(o2)[C@](O)(C)C)C(═O)C)C(═O)C[C@@H](C)C |
| NR0350774 | B6 | c12c(c(c(cc1O[C@@]([C@@H]([C@H]2OCC)O)(C)C)OC)C(═O) |
| | | C)OC |
| NR0356116 | B6 | c1(c2c(c(cc1O)O)CC[C@](O2)(C)C)C(═O)[C@H](C)C |
| NR0360908 | B6 | c1(c(c2c(cc1OC)O[C@@](C═C2)(C)C)O)C(═O)[C@@H](C)C |
| NR0372696 | B6 | c12c(cc(cc1cc(o2)[C@@](O)(C)C)C(═O)C)C(═O)/C═C(/C)C |
| NR0381679 | B6 | c1(c(c2c(cc1OC)O[C@](CC2)(C)C)O)C(═O)[C@@H](C)C |
| NR0389026 | B6 | c12c(c(c(c(c1)O)C(═O)[C@@H](CC)C)O)CC[C@](O2)(C)C |
| NR0397278 | B6 | c12c(C(=O)[C@]([C@H]1OC(=O)C)(C)C)c(c(cc2[C@H](C)C) |
| | | OC)C |
| NR0044159 | B7.1 | C[C@@]1(CC(═O)/C(═C/c2ccco2)CO1)C |
| NR0118708 | B7.1 | COc1ccc(c2c1CCC2═O)OC |
| NR0137650 | B7.1 | COc1cc2c(cc1OC)C(═O)[C@@H](C2)CO |
| NR0137651 | B7.1 | COc1cc2c(cc1OC)C(═O)[C@H](C2)CO |
| NR0137653 | B7.1 | COc1ccc(c2c1C[C@H](C2═O)CO)OC |
| NR0157732 | B7.1 | C[C@@H]1c2cncc(c2C[C@H]1O)C(═O)OC |
| NR0312780 | B7.1 | n12[C@H](C(═O)OCc1ccc2C═O)[C@@H](C)C |
| NR0324180 | B7.1 | c12c(OC(═C(\C)C)\C1═O)ccc(c2)[C@@H](O)C |
| NR0387543 | B7.1 | c1(C(═O)OCC)c(OC)cccc1OC |
| NR0404007 | B7.1 | c12c([C@@H]([C@@H](C2)O)C)cncc1C(═O)OC |
| NR0028506 | B7.2 | CCc1c(cc(c2c1O[C@@H](CC2═O)C)OC)O |
| NR0065095 | B7.2 | CC(═O)CC(═O)c1ccc2c(c1)OCCO2 |
| NR0155221 | B7.2 | C[C@]1(CC(═O)c2c(cc(cc2OC)OC)O1)C |
| NR0242262 | B7.2 | c1(c(c(cc2c1CCO2)OC)C(═O)CCC)O |
| NR0267636 | B7.2 | c12c(c(ccc1O[C@](C═C2)(C)C)C(═O)C)OC |
| NR0275465 | B7.2 | [C@@]1(Oc2c(C(═O)C1)cc(cc2)C(═O)C)(CO)C |
| NR0291663 | B7.2 | c12c(cc(cc1OC)OC)O[C@@H](CC2═O)CC |
| NR0372120 | B7.2 | C1(═O)c2c(cc(cc2OC)OC)C[C@H](O1)C |
| NR0395063 | B7.2 | c12c(c(cc(c1)OC)OC)C(═O)C[C@@H](O2)C |
| NR0028758 | B7.3 | C[C@H]1Cc2cc(cc(c2C(═O)O1)OC)O |
| NR0044299 | B7.3 | Cc1c2c(c(cn1)CO)CO[C@](O2)(C)C |
| NR0125455 | B7.3 | CC(═O)N1CCc2cc(c(cc2C1)OC)O |
| NR0143343 | B7.3 | C[C@H]1CC(═O)c2c(cccc2OC)O1 |
| NR0228317 | B7.3 | c12c(c(cc(c1)OC)C)c(═O)cc(o2)C |
| NR0260410 | B7.3 | c1([C@@](OC)(C)C)oc2c(c1)cc(c(c2)C)O |
| NR0265991 | B7.3 | c12c(O[C@](C[C@@H]1O)(C)C)ccc(c2)C(=O)C |
| NR0330248 | B7.3 | c12c(O[C@@](CC1═O)(C)C)ccc(c2)OC |
| NR0347291 | B7.3 | c1(cc2c(O[C@@](C═C2)(C)C)cc1C)C(═O)C |
| NR0347606 | B7.3 | C12═CO[C@H](CC1═C(C(═O)C═C2OC)C)C |
| NR0036692 | B8 | Cc1coc2c1C(═O)[C@H]1[C@@](O1)(CCC═C(C2)C)C |
| NR0068326 | B8 | Cc1c(ccc2c1oc(═O)c1c2CCC1)OC |
| NR0076085 | B8 | Cc1cc(c2c(c1)oc(═O)c1c2CCCC1)O |
| NR0143400 | B8 | Cc1coc2c1C(═O)C1═C(CC═C[C@@]1(C2)C)C |
| NR0156325 | B8 | C[C@]1(CCC2═C(O1)C(═O)c1ccccc1C2═O)C |
| NR0158423 | B8 | Cc1coc2c1C(═O)[C@@H]1[C@](O1)(CCC═C(C2)C)C |
| NR0158847 | B8 | Cc1c2c(cc3c1C(═O)CC3)C(═O)OCC2 |
| NR0160396 | B8 | Cc1coc2c1C(═O)C1═C([C@H]3C[C@H]3[C@@]1(C2)C)C |
| NR0215412 | B8 | C12═C(C3C(C1(Cc1c(C2═O)c(co1)C)C)C3)C |
| NR0231176 | B8 | c12c(cc3c(c1O)occ3C)C(═O)C[C@H](C2)C |
| NR0261866 | B8 | c12c3c(cc(c1CC[C@H](C2═O)C)CO)occ3C |
| NR0281627 | B8 | [C@]12([C@@H](O1)C(═O)c1c(occ1C)CC(═CCC2)C)C |
| NR0289665 | B8 | [C@]12(C(═C(CC═C2)C)C(═O)c2c(C1)occ2C)C |
| NR0296403 | B8 | c12c(c3c(c(c1occ2C)O)CCC[C@@H]3C)C=O |
| NR0318270 | B8 | c12c(cc3c(c1OC)occ3C)[C@H](C[C@@H](C2═O)C)C |
| NR0328580 | B8 | [C@@]12(c3c(C(═O)C═C([C@@H]1CCC2)C)c(co3)C)C |
| NR0353785 | B8 | C12═C(C(═O)c3c(C1═O)cccc3)OC[C@@](C2)(C)C |
| NR0381963 | B8 | c12c(c3c(cc2occ1C(═O)C)C(═O)CC[C@H]3C)C |
| NR0400624 | B8 | c12c(c(c3c(c1C═O)[C@H](CCC3)C)OC)occ2C |
| NR0045455 | B9 | C[C@H]1[C@H](OC(═O)[C@](C1═O)(C)C)c1ccc(c(c1)OC)OC |
| NR0045457 | B9 | C[C@H]1[C@@H](OC(═O)[C@](C1═O)(C)C)c1ccc(c(c1)OC)OC |
| NR0045458 | B9 | C[C@@H]1[C@@H](OC(═O)[C@](C1═O)(C)C)c1ccc(c(c1)OC) |
| | | OC |
| NR0122269 | B9 | CCOC(═O)[C@@](C)(C)[C@@]1(CCC(═O)O1)c1ccc(cc1)OC |
| NR0122270 | B9 | CCOC(═O)[C@@](C)(C)[C@]1(CCC(═O)O1)c1ccc(cc1)OC |
| NR0261888 | B9 | c1(c(cc(cc1)C)OC(═O)[C@H](C)C)C(═C)COC(═O)C |
| NR0368072 | B9 | C(═O)(Oc1c(cc([C@H](OC(═O)[C@@H](C)C)C═C)cc1)OC) |
| | | [C@H](C)C |
| NR0380649 | B9 | c1(/C(═C\OC(═O)[C@@H](C)C)COC(═O)[C@H](C)C)c(cc(cc1) |
| | | C)O |
| NR0237534 | B10 | [C@]1(c2c(c(═O)c(c(o2)OC)C)C)([C@@H](C(═CC(═C1)C)C)/C |
| | | (═C/C(═O)C)C)C |
| NR0290847 | B10 | [C@]1(c2c(c(═O)c(c(o2)OC)C)C)([C@@H](C(═CC(═C1)C)C)/C |
| | | (═C/[C@@H](C(═O)CC)C)C)C |
| NR0389247 | B10 | [C@@]1(c2c(c(═O)c(c(o2)OC)C)C)([C@H](C(═CC(═C1)C)C)/C |
| | | (═C/CC)C)C |
| NR0389671 | B10 | [C@@]1(c2c(c(═O)c(c(o2)OC)C)C)([C@H](C(═CC(═C1)C)C)/C |
| | | (═C/[C@H](C(═O)CC)C)C)C |
| NR0397992 | B10 | [C@@]1(c2c(c(═O)c(c(o2)OC)C)C)([C@H](C(═CC(═C1)C)C)/C |
| | | (═C/[C@@H](C(═O)CC)C)C)C |
| NR0013536 | B11 | Cc1cc(c(c2c1CC[C@@H]1[C@@H]2OC(═O)[C@H]1C)C)O |
| NR0063708 | B11 | CCc1cc(═O)oc2c1c(cc1c2CC[C@@](O1)(C)C)OC |
| NR0075929 | B11 | Cc1c(c(═O)oc2c1c(cc1c2CC[C@@](O1)(C)C)O)C |
| NR0078805 | B11 | CCCc1cc(═O)oc2c1cc1c(c2C)O[C@](CC1═O)(C)C |
| NR0081990 | B11 | Cc1c2c(cc3c1O[C@](C[C@H]3O)(C)C)c1c(c(═O)o2)CCCC1 |
| NR0089767 | B11 | Cc1c2c(cc3c1O[C@](C[C@@H]3O)(C)C)c1c(c(═O)o2)CCCC1 |
| NR0155272 | B11 | Cc1cc(c(c2c1CC[C@@H]1[C@H]2OC(═O)[C@H]1C)C)O |
| NR0155398 | B11 | Cc1cc(c(c2c1CC[C@@H]1[C@H]2OC(═O)[C@H]1C)C)OC |
| NR0163179 | B11 | Cc1coc2c1C(═O)[C@H]1[C@@H](C[C@H](C═C1C2)OC)C |
| NR0263142 | B11 | c12c3c(C(═O)C(═C(\C)C)/O3)ccc1C[C@H](O[C@@H]2O)C |
| NR0269407 | B11 | c12c3c(ccc1c(═O)c(c(o2)C)C)C[C@H](O[C@@H]3O)C |
| NR0292905 | B11 | c12c3c(c(═O)c(c(o3)C)C)ccc1C[C@@](OC2)(O)C |
| NR0296386 | B11 | [C@H]12c3c(C(═O)C═C([C@@H]1[C@H](C[C@@H]2C)OC)C) |
| | | c(co3)C |
| NR0296705 | B11 | c12c3c(C(═O)C(═C(\C)C)/O3)ccc1C[C@H](O[C@@H]2OC)C |
| NR0315704 | B11 | c12c3c(C(═O)[C@@H](O3)[C@H](C)C)ccc1C[C@H](O[C@@H] |
| | | 2OC)C |
| NR0329981 | B11 | [C@@H]12[C@@](Oc3c(C1)c(c(cc3)C(═O)C)O)(OC[C@@H] |
| | | 2C)C |
| NR0043967 | B12.1 | COc1cc2c(cc1OC)[C@]1(CCCC1)C(═O)OC2 |
| NR0044680 | B12.1 | CC[C@]1([C@H](O1)c1ccc(cc1)OC)C(═O)OCC |
| NR0044683 | B12.1 | CC[C@@]1([C@@H](O1)c1ccc(cc1)OC)C(═O)OCC |
| NR0045428 | B12.1 | CCc1cc2c(c(c(═O)oc2cc1OC)CC)C |
| NR0051562 | B12.1 | CCCc1c(c2ccc(cc2oc1═O)OCCC)C |
| NR0067011 | B12.1 | CCCc1c(c2ccc(cc2oc1═O)OC)C |
| NR0086340 | B12.1 | Cc1cccc2c1nc(c(c2O)CCC(═O)C)C |
| NR0118415 | B12.1 | C[C@@]1(CCc2cc(ccc2C1═O)OC)C(═O)OC |
| NR0127969 | B12.1 | COc1ccc2c(c1)C[C@]1(C2═O)CCC(═O)CC1 |
| NR0250065 | B12.1 | c1(c2c(c(cc1OC)C)oc(═O)c(c2)C)[C@@H](C)C |
| NR0261537 | B12.1 | [C@]1([C@@H](O1)C)(/C═C(\c1cc(c(c(═O)o1)C)OC)C)C |
| NR0300999 | B12.1 | O1c2c(C[C@H]1[C@@](O)(C)C)cc(cc2OC)C═O |
| NR0306870 | B12.1 | c12c(cc(cc2)OCC)oc(═O)c(c1C)C |
| NR0308654 | B12.1 | c12c(c(cc(c1[C@@H](C)C)O)C)oc(═O)c(c2)C |
| NR0327564 | B12.1 | c12c(cc(c(c2)C)[C@H](CCC(═O)C)O)occ1C |
| NR0339112 | B12.1 | c12c(C[C@H](O2)[C@@](O)(C)C)cc(cc1OC)C(═O)OC |
| NR0354553 | B12.1 | c12c(cc(c(c2)C)C(═O)CCC(═O)C)occ1C |
| NR0399939 | B12.1 | [C@]1([C@H](O1)C)(/C═C(\c1cc(c(c(═O)o1)C)OC)C)C |
| NR0404162 | B12.1 | c1(c2c(cc(c1C(═O)C)C)cccc2OC)OC |
| NR0019926 | B12.2 | C[C@@](C)([C@H](Cc1c(ccc2c1oc(═O)cc2)OC)O)OC |
| NR0043278 | B12.2 | C/C═C/C(═O)N1c2ccc(cc2C(═C[C@ @] 1(C)C)C)OC |
| NR0064477 | B12.2 | CCOc1ccc2c(c1)c(c(c(n2)C)CCC(═O)C)O |
| NR0066854 | B12.2 | Cc1ccc2c(c1)[C@H](C[C@H](N2C(═O)C)C)OC(═O)C |
| NR0077406 | B12.2 | CCOC(═O)/C═C\1c2cc(c(cc2C[C@@](N1)(C)C)OC)OC |
| NR0134734 | B12.2 | CC(═O)CCN1Cc2cc(c(cc2[C@H](C1)O)OC)OC |
| NR0143877 | B12.2 | CCOC(═O)c1c2cc(ccc2oc1[C@](C)(C)C)O |
| NR0144121 | B12.2 | CCOC(═O)c1c2cc(ccc2oc1[C@](C)(C)C)OC |
| NR0146981 | B12.2 | CC[NH+](CCO)Cc1cc(═O)oc2c1cc(c(c2)C)Cl |
| NR0146982 | B12.2 | Cc1cc2c(cc1Cl)c(cc(═O)o2)C[NH+](C)CCO |
| NR0244708 | B12.2 | [C@H]1(c2c([C@H](CC1═O)C)cc(c(c2)C)OC(═O)C)[C@@H](C) |
| | | C |
| NR0332520 | B12.2 | c1(c2c(c(cc1C)OC)C═C[C@@](O2)(C)C)C(═O)OC |
| NR0368343 | B12.2 | c12c(c(c(c(c1)OC)C/C═C(\C)C)O)c(═O)cc(o2)C |
| NR0385361 | B12.2 | c12c(c(c(c(c1)OC)C(═O)OC)C)C═C[C@@](O2)(C)C |
| NR0134737 | B12.3 | COc1ccc2c(c1O)CN1CCC(═O)C[C@H]1C2 |
| NR0134740 | B12.3 | COc1cc2c(cc1O)CN1CCC(═O)C[C@@H]1C2 |
| NR0134743 | B12.3 | COc1cc2c(cc1O)C[C@H]1CC(═O)CCN1C2 |
| NR0368062 | B12.3 | c12c(O[C@@](C(═O)CC[C@H]1C)(C)C)cc(c(c2)O)C |
| NR0021218 | B13 | Cc1coc2c1C(═O)C[C@@H](C[C@H](C═C(C2)C)OC)C |
| NR0021220 | B13 | Cc1coc2c1C(═O)C[C@H](C[C@H](C═C(C2)C)OC)C |
| NR0021221 | B13 | Cc1coc2c1C(═O)C[C@H](C[C@@H](C═C(C2)C)OC)C |
| NR0159429 | B13 | Cc1coc2c1C(═O)C═C(CCC═C(C2)C)C |
| NR0228234 | B13 | c12c(c(co1)C)CC═C(C(═O)OC)CCC═C(C2)C |
| NR0235600 | B13 | c12c(CC(═CCC[C@@H](C(═O)C2)C)C)occ1C |
| NR0258297 | B13 | C1(═C(c2cocc2)CC[C@@H]1C)C(═O)/C═C(\C)C |
| NR0258982 | B13 | c12c(c(co1)C)CC═C(C(═O)OC)CCC═C(C2)C |
| NR0295319 | B13 | c1(C2═C(CC[C@H]2C)C(═O)C)c(cco1)[C@H](C)C |
| NR0298160 | B13 | c12c(CC(═C[C@H](C[C@@H](CC2═O)C)OC)C)occ1C |
| NR0300156 | B13 | c12c(CC(═C[C@@H](C[C@H](CC2═O)C)OC)C)occ1C |
| NR0340209 | B13 | c1(C2═C(CC[C@H]2C(═O)C)C)c(cco1)[C@H](C)C |
| NR0013897 | B14 | Cc1cc2c(cc1O)[C@]1(CCC(═O)[C@@]([C@@H]1CC2═O)(C)C) |
| | | C |
| NR0020634 | B14 | Cc1cc2c(cc1O)[C@]1(CCC(═O)[C@@]([C@H]1CC2═O)(C)C)C |
| NR0043051 | B14 | C/C(═C\COc1cc2c(cc1Cl)c1c(c(═O)o2)CCCC1)C |
| NR0160334 | B14 | C/C═C\C(═O)OCCc1c(cc2c(c1C)C(═O)[C@H](C2)C)C |
| NR0230964 | B14 | [C@]12(c3c(C(═O)C[C@H]1[C@](C(═O)CC2)(C)C)cc(c(c3)OC) |
| | | OC)C |
| NR0233161 | B14 | [C@]1(c2c(cc3c(c(═O)c2)cc(c(c3OC)OC)[C@@H](C)C)C═C |
| | | [C@H]1O)(C)C |
| NR0238967 | B14 | c1(═O)oc2c(C/C═C(\C)C)c(ccc2cc1[C@](C═C)(C)C)OC |
| NR0271750 | B14 | c12c3c(c(c(cc3)O)C)CCc1c(c(cc2[C@H](OCC)C)OC)C |
| NR0296309 | B14 | C12═Cc3c(C(═O)C[C@H]1[C@](CC[C@H]2O)(C)C)cc(c(c3)OC) |
| | | C |
| NR0300215 | B14 | c12c([C@@H]([C@@H]([C@@](C2═O)(C)C)O)C)cc2c(c1O)c(cc |
| | | (c2)OC)C |
| NR0306136 | B14 | c1(c2c(c(c3c1[C@H](CCC3)C)OC)occ2C)CC(═O)/C(═C\C)C |
| NR0321845 | B14 | [C@@H]12[C@@](c3c(C(═O)C2)cc(c(c3)C)O)(CCC(═O)[C@@] |
| | | 1(C)C)C |
| NR0324353 | B14 | c12c(cc(c(c1C)CCOC(═O)/C═C\C)C)C[C@H](C2═O)C |
| NR0325151 | B14 | c12c3c(c(cc2ccc(c1C═C(O3)C(═O)[C@@H](C)C)C)[C@H](C)C) |
| | | O |
| NR0358201 | B14 | C12═CC(═O)c3c([C@]1(CC[C@@H]([C@@]2(C)C)O)C)cc(c(c3) |
| | | C)O |
| NR0358588 | B14 | c12c3c(c(c(c1C(═O)[C@H]([C@@H](O2)C)C)O)C/C═C(/C)C)OC |
| | | (═O)C[C@@H]3CCC |
| NR0359810 | B14 | c12c3c(c(c(c1C(═O)[C@@H]([C@H](O2)C)C)O)C/C═C(/C)C)OC |
| | | (═O)C[C@H]3CCC |
| NR0365939 | B14 | [C@]1([C@H]2C(═CC(═O)[C@@H]1O)c1c(C(═O)C2)cc(c(c1) |
| | | OC)C)(C)C |
| NR0368390 | B14 | c12c(c3c(c(c2O)C/C═C(/C)C)OC(═O)C[C@H]3CCC)O[C@H]( |
| | | [C@@H](C1═O)C)C |
| NR0373534 | B14 | c12C(═O)[C@@]([C@@H]([C@@H](c1cc1c(c2O)c(cc(c1)OC)C) |
| | | C)O)(C)C |
| NR0224764 | B15 | [C@]12([C@H](CC(═O)C═C1C)C)CC(═O)CC2 |
| NR0268737 | B15 | [C@@]12(C(═CC(═O)C(═C2)OC)C═C(C(═O)C1)[C@@H](C)C) |
| | | C |
| NR0272576 | B15 | C12═C(C(═O)C[C@@H]1[C@H](CC(═O)C(═C2)[C@@H](C)C) |
| | | C)C |
| NR0313650 | B15 | [C@]12(C(═C([C@@H]3C(═C1)C(═O)[C@](C3)(C)C)C)C(═O) |
| | | OC2)C |
| NR0316049 | B15 | [C@@]12([C@@H](CC(═C2)C(═O)C)CCC(═O)[C@H]1C)C |
| NR0324640 | B15 | C12═C(C(═O)C═C(C(═C)O2)C(═C)C)CCC[C@@H]1C |
| NR0330884 | B15 | [C@]12(C(═C(CCC1═O)C)[C@@H]1[C@@H](C═C2)[C@@H] |
| | | (C(═O)O1)C)C |
| NR0330887 | B15 | [C@@]12(C(═CC(═O)C[C@H]1C)C)CCC(═O)C2 |
| NR0333649 | B15 | [C@]12(C(═C([C@@H]3C(═C1)[C@H]([C@](C3)(C)C)O)C)C |
| | | (═O)OC2)C |
| NR0347374 | B15 | C12═C(C(═O)C═C(OC1═C)C(═C)C)CCC[C@@H]2C |
| NR0349993 | B15 | [C@@]1(C(═O)C2═COC(═C(C2═CC1═O)C)C)(CC)C |
| NR0353731 | B15 | C12═C(C(═O)C(═C[C@@]1(CC(═O)C(═C2)[C@@H](C)C)C) |
| | | OC)C |
| NR0386491 | B15 | C12═C3[C@](C═CC(═O)[C@@H]3C)(CC[C@H]2[C@@H](C |
| | | (═O)O1)C)C |

TABLE B.1
Image of 6 conserved cores of several compounds in Table B

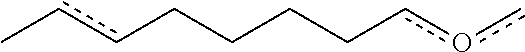

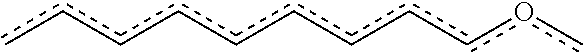

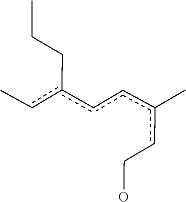

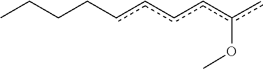

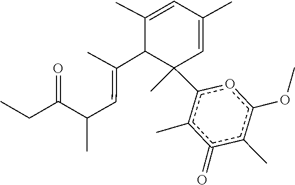

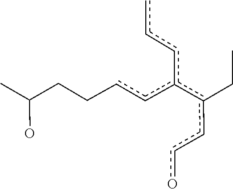

TABLE B.2
2 Structures of conserved cores of several groups of compounds in Table B

| Group | Core Structure |
|---|---|
| B1 | 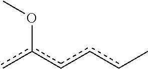 |
| B2 | 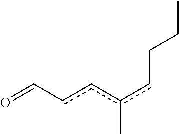 |
| B3 | 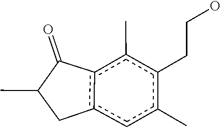 |
| B4 | 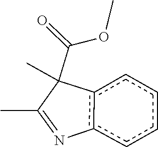 |
| B5 | 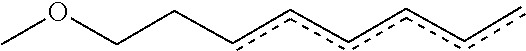 |
| B6 | 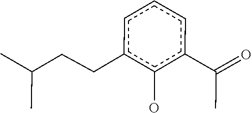 |
| B7.1 | 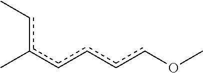 |
| B7.2 | 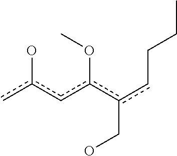 |
| B7.3 | 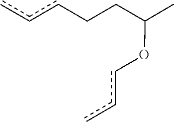 |
| B8 | 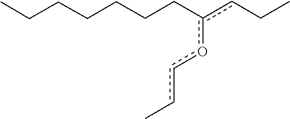 |
| B9 | 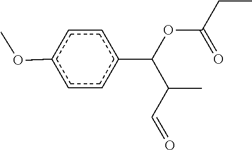 |
| B10 | 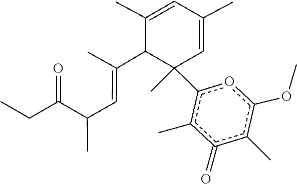 |
| B11 | 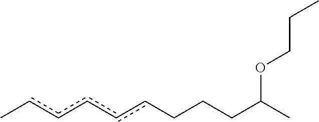 |
| B12.1 | 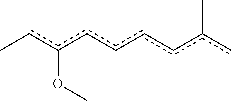 |
| B12.2 | 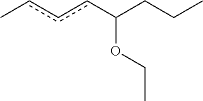 |
| B12.3 | 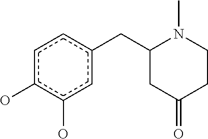 |
| B13 | 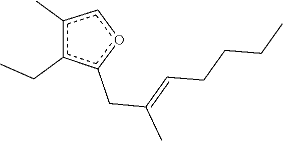 |
| B14 | 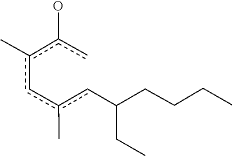 |
| B15 | 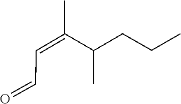 |

The compounds may be used alone or in combination with other agents. The compounds of the disclosure may be combined with additional active agent(s), insecticide(s) and the like in traps to reduce the presence of amount of an insect in the environment. For example, compounds of the disclosure may be used in combination with insect traps (e.g., tape, combustibles, electric traps).

In another embodiment, the compounds may be formulated for application to the skin, clothing, bednets, house walls, curtains or other material.

For example, the compounds of the disclosure may be used as repellents or in compositions comprising said repellent compounds and the use of such repellent compounds and compositions in controlling insects.

Liquid formulations may be aqueous-based or non-aqueous (e.g., organic solvents), or combinations thereof, and may be employed as lotions, foams, gels, suspensions, emulsions, microemulsions or emulsifiable concentrates or the like. The formulations may be designed to be slowly release from a patch, canister, emanator or fan-based devices.

The compositions may comprise various combinations of compounds as well as varying concentrations of the compound depending upon the insect to be repelled, the type of surface that the composition will be applied to, or the type of emanator to be used. Typically, the active ingredient compound of the disclosure will be present in the composition in a concentration of at least about 0.0001% by weight and may be 10, 50, 99 or 100% by weight of the total composition. The repellent carrier may be from 0.1% to 99.9999% by weight of the total composition. The dry formulations will have from about 0.0001-95% by weight of the pesticide while the liquid formulations will generally have from about 0.0001-60% by weight of the solids in the liquid phase.

As mentioned above, the compositions may be formulated for administration to a subject. Such formulations are typically administered to a subject's skin. The composition may also be formulated for administration to garments, belts, collars, or other articles worn or used by the subject from whom insects are to be repelled. The formulation may be applied to bedding, netting, screens, camping gear and the like. It will be recognized that the application of the compositions and compounds of the disclosure do not only include human subjects, but include canines, equines, bovines and other animals subject to biting insects. For topical application, the formulation may take the form of a spray formulation, powder or a lotion formulation.

The compounds according to the disclosure may be employed alone or in mixtures with one another and/or with such solid and/or liquid dispersible carrier vehicles.

In other aspects, provided is a method of repelling an insect, comprising dispensing the insect repellent compositions described herein to expose insects to the composition, thereby repelling the insects.

Compositions of Pesticidal Repellents Pesticide

In other embodiments, the compound identified as a spatial repellent and/or pesticide according to the methods and systems described herein are selected from Table C or Table CII. In other aspects, provided are compositions of spatial repellents and/or pesticides, which comprise one or more, two or more, or three or more compounds selected from Table C or Table CII below.

In some embodiments, the compounds identified have a core structure selected from the groups of Table C.1 and are conserved in the structure of compounds selected from Table C.

TABLE C

| Com- | |
|---|---|
| pound ID | SMILES |
| RNat6 | C[C@]12CC[C@](C[C@H]1C1═CC(═O)[C@H]3[C@]4(CC[C@@H]([C@]([C@H]4 |
| | CC[C@]3([C@@]1(CC2)C)C)(C)C)O[C@H]1[C@@H]([C@H]([C@@H]([C@H](O |
| | 1)CO)O)O[C@H]1[C@@H]([C@H]([C@@H]([C@H](O1)CO)O)O)O)O)C)(C)C(═O) |
| | [O−] |
| RNat9 | C[C@]12CC[C@](C[C@H]1C1═CC(═O)[C@H]3[C@]4(CC[C@@H]([C@@]( |
| | [C@@H]4CC[C@]3([C@@]1(CC2)C)C)(C)C)O)C)(C)C(═O)[O−] |
| RNat10 | CC(═O)O[C@H]1CC[C@]2([C@H]([C@]1(C)C)CC[C@@]1([C@@H]2C(═O)C═C2 |
| | [C@]1(CC[C@@]1([C@H]2C[C@@](CC1)(C)C(═O)[O−])C)C)C)C |
| RNat11 | C/C(═C\[C@H]1[C@H]([C@@]1(C)C)C(═O)NCc1ccccn1)C |
| RNat12 | [C@H]12[C@@H](OC(═O)C2═C)C═C([C@H](CC═C(C[C@H]1OC(═O)/C(═C/C) |
| | COC(═O)C)CO)O)C |
| RNat13 | [C@@]12([C@]3(C(═CC(═O)[C@@H]1[C@@]1([C@@H](CC2)[C@]([C@H] |
| | (CC1)OC(═O)CCCCCCC/C═C\CCCCCC)(C)C)C)[C@H]1[C@@](CC3)(CC[C@] |
| | (C1)(C)C)C)C)C |
| RNat14 | C[C@H](CCC[C@H](C)C)[C@H]1CC[C@@H]2[C@@]1(CC[C@H]1[C@H]2CC═C |
| | 2[C@@]1(CC[C@@H](C2)OC(═O)COc1ccc2c(c1)oc(═O)c1c2CCCC1)C)C |
| RNat16 | C[C@]12CC[C@](C[C@H]1C1═CC(═O)[C@@H]3[C@]4(CC[C@@H]([C@] |
| | ([C@H]4CC[C@]3([C@@]1(CC2)C)C)(C)C)O)C)(C)C(═O)[O−] |
| RNat17 | C[C@]12CC[C@](C[C@H]1C1═CC(═O)[C@H]3[C@]4(CC[C@@H]([C@]([C@H]4 |
| | CC[C@]3([C@@]1(CC2)C)C)(C)C)O)C)(C)C(═O)[O−] |
| RNat18 | [C@@H]1([C@]([C@H]1/C═C(/C(═O)O)C)(C)C)C[C@@H](C(═C)[C@H](C1═C[C |
| | @@H](CC1═O)C)OC(═O)C)OC(═O)c1ccccc1 |
| RNat19 | CC1═C(C(═O)C[C@H]1OC(═O)[C@H]1[C@@H]([C@]1(C)C)/C═C(\C)C)C/C═C/ |
| | C=C |
| RNat20 | C[C@]12CC[C@](C[C@H]1C1═CC(═O)[C@H]3[C@]4(CC[C@@H]([C@]([C@H]4 |
| | CC[C@]3([C@@]1(CC2)C)C)(C)C)O[C@H]1[C@@H]([C@H]([C@@H]([C@H](O1) |
| | CO)O)O)O[C@H]1[C@@H]([C@H]([C@@H]([C@H](O1)CO)O)O)O)C)(C)C(═O) |
| | [O−] |
| RNat22 | [C@]12([C@@H]([C@@]([C@H]([C@H](C2)O)O)(C)C)CC═C([C@H]1CC/C(═C/C |
| | OC(═O)C)C)C)C |
| RNat23 | [C@@]12([C@]3([C@H]([C@@]4([C@H](CC3)[C@]([C@H](CC4)O[C@H]3[C@ |
| | H]([C@@H]([C@H]([C@@H](O3)C(═O)O)O)O)O[C@H]3[C@H]([C@@H]([C@H] |
| | ([C@@H](O3)O)O)O)C(═O)O)(C)C)C)C(═O)C═C1[C@H]1[C@@](CC2)(CC[C@@] |
| | (C1)(C(═O)O)C)C)C)C |
| RNat24 | CCOC(═O)[C@@H]1[C@@H]([C@@]1(C)C)/C═C(\C)C |
| RNat25 | [C@@]12([C@]3(C(═CC(═O)[C@@H]1[C@@]1([C@@H](CC2)[C@]([C@H](CC1) |
| | O)(C)C)C)[C@H]1[C@](CC3)(C(═O)OC)CC[C@](C1)(C)C)C)C |
| RNat26 | [C@@]12([C@]3([C@@H]([C@@]4([C@@H](CC3)[C@]([C@H]([C@@H](C4)O) |
| | O)(C)C)C)C(═O)C═C1[C@H]1[C@](CC2)(C(═O)OC)CC[C@](C1)(C)C)C)C |
| RNat27 | [C@@H]1([C@]([C@@H]1/C═C(\C)C)(C)C)C(═O)O[C@@H]1C(═C(C(═O)C1)C/ |
| | C═C\C)C |
| RNat28 | [C@@H]1([C@]([C@@H]1/C═C(/C)C)(C)C)C(═O)O[C@@H]1C(═C(C(═O)C1)C/ |
| | C═C\CC)C |
| RNat29 | [C@@H]1([C@]([C@@H]1/C═C(\C)C)(C)C)C(═O)O[C@H]1C(═C(C(═O)C1)C/ |
| | C═C/C═C)C |
| RNat30 | [C@@]12([C@]3([C@@H]([C@@]4([C@@H](CC3)[C@]([C@H](CC4)O[C@H]3 |
| | [C@@H]([C@H]([C@@H]([C@H](O3)CO)O)O)O)(C)C)C)C(═O)C═C1[C@H]1[C@] |
| | (CC2)(C(═O)O[C@H]2[C@@H]([C@H]([C@@H]([C@H](O2)CO)O)O)O)CC[C@] |
| | (C1)(C)C)C)C |
| RNat31 | [C@@]1([C@H]([C@@H]([C@@]([C@@H](O1)/C═C/C═C\C)(C)C)OC(=O) |
| | Cc1ccccc1)O)([C@@H](C(=O)NC/C═C/C═C(/[C@@H]([C@H]([C@@H]1O[C@H] |
| | ([C@@H](C1)O)/C═C/C═C/C═C/C(═O)O)C)OC)C)CO[C@@H]1O[C@@H]([C@H] |
| | ([C@@H](C1)OC)O)C)O |
| RNat32 | [C@@]1([C@H]([C@@H]([C@]([C@@H](O1)/C═C/C═C\C)(C)C)O)OC(=O) |
| | Cc1ccccc1)([C@@H](C(=O)NC/C═C/C═C(/[C@@H]([C@H]([C@@H]1O[C@H] |
| | ([C@@H](C1)O)/C═C/C═C/C═C/C(═O)O)C)OC)C)CO[C@@H]1O[C@@H] |
| | ([C@H]([C@@H](C1)OC)O)C)O |
| RNat33 | [C@@]12([C@]3(C(═CC(═O)[C@@H]1[C@@]1([C@@H](CC2)[C@]([C@H](CC1) |
| | OC(═O)CCCCCCC/C═C\CCCCCC)(C)C)C)[C@H]1[C@@](CC3)(CC[C@](C1)(C) |
| | C)CO)C)C |
| RNat35 | C[C@H](CCC[C@H](C)C)[C@H]1CC[C@@H]2[C@@]1(CC[C@H]1[C@H] |
| | 2CC═C2[C@@]1(CC[C@@H](C2)OC(═O)COc1ccc2c(cc(═O)oc2c1)c1ccccc1)C)C |
| RNat36 | C/C(═C\[C@H]1[C@H]([C@]1(C)C)C(═O)OCc1cccc(c1)Oc1ccccc1)C |
| RNat37 | [C@]12([C@@H]3[C@H]([C@H]4[C@](CC3)([C@H](CC4)[C@@H](N(C)C)C)C) |
| | CC═C1C[C@H][C@H](C2)O)NC(═O)/C═C(\C)C)C |
| RNat38 | [C@@]12([C@]3(C(═CC(═O)[C@H]1[C@@]1([C@@H](CC2)[C@][C@HJ(CC1) |
| | O[C@H]1[C@@H]([C@H]([C@@H]([C@H](O1)C(═O)O)O)O)O[C@H]1[C@@H] |
| | ([C@H]([C@@H]([C@H](O1)C(═O)O)O)O)O)(C)C)C)[C@H]1[C@@](CC3)(CC |
| | [C@@](C1)(C(═O)O[C@H]1[C@@H]([C@H]([C@@H]([C@H](O1)CO)O)O)O)C) |
| | C)C)C |
| RNat39 | [C@@]12([C@]3(C(═CC(═O)[C@@H]1[C@@]1([C@@H](CC2)[C@]([C@H](CC1) |
| | O[C@H]1[C@@H]([C@H]([C@@H]([C@H](O1)C(═O)O)O)O)O[C@H]1[C@@H] |
| | ([C@H]([C@@H]([C@H](O1)C(═O)O)O)O)O)(C)C)C)[C@H]1[C@@](CC3)(CC[C |
| | @@](C1)(C(═O)O[C@H]1[C@@H]([C@H]([C@@H]([C@H](O1)CO)O)O)O)C)C) |
| | C)C |
| RNat41 | C[C@H]1CC(═O)C(═C1)[C@H](C(═C)[C@@H](C[C@H]1[C@H]([C@]1(C)C)/ |
| | C═C(\C)C(═O)[O−])OC(═O)c1ccccc1)OC(═O)C |
| RNat42 | [C@@H]1([C@]([C@@H]1/C═C(/OC(═O)C)C)(C)C)C(═O)O[C@@H]1C(═C(C(═O) |
| | C1)C/C═C/C)C |
| RNat43 | C[C@]12CC[C@](C[C@H]1C1═CC(═O)[C@@H]3[C@]4(CC[C@H]([C@@]([C@ |
| | @H]4CC[C@]3([C@@]1(CC2)C)C)(C)C)O)C)(C)C(═O)OC |
| RNat44 | C1[C@@H]([C@@]([C@H]2[C@](C1)([C@@H]1[C@@](CC2)([C@]2(C(═CC1═O) |
| | [C@H]1[C@@](CC2)(CC[C@](C1)(C)C(═O)OC)C)C)C)C)(C)C)O |
| RNat45 | C[C@]12CC[C@](C═C1C1═CC(═O)[C@@H]3[C@]4(CCC(═O)[C@]([C@H]4CC |
| | [C@]3([C@@]1(CC2)C)C)(C)C)C)(C)C(═O)OC |
| RNat46 | c1cc(cc(c1)NC(═O)N1C[C@@H]2C[C@H](C1)c1ccc(c(═O)n1C2)c1ccc(cc1)O[C@] |
| | (F)(F)F)C#N |
| RNat47 | [C@H]1([C@@]([C@@H]1/C═C(/C)C)(C)C)C(═O)O[C@@H]1C(═C(C(═O)C1)C/ |
| | C═C\C)C |
| RNat48 | [C@]12([C@H]([C@@]([C@H]([C@H](C2)O)O)(C)C)CC═C([C@H]1CC/C(═C/ |
| | COC(═O)C)C)C)C |
| RNat49 | c12c3nc(co3)[C@H](CC(═O)CCC[C@@H](CC(═O)O[C@H]([C@@H]([C@H](CC= |
| | Cc3nc(c(n1)oc2)co3)OC)C)C[C@@H]([C@H](CC[C@H]([C@@H]([C@@H]([C@H] |
| | (/C═C/N(C═O)C)C)OC(═O)C)C)OC(═O)[C@@H](COC)OC)C)OC)O)C |
| RNat54 | CC[NH2+][C@H]1C[C@H]2C═CCC[C@H]2C[C@@H]1COC(═O)[C@@]12C(═O) |
| | c3c(cccc3C(═O)[C@@]1(O2)C/C(═C(\C)C[C@]1(CCCCC1)c1cc[n+]c(c1)NC[NH2+] |
| | C)CO)C[C@@H](C)C |
| RNat55 | CC1═C(C(═O)C[C@@H]1OC(═O)[C@@H]1[C@H]([C@@]1(C)C)/C═C(\C)C(═O) |
| | OC)C/C═C/C═C |
| RNat56 | C/C═C/CC1═C([C@H](CC1═O)OC(═O)[C@@H]1[C@H]([C@@]1(C)C)/C═C(\C)C |
| | (═O)OC)C |
| RNat57 | [C@@H]1([C@]([C@@H]1/C═C(/C(═O)OC)C)(C)C)C(═O)O[C@@H]1C(═C(C(═O) |
| | C1)C/C═C\CC)C |
| RNat58 | [C@@H]1([C@]([C@@H]1/C═C(\C(═O)OC)C)(C)C)C(═O)O[C@@H]1C(═C(C(═O) |
| | C1)C/C═C/C═C)C |
| RNat59 | [C@]1([C@@H]([C@H]1C(═O)O[C@@H]1C(═C(C(═O)C1)C/C═C\C)C)/C═C(\C(= |
| | O)OC)C)(C)C |
| RNat60 | [C@@H]1([C@]([C@@H]1/C═C(/C(═O)OC)C)(C)C)C(═O)O[C@@H]1C(═C(C(═O) |
| | C1)C/C═C\C)C |
| RNat61 | [C@@H]1([C@]([C@@H]1/C═C(/C(═O)OC)C)(C)C)C(═O)O[C@@H]1C(═C(C(═O) |
| | C1)C/C═C\C═C)C |
| RNat62 | [C@]123[C@]4(c5c(N2)ccc([C@@H]2[C@]6([C@H]7c8n(c9c(c8CCN7CCC6)cccc9) |
| | C2)CC)c5)[C@@H]2[C@@](C[C@H]1C(═O)OC)(CC3)CCCN2CC4 |
| RNat63 | [C@@]123[C@@]([C@H](C(═C[C@H](C1═O)[C@H]1[C@@H](C[C@H]2C) |
| | [C@@]1(C)C)CO)OC(=O)/C═C/CCCCC)([C@H](C(═C3)C)O)O |
| RNat64 | C[C@@]1([C@H]([C@@H]1C(═O)C1═C([O−])CCCC1═O)/C═C(\Cl)Cl)C |
| RNat65 | [C@]12([C@H]([C@H]([C@@H]3[C@H](C═C(C(═CC1═O)O2)C)OC(═O)C3═C) |
| | OC(═O)/C(═C/C)COC(═O)C)O)C |
| RNat66 | C[C@]1([C@H]([C@@H]1C(═O)O[C@@H](C#N)c1cccc(c1)Oc1ccccc1)/C═C(\Br) |
| | Br)C |
| RNat67 | [C@@]12([C@H]([C@H]([C@H](C2)C)OC(═O)/C═C\c2ccccc2)C═C(CC[C@H]2 |
| | [C@@H](C═C(C1═O)C)[C@@]2(C)C)COC(═O)C)OC(═O)C |
| RNat68 | C[C@@]1([C@@H]([C@@H]1C(═O)O[C@@H](C#N)c1cccc(c1)Oc1ccccc1)/C═C |
| | (\Cl)Cl)C |
| RNat69 | C[C@]1([C@H]([C@@H]1C(═O)O[C@@H](C#N)c1cccc(c1)Oc1ccccc1)/C═C(\Cl) |
| | Cl)C |
| RNat70 | C[C@@]1([C@@H]([C@H]1C(═O)O[C@@H](C#N)c1cccc(c1)Oc1ccccc1)/C═C(\ |
| | Cl)Cl)C |
| RNat71 | C[C@@]1([C@H]([C@H]1C(═O)O[C@@H](C#N)c1cccc(c1)Oc1ccccc1)/C═C(\Cl) |
| | Cl)C |
| RNat72 | [C@]12([C@@]([C@H]([C@H](C2)O)[C@@]2(O[C@@H](CC2)[C@@](O)(C)C)C) |
| | (CC[C@@]2([C@H]1C[C@@H]([C@@H]1[C@@]2(CC[C@@H]([C@@]1(C)C)O |
| | [C@H]1[C@@H]([C@H]([C@@H](CO1)OC(═O)C)OC(═O)C)OC(═O)C)C)O[C@ |
| | H]1[C@@H]([C@H]([C@@H](CO1)O)O)O)C)C)C |
| RNat75 | [C@]1([C@@]2([C@@H](CC1═O)[C@@]1([C@@H](CC2)[C@](C(═O)CC1)(C)C) |
| | C)C)(C1═C[C@H]([C@H]([C@@H](C1)C(═O)C)C(═O)/C(═C/C═C/C(═C1/[C@@] |
| | 2([C@@H](CC1=O)[C@@]1([C@@H](CC2)[C@](C(=O)CC1)(C)C)C)C)C)C)/C═C |
| | (/c1oc(═O)c(cc1)C)C)O |
| RNat76 | COC[C@H]1CCCN1C(═O)CC[C@@H]1CNC(═O)[C@@H]2C[C@@H](C[NH+]12) |
| | NC(═O)c1cccc(c1)F |
| RNat77 | [C@H]12[C@@H](OC(═O)C2═C)C═C([C@H](CC═C(C[C@H]1OC(═O)/C(═C/C) |
| | COC(═O)/C(═C/C)CO)C)O)C |
| RNat78 | [C@@]12([C@]3([C@@H]([C@@]4([C@@H](CC3)[C@]([C@H](CC4)O)(C)C)C) |
| | C(═O)C═C1[C@H]1[C@@](CC2)(CC[C@@](C1)(C(═O)O)C)C)C)C |
| RNat79 | [C@@]12([C@]3([C@@H]([C@@]4([C@@H](CC3)[C@]([C@H](CC4)OC(═O)C) |
| | (C)C)C)C(═O)C═C1[C@H]1[C@@](CC2)(CC[C@@](C1)(C(═O)O)C)C)C)C |
| RNat80 | [C@@]12([C@]3([C@H]([C@@]4([C@@H](CC3)[C@]([C@H](CC4)O)(C)C)C)C |
| | (═O)C═C1[C@H]1[C@@](CC2)(CC[C@@](C1)(C(═O)O)C)C)C)C |
| RNat82 | c1cc(cc(c1)F)C(═O)N[C@H]1CCN2[C@@H]1C(═O)Nc1ccc(cc1C2═O)/C═C/c1ccc |
| | (cc1)O |
| RNat83 | [C@@]1([c@H](C(═O)NC/C═C/C═C(/[C@@H]([C@H][C@@H]2O[C@H]([C@@H] |
| | (C2)O)/C═C/C═C/C═C/C(═O)O)C)OC)C)CO[C@H]2C[C@@H]([C@@H]([C@@H] |
| | (O2)C)O[C@@H]2C[C@H]([C@H]([C@@H](O2)C)O)OC)OC)(O[C@H]([C@] |
| | ([C@H](C1)O)(C)C)/C═C/C═C\C)O |
| RNat84 | [C@@]123[C@@]([C@H](C(═C[C@H](C1═O)[C@H]1[C@@H](C[C@H]2C)[C@]1 |
| | (C)C)CO)OC(═O)C/C═C/C═C)([C@H](C(═C3)C)O)O |
| RNat85 | [C@@]123[C@]([C@@H](C(═C[C@H](C1═O)[C@H]1[C@@H](C[C@H]2C)[C@]1 |
| | (COC(═O)c1ccccc1)C)CO)OC(═O)/C(═C\C)C)([C@H](C(═C3)C)OC(═O)C)O |
| RNat86 | [C@]1([C@H]([C@H]1C(═O)OC)/C═C(/C=N/O)C)(C)C |
| RNat87 | C[C@H](CCC[C@H](C)C)[C@H]1CC[C@@H]2[C@@]1(CC[C@H]1[C@H] |
| | 2CC═C2[C@@]1(CC[C@@H](C2)OC(═O)COc1ccc2c(c1)oc(═O)c1c2CCC1)C)C |
| RNat90 | Cn1c(cc(═O)c(c1CN1CC[NH+](CC1)C/C═C/c1ccccc1)O)C[NH+]1C[C@H]2C[C@ |
| | @H](C1)c1cccc(═O)n1C2 |
| RNat91 | CC[C@@H](CCO)/C(═C/C(═O)CCc1cc(c(c2c1C#CC[C@@H](C[C@@]1(C═C3 |
| | [C@H](C[C@@H](C[C@@H]3[C@@H]2[C@H]1COC)C)c1cccc(c1)O)CO)/ |
| | [NH+]═C(\N)N)O)O[C@H]1CCCC1)CO |
| RNat95 | CCN(CC)C(═O)CC[C@@H]1CNC(═O)[C@@H]2C[C@@H](C[NH+]12)NC(═O) |
| | c1cccc(c1)F |
| RNat96 | [C@@]12([C@H]([C@H]3[C@H](CC2)[C@@]2([C@H](CC3)CC(═O)C(═C2)O) |
| | C)CC[C@@H]1[C@@H](Cc1c(cco1)[C@@H](C)C)C(═O)O)C |
| RNat97 | [C@]12(C═C(C(═O)C[C@H]2CC[C@@H]2[C@H]1CC[C@]1([C@H]2CC |
| | [C@@H]1[C@@H](Cc1c(cco1)[C@@H](C)C)C(═O)O)C)O)C |
| RNat103 | c1ccc(c(c1)/C═C\1C(═O)c2ccc(c(c2O1)C[NH+]1C[C@H]2C[C@@H](C1)c1cccc |
| | (=O)n1C2)[O−])F |
| RNat104 | C[C@H](C)NC(═O)N1C[C@@H]2C[C@H](C1)c1ccc(c(═O)n1C2)c1cccc(c1)[C@ |
| | @](F)(F)F |
| RNat105 | [C@@]12([C@]3([C@@H]([C@@]4([C@@H](CC3)[C@]([C@H](CC4)O)(C)C)C) |
| | C(═O)C═C1[C@H]1[C@@](CC2)(CC[C@@](C1)(C(═O) |
| | OCCCCCCCCCCCCCCCCCC)C)C)C)C |
| RNat106 | [C@H]1([C@@]([C@@H]1/C═C(/OC(═O)C)C)(C)C)C(═O)O[C@@H]1C(═C(C |
| | (═O)C1)C/C═C\C═C)C |
| RNat107 | [C@@H]12[C@@]3(C(═CC[C@H]1[C@H]1[C@](CC2)([C@H](CC1)[C@@H](N |
| | (C)C)C)C)C[C@H]([C@H](C3)O)NC(═O)/C(═C/C)C)C |
| RNat110 | [C@@]12([C@]3([C@@H]([C@H](CC3)[C@@](O[C@H]3[C@@H]([C@H]( |
| | [C@@H]([C@H](O3)CO)O)O)O)(CC/C═C(\C)C)C)[C@@H](C[C@@H]1[C@@] |
| | 1([C@@H]([C@H](C2)O[C@H]2[C@@H]([C@H]([C@@H]([C@H](O2)CO)O |
| | [C@@H]2[C@@H]([C@H]([C@@H]([C@H](O2)CO)O)O)O)O)O)[C@]([C@H] |
| | (CC1)O)(C)C)C)O)C)C |
| RNat111 | [C@@]123[C@]([C@@H](C(═C[C@@H](C1═O)[C@H]1[C@@H](C[C@H]2C) |
| | [C@]1(C)C)COC(═O)c1c(NC(═O)c2c(cccc2)N)cccc1)OC(═O)/C(═C\C)C)([C@H] |
| | (C(=C3)C)OC(═O)C)O |
| RNat114 | C[C@@H]([C@H]1C[C@]2(C═C[C@]3([C@@H]([C@H]4[C@](CCC(═O)[C@@] |
| | 4(C)C)(C4═C3[C@]2([C@@]1(CC4═O)[C@@H]1CCCC1)C)C)/C═C/c1ccccc1)O) |
| | O)[C@HJ(C/[NH+]═C(\N)N)[c@@H](/C═C(\C)C(═O)[O−))O |
| RNat116 | CC1═C(C(═O)C[C@H]1OC(═O)[C@H]1[C@@H]([C@]1(C)C)/C═C(/C)C(═O) |
| | OC)C/C=C/C=C |
| RNat117 | C12═CC(═O)[C@H]3[C@]([C@@]1(CC[C@@]1([C@H]2C[C@](C(═O)OC)(CC1) |
| | C)C)C)(CC[C@H]1[C@@]3(CC[C@@H]([C@]1(C)C)O)C)C |
| RNat118 | C12═CC(═O)[C@H]3[C@]([C@@]1(CC[C@@]1([C@H]2C[C@](C(═O)O)(CC1)C) |
| | C)C)(CC[C@H]1[C@@]3(CC[C@@H]([C@]1(C)C)O)C)C |
| RNat120 | [C@@]12([C@]3([C@@H]([C@@]4([C@@H](CC3)[C@]([C@H](CC4)O[C@H]3 |
| | [C@@H]([C@H]([C@@H]([C@H](O3)C(═O)O)O)O)O[C@H]3[C@@H]([C@H] |
| | ([C@H](CO3)O)O)O)(C)C)C)C(═O)C═C1[C@H]1[C@@](CC2)(CC[C@@](C1) |
| | (C(═O)O)C)C)C)C |
| RNat121 | [C@@]12([C@]3([C@@H]([C@@]4([C@@H](CC3)[C@]([C@H](CC4)O[C@H]3 |
| | [C@@H]([C@H]([C@@H]([C@H](O3)C(═O)O)O)O)O[C@H]3[C@@H]([C@] |
| | (CO3)(CO)O)O)(C)C)C)C(═O)C═C1[C@H]1[C@@](CC2)(CC[C@@](C1)(C(═O) |
| | CO)C)C))C |
| RNat122 | [C@@]12([C@]3(C(═CC(═O)[C@@H]1[C@@]1([C@@H](CC2)[C@]([C@H] |
| | (CC1)O[C@H]1[C@@H]([C@H]([C@@H]([C@H](O1)C(═O)O)O)O)O[C@H]1 |
| | [C@@H]([C@H]([C@@H]([C@H](O1)C(═O)O)O)O)O)(C)C)C)[C@H]1 |
| | [C@@](CC3)(CC[C@@](C1)(C(═O)O)C)C)C)C |
| RNat123 | [C@@]12([C@]3(C(═CC(═O)[C@@H]1[C@@]1([C@@H](CC2)[C@]([C@H] |
| | (CC1)O[C@H]1[C@@H]([C@H]([C@@H]([C@H](O1)C(═O)O)O)O)O[C@H]1 |
| | [C@@H]([C@H]([C@@H]([C@H](O1)C(═O)O)O)O)O)(C)C)C)[C@H]1 |
| | [C@@](CC3)(CC[C@](C1)(C(═O)O)C)C)C)C |
| RNat124 | c1cc[n+]c(c1)N1CCN(CC1)C(=O)CC[C@@H]1CNC(=O)[C@@H]2C[C@@H](C |
| | [NH+]12)NC(=O)c1cccc(c1)F |
| RNat125 | c1cc(cc(c1)F)C(═O)N[C@H]1C[C@H]2C(═O)NC[C@@H](CCC(═O) |
| | N3CCCCC3)[NH+]2C1 |
| RNat126 | c1cc(cc(c1)F)C(═O)N[C@H]1C[C@H]2C(═O)NC[C@@H](CCC(═O) |
| | N3CCCC3)[NH+]2C1 |
| RNat127 | c1ccc(cc1)N1CCN(CC1)C(=O)CC[C@@H]1CNC(=O)[C@@H]2C[C@@H] |
| | (C[NH+]12)NC(=O)c1cccc(c1)F |
| RNat128 | CN1CCN(CC1)C(═O)CC[C@@H]1CNC(═O)[C@H]2[NH+]1C[C@H](C2) |
| | NC(═O)c1cccc(c1)F |
| RNat129 | [C@@]123[C@@]([C@H](C(═C3)C)OC(═O)c3c(NC(═O)c4c(c(ccc4)O)NC(═O)/ |
| | C(═C/C)C)cccc3)([C@@H](C(═C[C@H](C1═O)[C@H]1[C@@H](C[C@H]2C) |
| | [C@]1(C)C)COC(═O)C)O)O |
| RNat130 | C[C@]1([C@@H]([C@@H]1C(═O)N1CCCC[C@@H]1c1cccnc1)/C═C(\Cl)Cl)C |
| RNat131 | C[C@@]1([C@H]([C@@H]1C(═O)N1CCCC[C@@H]1c1cccnc1)/C═C(\Cl)Cl)C |
| RNat132 | C[C@]1([C@@H]([C@H]1C(═O)N1CCCC[C@@H]1c1cccnc1)/C═C(\Cl)Cl)C |
| RNat133 | C[C@@]1([C@H]([C@H]1C(═O)N1CCCC[C@@H]1c1cccnc1)/C═C(\Cl)Cl)C |
| RNat134 | Cc1cc(n(n1)C(═O)[C@@H]1[C@@H]([C@]1(C)C)/C═C(\C)C)C |
| RNat135 | [C@@]12([C@]3(C(═CC(═O)[C@@H]1[C@@]1([C@@H](CC2)[C@]([C@H] |
| | (CC1)O[C@H]1[C@@H]([C@H]([C@@H]([C@H](O1)C(═O)O)O)O)O[C@H]1 |
| | [C@@H]([C@H]([C@@H]([C@H](O1)C(═O)O)O[C@@H]1[C@@H]([C@H] |
| | ([C@@H]([C@H](O1)CO)O)O)O)O)O)(C)C)C)[C@H]1[C@@](CC3)(CC[C@@] |
| | (C1)(C(═O)O)C)C)C)C |
| RNat136 | [C@@]12([C@]([C@@H]([C@@H](O1)[C@@H](C[C@H]([C@H]([C@H]([C@H] |
| | (/C═C(/C(═C/C═C/C(═C\C#N)C)C)C)C)O)C)O)OC)O[P@@](═O)(O)O)(C)C)O |
| | [C@@H]([C@@H]([C@H](C2)O)C)C/C═C/c1nc(oc1)[C@@H](CCNC(═O) |
| | [C@@H]([C@@H]([C@@H](COC)NC)O)O)C |
| RNat137 | C[C@]12CC[C@](C═C1C1═CC(═O)[C@@H]3[C@]4(CCC(═O)[C@@]([C@@H] |
| | 4CC[C@]3([C@@]1(CC2)C)C)(C)C)C)(C)C(═O)OC |
| RNat138 | CCCCC[C@@H](/C═C/C1═C([C@@H]([NH2+][C@H](CC#Cc2ccccc2CC1)[C@] |
| | (C)(Cc1ccc(cc1)O)O)CCC[C@@H]([C@@]1(CCCC1)CC(═O)[O−])[NH2+]CC)C |
| | [C@@H](CO)O)O |
| RNat139 | [C@@]12([C@]3(C(═CC(═O)[C@@H]1[C@@]1([C@@H](CC2)[C@]([C@H] |
| | (CC1)OC(═O)CCCCCCC)(C)C)C)[C@H]1[C@@](CC3)(CC[C@](C1)(C)C)C |
| | (═O)O)C)C |
| RNat142 | [C@]123[C@]4([C@@H]([C@@]5([C@@H](CC4)[C@]([C@H](CC5)O[C@H]4 |
| | [C@@H]([C@@H](O[C@H]5[C@@H]([C@H]([C@@H]([C@H](O5)CO)O[S@] |
| | (═O)(═O)O)O)O)[C@H](CO4)O)O[C@H]4[C@H]([C@@H]([C@H]([C@@H] |
| | (O4)C)O)O)O)(C)C)C)CC[C@@H]1[C@H]1[C@@](C2)(OC3)O[C@@H](C[C@] |
| | 1(O)C)/C═C(\C)C)C |
| RNat143 | C/C(═C\[C@H]1[C@@H]([C@@]1(C)C)C(═O)NCc1ccccn1)C |
| RNat144 | CC(═O)O[C@H]1CC[C@]2([C@H]([C@]1(C)C)CC[C@@]1([C@@H]2C(═O) |
| | C═C2[C@]1(CC[C@@]1([C@H]2C[C@@](CC1)(C)C)C(═O)[O−])C)C)C |
| RNat145 | CC(═O)O[C@H]1CC[C@]2([C@H]([C@]1(C)C)CC[C@@]1([C@H]2C(═O) |
| | C═C2[C@]1(CC[C@@]1([C@H]2C[C@@](CC1)(C)C)C(═O)[O−])C)C)C |
| RNat146 | [C@@]12([C@]3(C(═CC(═O)[C@@H]1[C@@]1([C@@H](CC2)[C@]([C@@H] |
| | (CC1)O)(C)C)C)[C@H]1[C@@](CC3)(CC[C@](C1)(C)C)C(═O)O)C)C |
| RNat147 | [C@@]12([C@]3(C(═CC(═O)[C@@H]1[C@@]1([C@@H](CC2)[C@]([C@H] |
| | (CC1)O)(C)C)C)[C@H]1[C@@](CC3)(CC[C@](C1)(C)C)C(═O)O)C)C |
| RNat148 | [C@@]12([C@]3(C(═CC(═O)[C@@H]1[C@@]1([C@@H](CC2)[C@]([C@H] |
| | (CC1)OC(═O)C)(C)C)C)[C@H]1[C@@](CC3)(CC[C@](C1)(C)C)C(═O)O)C)C |
| RNat149 | C[C@]12CC[C@](C═C1C1═CC(═O)[C@H]3[C@]4(CCC(═O)[C@@]([C@@H] |
| | 4CC[C@]3([C@@]1(CC2)C)C)(C)C)C)(C)C(═O)OC |
| RNat150 | C[C@]12CC[C@](C═C1C1═CC(═O)[C@H]3[C@]4(CCC(═O)[C@]([C@H]4CC |
| | [C@]3([C@@]1(CC2)C)C)(C)C)C)(C)C(═O)OC |
| RNat152 | [C@@]12([C@]3([C@@H]([C@@]4([C@@H](CC3)[C@]([C@H](CC4)OC(═O) |
| | C)(C)C)C)C(═O)C═C1[C@H]1[C@@](CC2)(CC[C@@](C1)(C(═O)OC)C)COC |
| | (═O)C)C)C |
| RNat153 | COc1ccc2c(c1OC)c(═O)n1c3ccc(cc3c3c1c2ncc3)OCc1cccc(c1)F |
| RNat154 | CC(═O)N[C@H]1CCc2cc(c(c(c2c2c1cc(═O)c(cc2)NCCc1ccccc1F)OC)OC)OC |
| RNat156 | c1ccc2c(c1)CCN2C(═O)CC[C@@H]1CNC(═O)[C@@H]2C[C@@H](C[NH+]12) |
| | NC(═O)c1cccc(c1)F |
| RNat158 | c1ccc(cc1)C[C@@H](C(=O)Nc1ccc(c(c1)Cl)F)NC(=O)N1C[C@H]2C[C@@H](C1) |
| | c1cccc(═O)n1C2 |
| RNat160 | CCCCC/C═C\C═C\C(═O)O[C@H]1C(═C[C@@]23[C@@]1([C@@H](C(═C |
| | [C@@H](C2═O)[C@H]1[C@H]([C@]1(C)C)C[C@H]3C)CO)O)O)C |
| RNat161 | [C@@]123[C@@]([C@H](C(═C3)C)OC(═O)/C═C\C═C\CCCCC)([C@@H](C |
| | (═C[C@H](C1═O)[C@H]1[C@@H](C[C@H]2C)[C@]1(C)C)CO)O)O |
| RNat162 | [C@@]123[C@@]([C@H](C(═C3)C)OC(═O)/C═C/C═C/CCCCC)([C@@H](C |
| | (═C[C@H](C1═O)[C@H]1[C@@H](C[C@H]2C)[C@]1(C)C)CO)O)O |
| RNat163 | [C@@]123[C@@]([C@H](C(═C3)C)OC(═O)/C═C\C═C/CCCCC)([C@@H](C |
| | (═C[C@H](C1═O)[C@H]1[C@@H](C[C@H]2C)[C@]1(C)C)CO)O)O |
| RNat164 | [C@@]123[C@@]([C@H](C(═C3)C)OC(═O)/C═C/C═C\CCCCC)([C@@H](C |
| | (═C[C@H](C1═O)[C@H]1[C@@H](C[C@H]2C)[C@]1(C)C)CO)O)O |
| RNat165 | C/C(═C\1CCc2ccc(cc2)[C@@H]2C═C[C@H](C[C@H]2CC(═O)O[C@@H]2c3c |
| | (ccc4c3oc(═O)cc4)O[C@]([C@H]2OC1═O)(C)C)c1cccc(c1)Cc1ccccc1)C |
| RNat167 | [C@@]12([C@]3([C@H]([C@H](CC3)[C@@](O[C@H]3[C@@H]([C@H]( |
| | [C@@H]([C@H](O3)CO)O)O)O)(CC/C═C(\C)C)C)[C@@H](C[C@@H]1[C@@] |
| | 1([C@@H]([C@H](C2)O[C@H]2[C@@H]([C@H]([C@@H]([C@H](O2)COC |
| | (═O)C)O)O)O[C@H]2[C@@H]([C@@H]([C@H]([C@@H](O2)C)O)O)O)[C@] |
| | ([C@H](CC1)O)(C)C)C)O)C)C |
| RNat168 | C[C@]12C[C@H](C[C@](C1)(C)C)N(C2)C(═O)[C@@H]1[C@@H]([C@]1(C) |
| | C)/C═C(\Cl)Cl |
| RNat169 | C[C@H](C[C@@H](C(═O)[C@@H](C)C(═O)[O−])O)[C@H]1C[C@]2(C═C |
| | [C@]3([C@@H]([C@H]4[C@](CCC(═O)[C@@]4(C)C)(C4═C3[C@]2([C@@]1 |
| | (CC4═O)[C@@H]1CCCC1)C)C)/C═C/c1ccccc1)O)O |
| RNat170 | [C@]12([C@@]([C@H]([C@H](C2)O)[C@@]2(O[C@@H](CC2)[C@](O)(C)C) |
| | C)(CC[C@@]2([C@H]1C[C@@H]([C@@H]1[C@@]2(CC[C@@H]([C@@]1 |
| | (C)C)O[C@H]1[C@@H]([C@H]([C@@H](CO1)O)O)OC(═O)C)C)O[C@H]1 |
| | [C@@H]([C@H]([C@@H]([C@H](O1)CO)O)O)O)C)C)C |
| RNat171 | C[C@H](CCC[C@H](C)C)[C@H]1CC[C@@H]2[C@@]1(CC[C@H]1[C@H] |
| | 2CC═C2[C@@]1(CC[C@@H](C2)OC(═O)COc1ccc2c(c1)occ(c2═O) |
| | c1ccccc1OC)C)C |
| RNat172 | CC(═O)O[C@H]1CC[C@]2([C@H]([C@]1(C)C)CC[C@@]1([C@H]2C(═O) |
| | C═C2[C@]1(CC[C@@]1([C@@H]2C[C@@](CC1)(C)C(═O)OC)C)C)C)C |
| RNat173 | C[C@]12CC[C@](C[C@@H]1C1═CC(═O)[C@@H]3[C@]4(CC[C@@H] |
| | ([C@@]([C@@H]4CC[C@]3([C@@]1(CC2)C)C)(C)C)O)C)(C)C(═O)OC |
| RNat174 | CC(═O)O[C@H]1CC[C@]2([C@H]([C@]1(C)C)CC[C@@]1([C@@H]2C(═O) |
| | C═C2[C@]1(CC[C@@]1([C@@H]2C[C@@](CC1)(C)C(═O)OC)C)C)C)C |
| RNat175 | C[C@]12CC[C@](C[C@@H]1C1═CC(═O)[C@H]3[C@]4(CC[C@@H]([C@@] |
| | ([C@@H]4CC[C@]3([C@@]1(CC2)C)C)(C)C)O)C)(C)C(═O)OC |
| RNat176 | [C@@]12([C@H]3[C@](C(═O)C[C@@H]1[C@@]([C@H](C[C@H]2O)OC(═O)/ |
| | C(═C\C)C)(C)C)(O[C@@](C[C@H]3O)(C═C)C)C)C |
| RNat179 | [C@@H]12[C@@H]3[C@@](O3)(C[C@H]([C@H]3C(═C)C(═O)O[C@H]3C═C |
| | ([C@@H]1O2)CO)OC(═O)/C(═C/C)COC(═O)C)C |
| RNat180 | [C@]123[C@@](O1)([C@H]([C@H](C3)C)OC(═O)C)C═C([C@H]([C@H]([C@H] |
| | 1[C@@H](C═C([C@@H]2OC(═O)C)COC(═O)C)[C@]1(C)C)OC(═O)C)OC(═O) |
| | [C@@H](CC)C)CO |
| RNat181 | [C@]1(C(═O)N2[C@@H]1SCC(═C2C(═O)[O−])COC(═O)/C(═C/c1cc(c(cc1) |
| | O)O)OC)(NC(═O)CCC[C@@H](C(═O)O)N)OC |
| RNat184 | [C@]12([C@H]3[C@]([C@]4(C(═CC3)[C@@H]3[C@@](C(═O)O)(CC4)CC |
| | [C@](C3)(C)C)C)(CC[C@@H]1[C@@]([C@@H](O[C@H]1[C@H]([C@@H] |
| | (O[C@H]3[C@@H](O[C@H]4[C@H]([C@H]([C@H](CO4)O)O)O)[C@H] |
| | ([C@@H](CO3)O)O)[C@@H]([C@H](O1)CO)O)O)[C@H](C2)O)(C)C)C)C |
| RNat185 | CCC(═O)O[C@@]1([C@H](C[C@H]2[C@@]1(C[C@@H]([C@]1([C@@H] |
| | 2CCC2═CC(═O)C═C[C@]12C)F)O)C)C)C(═O)CCl |
| RNat186 | CCC(═O)O[C@@]1([C@H](C[C@H]2[C@@]1(C[C@@H]([C@]1([C@H] |
| | 2CCC2=CC(=O)C═C[C@]12C)F)O)C)C)C(=O)CCl |
| RNat187 | CCCCC[C@@H](/C═C/[C@H]1CCC(═O)[C@@H]1CCCCCCC(═O)N1CCn2c3ccc |
| | (cc3c3c2[C@@H]1CCC3)C)O |
| RNat188 | [C@H]12[C@@](C(═O)C(═C[C@@H]3[C@H](CC[C@@]4([C@@H]1O4)C)[C@ |
| | @]3(C)C)C)(C[C@H]([C@@H]2OC(═O)C)C)OC(═O)c1ccccc1 |
| RNat189 | CCCCC[C@@H](/C═C/[C@H]1CCC(═O)[C@@H]1CCCCCCC(═O)N1CCn2c3ccc |
| | (cc3c3c2[C@@H]1CCC3)[C@H]1CCCCC1)O |
| RNat191 | CC(═O)O[C@H]1CC[C@]2([C@@H]([C@@]1(C)C)CC[C@@]1([C@@H]2C |
| | (═O)C═C2[C@]1(CC[C@@]1([C@H]2C[C@@](CC1)(C)C)C(═O)[O−])C)C)C |
| RNat192 | CC(═O)O[C@H]1CC[C@]2([C@@H]([C@]1(C)C)CC[C@@]1([C@H]2C(═O) |
| | C═C2[C@]1(CC[C@@]1([C@H]2C[C@@](CC1)(C)C)C(═O)[O−])C)C)C |
| RNat193 | [C@@]12([C@]3(C(═CC(═O)[C@@H]1[C@@]1([C@H](CC2)[C@@]([C@H] |
| | (CC1)O)(C)C)C)[C@H]1[C@@](CC3)(CC[C@](C1)(C)C)C(═O)O)C)C |
| RNat194 | [C@@]123[C@]([C@@H](C(═C[C@H](C1═O)[C@H]1[C@@H](C[C@H]2C) |
| | [C@]1(C)C)COC(═O)C)OC(═O)/C═C/C═C\CCCCCCCCC)([C@H](C(═C3)C) |
| | OC(═O)C)O |
| RNat195 | c1cc(cc(c1)[C@@](F)(F)F)c1ccc2n(c1═O)C[C@H]1C[C@@H]2CN(C1)C(═O) |
| | c1ccc(cc1)C#N |
| RNat196 | C[C@]12CC[C@](C[C@H]1C1═CC(═O)[C@@H]3[C@]4(CCC(═O)[C@]([C@H] |
| | 4CC[C@]3([C@@]1(CC2)C)C)(C)C)C)(C)C(═O)[O−] |
| RNat197 | [C@@]12([C@H]([C@H]3[C@H](CC2)[C@@]2(C(═CC3)C[C@H](CC2)O[C@H] |
| | 2[C@@H]([C@H]([C@@H]([C@H](O2)CO)O[C@H]2[C@@H]([C@H]([C@@H] |
| | ([C@H](O2)CO)O)O)O)O)O)C)C[C@@H]([C@@H]1[C@@H]([C@@H]1N(C |
| | [C@H](CC1)C)C)C)O)C |
| RNat198 | Cc1ccc2c(c1)c1c3n2CCN([C@@H]3CCC1)CC(═O)N/N═C/C═C/c1ccccc1 |
| RNat199 | [C@@]1([C@@H](C(═O)NC/C═C/C═C(\[C@H]([C@H]([C@@H]([C@H] |
| | (/C═C\C═C\C═C\C═C(\C(═O)c2c(═O)n(ccc2O)C)C)O)O)C)OC)C)CC)(O[C@H] |
| | ([C@@]([C@@H](C1)O)(C)C)/C═C/C═C\C)O |
| RNat200 | [C@]123[C@]4([C@@H]([C@@]5([C@@H](CC4)[C@]([C@H](CC5)O[C@H]4 |
| | [C@@H]([C@@H](O[C@H]5[C@@H]([C@H]([C@@H]([C@H](O5)CO)O[S@] |
| | (═O)(═O)O)O)O)[C@H](CO4)O)O[C@H]4[C@@H]([C@@H]([C@H]([C@@H] |
| | (O4)C)O)O)O)(C)C)C)CC[C@@H]1[C@@H]1[C@@](C2)(OC3)O[C@H](C |
| | [C@@]1(O)C)/C═C(/C)C)C |
| RNat201 | [C@@]12([C@@H]([C@@H](CC[C@H]1CC(═O)C(═C2)[C@@H](C(═O)OC)C) |
| | OC(═O)/C(═C\C)C)C(═O)OC)C |
| RNat202 | CCCCC/C═C/C═C/C(═O)O[C@H]1C(═C[C@@]23[C@@]1([C@@H](C(═C |
| | [C@@H](C2═O)[C@H]1[C@H]([C@]1(C)C)C[C@H]3C)COC(═O)C)O)O)C |
| RNat203 | CCCCC/C═C\C═C\C(═O)O[C@H]1C(═C[C@@]23[C@@]1([C@@H](C(═C |
| | [C@@H](C2═O)[C@H]1[C@H]([C@]1(C)C)C[C@H]3C)COC(═O)C)O)O)C |
| RNat204 | [C@@]123[C@@]([C@H](C(═C3)C)OC(═O)/C═C\C═C\CCCCC)([C@@H](C |
| | (═C[C@H](C1═O)[C@H]1[C@@H](C[C@H]2C)[C@]1(C)C)COC(═O)C)O)O |
| RNat205 | [C@@]123[C@@]([C@H](C(═C3)C)OC(═O)/C═C/C═C\CCCCC)([C@@H](C |
| | (═C[C@H](C1═O)[C@H]1[C@@H](C[C@H]2C)[C@]1(C)C)COC(═O)C)O)O |
| RNat206 | [C@@]123[C@@]([C@H](C(═C3)C)OC(═O)/C═C/C═C/CCCCC)([C@@H](C |
| | (═C[C@H](C1═O)[C@H]1[C@@H](C[C@H]2C)[C@]1(C)C)COC(═O)C)O)O |
| RNat207 | c1ccc(cc1)C(=O)N/C(═C\c1ccccc1F)C(=O)N1C[C@H]2C[C@@H](C1)c1cccc(=O) |
| | n1C2 |
| RNat208 | c1ccc(cc1)C(=O)N/C(═C\c1ccccc1F)C(=O)N1C[C@@H]2C[C@H](C1)c1cccc(=O) |
| | n1C2 |
| RNat209 | [C@]123[C@]([C@H](c4cocc4)OC(═O)[C@H]2OC(═O)C)(CC[C@@H](C1═C) |
| | [C@@]1([C@@H](O3)[C@H]([C@H]([C@]([C@H]1CC(═O)OC)(C)C)O)OC |
| | (═O)C[C@@H](C)C)C)C |
| RNat210 | [C@@]123[C@]([C@@H](OC(═O)[C@H]1OC(═O)C)c1cocc1)(CC[C@H]([C@] |
| | 1([C@@H](O3)[C@H]([C@H]([C@]([C@@H]1CC(═O)OC)(C)C)O)OC(═O)C |
| | [C@@H](C)C)C)C2═C)C |
| RNat211 | CC1═C2[C@H](C(═C([C@H](C[C@@H](C(═C[C@@H]([C@@H]([C@@]2(C) |
| | C)C[C@@H]1OC(═O)C)OC(═O)C)COC(═O)C)OC(═O)/C═C/c1ccccc1)OC(═O) |
| | C)C)OC(═O)C)OC(═O)C |
| RNat212 | [C@@H]1([C@@](CCCC1═C)(C)C)CC/C(═C/CC/C(═C/COC(═O)CC(═O)OCC) |
| | C)C |
| RNat213 | [C@@H]1([C@@](CCCC1═C)(C)C)CC/C(═C/CC/C(═C/COC(═O)CC(═O)OC |
| | [C@@H](C)C)C)C |
| RNat214 | [C@@H]1([C@@](CCCC1═C)(C)C)CC/C(═C/CC/C(═C/COC(═O)CC(═O)O)C) |
| | C |
| RNat215 | [C@@H]1([C@@](CCCC1═C)(C)C)CC/C(═C/CC/C(═C/COC(═O)CC(═O)OC)C) |
| | C |
| RNat216 | [C@@H]1(OC[C@@H]([C@@H]([C@@H]1O)O)O)O[C@H]1CC[C@]23[C@@H] |
| | ([C@@]1(C)C)CC═C1[C@@]2(C[C@H]([C@]2([C@@]1([C@H](C(═O)[C@H]2 |
| | [C@H](CC(═O)[C@@H]([C@](C)(C)O)O)C)O)C)C)OC(=O)C)C3 |
| RNat217 | CC(═O)O[C@H]1CC[C@]2([C@H]([C@]1(C)C)CC[C@@]1([C@@H]2C(═O) |
| | C═C2[C@]1(CC[C@@]1(C2═C[C@@](CC1)(C)C(═O)OC)C)C)C)C |
| RNat218 | C[C@]12CC[C@](C═C1C1═CC(═O)[C@@H]3[C@]4(CC[C@@H]([C@@] |
| | ([C@@H]4CC[C@]3([C@@]1(CC2)C)C)(C)C)O)C)(C)C(═O)OC |
| RNat219 | C[C@]12CC[C@](C═C1C1═CC(═O)[C@@H]3[C@]4(CC[C@@H]([C@@] |
| | ([C@@H]4CC[C@]3([C@@]1(CC2)C)C)(C)C)OCO)C)(C)C(═O)[O−] |
| RNat220 | [C@]123[C@@]4(C2)[C@H]([C@]2([C@](CC4)([C@H]([C@H](C2)O)[C@@]2(O |
| | [C@@H](CC2)[C@@](O)(C)C)C)C)C)C[C@@H]([C@H]1[C@]([C@H](CC3)O |
| | [C@H]1[C@@H]([C@H]([C@@H](CO1)O)O)OC(═O)C)(C)C)O[C@H]1 |
| | [C@@H]([C@@H]([C@H]([C@@H](O1)C)O)O)OC(=O)C |
| RNat221 | [C@@]123[C@]4(C2)[C@H]([C@]([C@H](CC4)O[C@H]2[C@@H]([C@H]([C@ |
| | @H](CO2)O)O)OC(═O)CC(═O)O)(C)C)CC═C1[C@]1([C@](CC3)([C@H](C(═O) |
| | [C@@H]1O)[C@@H](C[C@H]([C@H]1[C@](O1)(C)C)OC(=O)C)C)C)C |
| RNat222 | [C@]123[C@H]4[C@@](O[C@H]2OC)([C@H]([C@@H](O[C@H]4C[C@H]1 |
| | [C@H]1[C@H](CC3)[C@@]2(C(═CC1)C[C@H](CC2)O[C@H]1[C@@H]([C@H] |
| | ([C@@H]([C@H](O1)CO)O)O)O[C@H]1[C@@H]([C@@H]([C@H]([C@@H] |
| | (O1)C)OC(═O)c1ccc(cc1)OC)O)O)C)O)/C═C(/C)C)C |
| RNat223 | [C@]12(C3═C([C@]4([C@](CC3)([C@H](C[C@H]4O)[C@@H](O)C)C)C)CC |
| | [C@H]1[C@]([C@H]([C@@H]([C@H]2O)OC(═O)C[C@@H](C)C)O)(C)C)C |
| RNat224 | [C@@]123[C@]([C@@H](C(═C[C@](C1═O)([C@H]1[C@@H](C[C@H]2C)[C@] |
| | 1(C)C)C)COC(═O)c1c(NC(═O)c2c(NC(═O)c4c(N(C)C)cccc4)c(ccc2)O)cccc1)O)([C |
| | @H](C(═C3)C)O)O |
| RNat225 | [C@@]12([C@]([C@@H]([C@@H](O1)[C@@H](C[C@H]([C@H]([C@H]([C@H] |
| | (/C═C(/C(═C/C═C/C(═C\C#N)C)C)C)C)O)C)O)OC)O)(C)C)O[C@@H]([C@@H] |
| | ([C@H](C2)O)C)C/C═C/c1nc(oc1)[C@@H](CCNC(═O)[C@@H]([C@@H]([C@H] |
| | (N(C)C)COC)O)O)C |
| RNat228 | C12═CC(═O)[C@@H]3[C@]([C@@]1(CC[C@@]1([C@H]2C[C@](C(═O)O) |
| | ([C@@H](C1)O)C)C)C)(CC[C@@H]1[C@@]3(CC[C@@H]([C@@]1(C)C)O)C)C |
| RNat229 | [C@@]12([C@]3([C@@H]([C@@]4([C@@H](CC3)[C@]([C@H](CC4)OC(═O)C) |
| | (C)C)C)C(═O)C═C1[C@H]1[C@@](CC2)(CC[C@](C1)(C)C)C)C)C |
| RNat231 | C[C@]12CC/C(=N\OCC(═O)NCC[C@]3(CCO[C@](C3)(C)C)c3ccccc3)C═C1CC |
| | [C@@H]1[C@@H]2CC[C@]2([C@@H]1CC[C@]2(C#C)O)C |
| RNat232 | C[C@]12CC/C(=N/OCC(═O)NCC[C@]3(CCO[C@](C3)(C)C)c3ccccc3)C═C1CC |
| | [C@@H]1[C@@H]2CC[C@]2([C@@H]1CC[C@]2(C#C)O)C |
| RNat233 | [C@H]1([C@]([C@H](O[C@H]2[C@@H]([C@H]([C@H]([C@H](O2)CO)O)O)OC |
| | (═O)C)CC[C@]1(OC(═O)C)C)(C)C)CC/C(═C/C[C@@H](/C═C(/[C@H](C[C@H]1 |
| | [C@](C(═O)CC═C1C)(C)C)OC(═O)C)C)OC(═O)C)C |
| RNat234 | [C@@H]1([C@@H](O[C@@H]([C@H]([C@@H]1O)O)CO)O[C@H]1[C@] |
| | ([C@@H]([C@](OC(═O)C)(CC1)C)CC/C(═C/C[C@@H](/C═C(/[C@H](C[C@H] |
| | 1[C@](C(═O)CC═C1C)(C)C)OC(═O)C)C)OC(═O)C)C)(C)C)OC(═O)C |
| RNat235 | C12═CC(═O)[C@@H]3[C@]([C@@]1(CC[C@@]1([C@H]2C[C@@](C(═O)O) |
| | (CC1)C)CO)C)(CC[C@@H]1[C@@]3(CC[C@@H]([C@@]1(C)C)O)C)C |
| RNat236 | C[C@H](C/C═C(/c1ccccc1)c1ccccc1)[C@H]1CC[C@@H]2[C@@]1(CC[C@@H]1 |
| | [C@@H]2CC═C2[C@@]1(CC[C@@H](C2)OC(═O)C)C)C |
| RNat237 | [C@]1([C@@H](C(═O)NC/C═C/C═C(/[C@@H]([C@@H]([C@@H]([C@H] |
| | (/C═C/C═C/C═C/C═C(/C(═O)c2c(═O)n(ccc2O)C)C)O)O)C)OC)C)CC)(O |
| | [C@@H]([C@@]([C@@H](C1)O)(C)C)/C═C/C═C\C)OC |
| RNat238 | C/C(═C\[C@@H]1[C@H]([C@@]1(C)C)C(═O)NCc1ccccn1)C |
| RNat240 | c1ccc(cc1)[C@]1(CCN(CC1)C(═O)COc1ccc2c(c1)oc(═O)c1c2CCCC1)C(═O)[O−] |
| RNat241 | [C@]123[c@]4([c@@H][c@@]5([c@@H](CC4)[c@][C@H](CC5)O[C@H]4 |
| | [C@@H]([C@H]([C@@H]([C@H](O4)CO)O)O[C@H]4[C@@H]([C@H]([C@@H] |
| | ([C@H](O4)CO)O)O)O)O)(C)C)C)CC[C@H]1[C@H]1[C@@](C2)(OC3)OC |
| | [C@H]([C@@]1(O)C)/C═C(\C)C)C |
| RNat242 | CN1CCc2cc3c(c(c2[C@H]1C#CCOc1ccc2c(c1)c1ccccc1o2)OC)OCO3 |
| RNat243 | c1cc(cc(c1)[C@@](F)(F)F)c1ccc2n(c1═O)C[C@H]1C[C@@H]2CN(C1)C(═O) |
| | Nc1cccc(c1)F |
| RNat244 | CC(═O)O[C@H]1CC[C@]2([C@@H]([C@]1(C)C)CC[C@@]1([C@@H]2C(═O) |
| | C═C2[C@]1(CC[C@@]1([C@@H]2C[C@@](CC1)(C)C(═O)OC)C)C)C)C |
| RNat245 | CC(═O)O[C@H]1CC[C@]2([C@@H]([C@@]1(C)C)CC[C@@]1([C@H]2C(═O) |
| | C═C2[C@]1(CC[C@@]1([C@@H]2C[C@@](CC1)(C)C(═O)OC)C)C)C)C |
| RNat246 | C[C@]12CC[C@](C[C@@H]1C1═CC(═O)[C@@H]3[C@]4(CC[C@@H]([C@] |
| | ([C@H]4CC[C@]3([C@@]1(CC2)C)C)(C)C)O)C)(C)C(═O)OC |
| RNat247 | C[C@]12CC[C@](C[C@@H]1C1═CC(═O)[C@H]3[C@]4(CC[C@@H]([C@] |
| | ([C@H]4CC[C@]3([C@@]1(CC2)C)C)(C)C)O)C)(C)C(═O)OC |
| RNat248 | C[C@H](C)[C@@H](C(=O)Nc1ccc(cc1)O[C@](F)(F)F)NC(=O)N1C[C@H]2C |
| | [C@@H](C1)c1cccc(=O)n1C2 |
| RNat249 | CSCC[C@@H](C(=O)Nc1ccc(cc1)O[C@](F)(F)F)NC(=O)N1C[C@H]2C[C@@H] |
| | (C1)c1cccc(=O)n1C2 |
| RNat250 | COc1ccc(cc1)c1ccc2c(c1)C(═O)N1CC[C@@H]([C@H]1C(═O)N2)NC(═O)c1cccc |
| | (c1)F |

TABLE C.1
Images of 6 conserved cores of several compounds in Table C

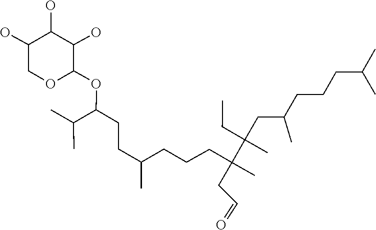

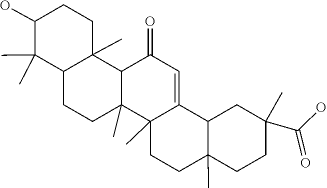

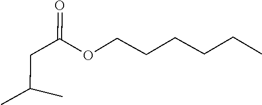

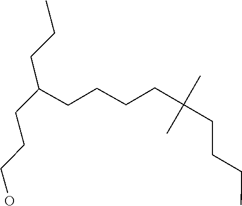

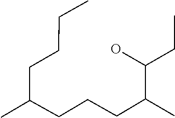

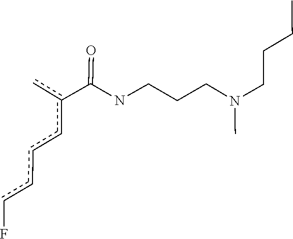

TABLE CII

| Compound ID | SMILES | Average Activity |
|---|---|---|
| RNat355829 | C═C/C═C/CC1═C(C)[C@H](OC(═O)[C@@H]2 | 0.99307826 |
| | [C@@H](C═C(C)C)C2(C)C)CC1═O | |
| RNat241231 | C═C/C═C\CC1═C(C)[C@@H](OC(═O)[C@H]2 | 0.98198923 |
| | [C@@H](/C═C(\C)OC(C)═O)C2(C)C)CC1═O | |
| RNat282738 | C═C/C═C/CC1═C(C)[C@@H](OC(═O)[C@@H]2 | 0.976296 |
| | [C@@H](/C═C(/C)C(═O)OC)C2(C)C)CC1═O | |
| RNat156146 | C═C/C═C/CC1═C(C)[C@H](OC(═O)[C@H]2[C@H] | 0.98735285 |
| | (C═C(C)C)C2(C)C)CC1═O | |
| RNat005837 | CC1(C)[C@@H](C═C(Cl)Cl)[C@H]1C(═O)O | 0.98601598 |
| | [C@@H](C#N)c1cccc(Oc2ccccc2)c1 | |
| RNat156180 | C═C/C═C/CC1═C(C)[C@H](OC(═O)[C@H]2[C@H] | 0.96289133 |
| | (/C═C(/C)C(═O)OC)C2(C)C)CC1═O | |
| RNat305444 | C/C═C\CC1═C(C)[C@@H](OC(═O)[C@@H]2 | 0.92737681 |
| | [C@@H](/C═C(/C)C(═O)OC)C2(C)C)CC1═O | |
| RNat342851 | C═C/C═C\CC1═C(C)[C@@H](OC(═O)[C@H]2C | 0.9078102 |
| | [C@@H]2C═C(C)C)CC1═O | |
| RNat163196 | CC1(C)[C@@H]([C@](C#N)(OC═O)c2cccc | 0.90075687 |
| | (Oc3ccccc3)c2)[C@@H]1/C═C(\Cl)C(F)(F)F | |
| RNat051960 | CCOc1ccc(Oc2c(C)oc3cc(OCc4cccc(Oc5ccccc5)c4) | 0.87853138 |
| | ccc3c2═O)cc1 | |
| RNat346954 | C/C═C/CC1═C(C)[C@@H](OC(=O)[C@@H]2 | 0.84369715 |
| | [C@@H](/C═C(\C)OC(C)═O)C2(C)C)CC1═O | |
| RNat160096 | C/C═C/CC1═C(C)[C@@H](OC(=O)[C@@H]2 | 0.82286606 |
| | [C@@H](/C═C(\C)C(═O)OC)C2(C)C)CC1═O | |
| RNat001465 | C[C@@H](C(═O)[O−])c1cccc(Oc2ccccc2)c1 | 0.82214451 |
| RNat303890 | C/C═C\CC1═C(C)[C@@H](OC(═O)[C@H]2 | 0.81808064 |
| | [C@@H](C═C(C)C)C2(C)C)CC1═O | |
| RNat001067 | CCOC(═O)[C@@H]1[C@H](C═C(C)C)C1(C)C | 0.79385727 |
| RNat001066 | CCOC(═O)[C@H]1[C@H](C═C(C)C)C1(C)C | 0.78535436 |
| RNat001064 | CCOC(═O)[C@H]1[C@@H](C═C(C)C)C1(C)C | 0.78502421 |
| RNat001065 | CCOC(═O)[C@@H]1[C@@H](C═C(C)C)C1(C)C | 0.78011319 |
| RNat220576 | CCOC(═O)C1C(C═C(C)C)C1(C)C | 0.77235109 |
| RNat383508 | CC(═O)OC(═O)[C@H]1[C@@H](C═C(C)C)C1(C)C | 0.72573267 |
| RNat277046 | COC(═O)/C(C)═C/[C@H]1[C@H](C(═O)OC)C1(C)C | 0.69778205 |
| RNat255691 | COC(═O)[C@@H]1[C@@H](C═C(C)C)C1(C)C | 0.60695771 |
| RNat044479 | [NH3+][C@@H](CC(═O)[O−])c1cccc(Oc2ccccc2)c1 | 0.57584071 |
| RNat044478 | [NH3+][C@H](CC(═O)[O−])c1cccc(Oc2ccccc2)c1 | 0.57288486 |
| RNat393014 | C═C/C═C\CC1═C(C)[C@@H](OC(═O)[C@H]2C | 0.55949569 |
| | [C@@H]2/C═C(\C)C(═O)OC)CC1═O | |

In some embodiments, the average activity in Table CII is a predicted average activity.

One or more pesticide compounds may be used alone or in combination with other agents. The compounds of the disclosure may be combined with additional active agent, e.g., other known insecticides and the like. Such compositions may comprise various combinations of compounds as well as varying concentrations of the compound depending upon the insect/pest being targeted.

In some embodiments, the compounds in Table C and Table CII may be employed alone or in mixtures with one another and/or with such solid and/or liquid dispersible carrier vehicles, and/or with other known compatible active agents, including, for example, insecticides, acaricides, rodenticides, fungicides, bactericides, nematocides, herbicides, fertilizers, growth-regulating agents. In some variations, the pesticide compositions are formulated as solutions, emulsions, suspensions, powders, pastes, or granules.

### EXAMPLES

The following examples are merely illustrative and are not meant to limit any embodiments of the present disclosure in any way.

### Example 1

### Repellent Effects of DEET on Mosquitoes

This Example demonstrates that Aedes aegypti detect and avoid DEET primarily using Olfaction.

### Materials and Methods

Repellency is tested in mated and starved Ae. aegypti females using a hand-in-glove assay. Briefly, a gloved hand with an opening exposing skin odorants protected by 2 layers of netting was presented to mosquitoes for 5 min inside a cage and video taped for landing and avoidance responses. Mosquitoes were unable to bite due to the outer protective layer of netting and the inner layer of netting was treated with either test compound (10%) or solvent, such that mosquitoes were able to respond to volatiles but unable to make physical contact. The number of mosquitoes present for more than 5 seconds, and the numbers departing during the same period were counted from the videos at minutes 2, 3, 4, and 5 mins and repellency percentage and escape index calculated by comparing with similar numbers in solvent treated controls.

Percentage repellency=100×[1−(mean cumulative number of mosquitoes on the window of treatment for 5 seconds at time points 2, 3, 4, 5 min/mean cumulative number of mosquitoes that remained on window of solvent treatment for 5 seconds at time points 2, 3, 4, 5 min)].
Percentage present=average number of mosquitoes on window for 5 seconds at a given timepoint across trials. All values were normalized to percentage of the highest value for the comparison, which was assigned a 100 percent present.
Mean Escape Index=(Average Number of mosquitoes in treatment that landed yet left the mesh during a five second window over the following time points: 2 minutes, 3 minutes, 4 minutes, 5 minutes)/(Average Number of mosquitoes that landed yet left the mesh during a five second window over the same time points in (treatment+control)). Each time point has N=5 trials, 40 mosquitoes per trial, Except for EA, where N=4.

Repellency is also tested in Two-choice heat attraction assay was performed by offering mosquitoes a choice between solvent and DEET treated mesh coupled with a heat stimulus. Heat stimuli for the assay was provided by two Hot Hands® Hand Warmers HH2 (Heat Max, Dalton, Ga.). A pair of heat sources, for test and control was prepared in this manner; 4 hand warmers were simultaneously activated by shaking in gloved hands to 37° C. The hand warmers were fitted snugly into a 100×15 mm petri dish (Fisher) base and covered with 15×15 cm polyester netting secured round the petri dish by a pair or 8 inch plastic cable ties (Gardner Bender, Milwaukee, Wis.) coupling to form a heat pad. Excess netting material was trimmed off round the edges of the petri dish but not the two loose ends of the cable ties. The heat pads were each covered with a 150×15 mm petri dish with a 10×7.5 cm window cut out of its base. This opening was now aligned in and secured in position with the heat pad top with the aid of the loose ends of the cable ties. The pair of large petri dish assembly was placed side by side with the window openings aligned to position. Another pair of 150×15 mm petri dish bases was placed next to the assembly to keep the arena in position and to act as base for test cage. Polyester nets (9×8 cm) treated with 500 μl solvent and DEET 3% concentration were suspended in air and solvent allowed evaporate. Each treated piece was placed between two 10×7.5 cm flexible magnets with 7.5×6.2 cm window frame. Three magnetic window frames were added on top. These solvent and odorant (DEET) treatment net-magnets were simultaneously placed over the 10×7.5 cm openings of the larger petri dishes on the heat pads to form a 2-choice arena. At the start of the assay, a test cage was gently set on its side aligned directly over the 2-choice arena. The pair of petri dish bases and the magnets always maintained a gap of ˜6 mm between the lower treated net and the test mosquito cage screen side thus ensuring no contact between mosquitoes and the treatments. Mosquitoes attracted by heat were thus either exposed to DEET and or acetone (solvent) treatment in a non-contact manner. The solvent and DEET positions were alternated between runs. Mosquito landing choices were during the assay and videos analyzed by counting the number of landings in snapshots of 1 minute interval from the second minute for the duration of the 5 minute trial.

### Example 2

### In-Silico Screening for Repellent Substitutes for DEET

In this Example, safe natural odors as repellents are identified using an in silico screen.

### Materials and Methods

Odor compound libraries: A subset of ˜450,000 volatile compounds was assembled from defined origins including plants, humans, insects (El-Sayed, 2009), food flavours and a fragrance collection (Sigma-Aldrich, 2007) including many additional fruit and floral volatiles (Cork and Park, 1996; Curran et al., 2005; Gallagher et al., 2008; Knudsen et al., 2006; Logan et al., 2008; Meijerink et al., 2000; Zeng et al., 1991; Zeng et al., 1996). Chemicals were also selected from the various metabolite databases, such as the HMDB (http://www.hmdb.ca/), KEGG http://www.genome.jp/kegg/), Yeast Metabolome Database http://www.ymdb.ca), Bovine Metabolome Database (http://bmdb.wishartlab.com), and Plant Metabolites.

Chemical Informatics: Using a Sequential Forward Selection (SFS) approach 18 molecular descriptors from the 3,224 available from the Dragon package (Talete) were selected for their ability to increase the correlation between descriptor values and repellency. The Support Vector Machine (SVM) function from the R package was trained with the 18 descriptors for the training compound set using regression and a radial basis function kernel. We trained SVM models to learn physicochemical features of the confirmed ligands for a subset of ORs whose response profiles are currently better characterized (34 total). Different chemical features were encoded as binary fingerprints, Morgan/Circular, Shortest Path, and Hybridization. Chemical fingerprints can encode up to ˜1000 bits and many are possibly uninformative. Kullback-Leibler (KL) divergence was used to select only those bits that maximized the distance between active and inactive compounds in the training data set of known repellents or pyrethroids. Predictions from these models provided probability scores for new chemicals for each of the two categories. This work relied on the chemistry development kit (CDK) (Steinbeck et al., 2003) as well as its R interface (rcdk) (Guha and Rojas-Chertó). The trained SVM then screened the library of natural compounds we assembled (>450,000) to identify additional chemicals that has one of the two activities.

### Results

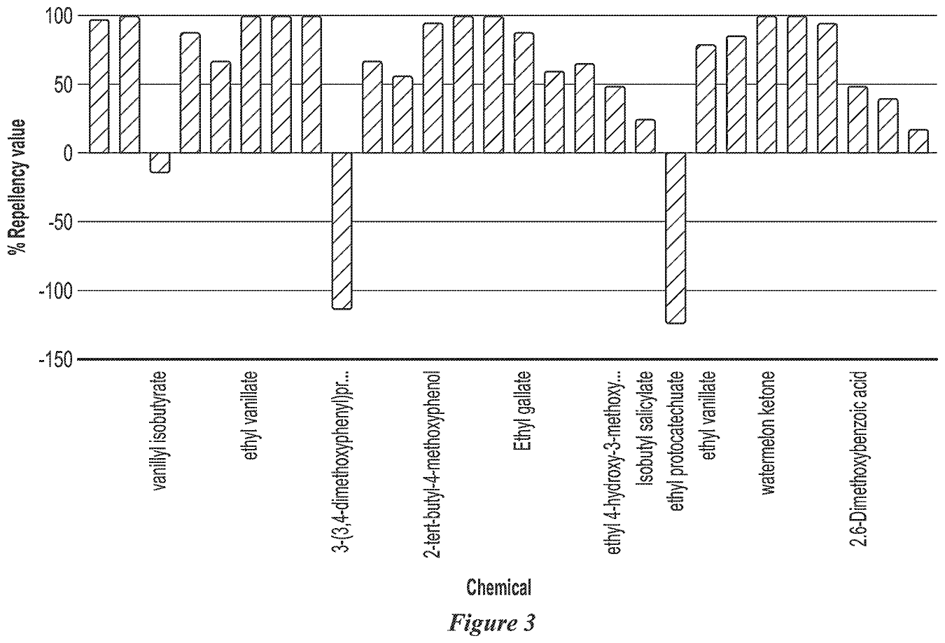

The 18 optimized-descriptors and SVM method were used to screen in-silico a large chemical library consisting of >440,000 chemicals from a database called eMolecules of putative volatiles. Upon inspection, the top 1,000 predicted compounds (0.23% of hits) were found to represent a structurally diverse group of chemicals that retain some structural features of the known repellents (FIGS. 3A and 3B). Log P values of the 1,000 compounds were computed to identify ones that are predicted to be lipophilic (log P>4.5) thus allowing for selection of other compounds that are less likely to pass through the skin barrier in topical applications (Walker et al., 2003) (FIG. 3B). In addition, the predicted vapor pressures of these chemicals were computed since volatility may predict ability of long-term protection vs. increased spatial domain of action (FIG. 3B). Taken together the results of the screen present a very large collection of novel predicted repellents with desirable properties, identified via a computationally guided search of odor space.

Although the in-silico screen bypasses the challenge of not knowing the protein target, the most significant challenge lies in identifying effective repellent substitutes for DEET that are affordable and safe and that can be rapidly approved for human use. In order to identify compounds that fit these criteria, an in-silico screen was applied to an assembled natural odor library consisting of >3,000 chemicals identified as either originating from plants, insects, or vertebrate species or compounds already approved for human use as fragrances, cosmetics or flavors. Using the trained SVM and optimized descriptor set on the natural library, the top 150 ranked predicted repellent compounds were identified. Predicted repellents share similarity in some parts of the structure while providing a diverse set of compounds (FIG. 3C). For example, several anthranilates and pyrazines were identified that represent novel groups of safe and natural compounds, although such compounds were absent from the training set. These 150 compounds were arranged by predicted log P and vapour pressure values to provide a high-priority list of candidates for behavioral testing (FIG. 3C).

1. A repellent composition, comprising
one or more compounds selected from Table A, Table B, or Table CII.

2. The composition of claim 1, wherein the composition comprises two or more compounds selected from Table A, Table B and Table CII.

3. The composition of claim 1, wherein the composition comprises at least one compound selected from Table A, and at least one compound from Table B.

4. The composition of claim 1, wherein the composition comprises at least one compound selected from Table A, Table B and Table CII, and an additional agent.

5. The composition of claim 4, wherein the additional agent is a known insect repellent or insecticide.

6. The composition of claim 1, wherein the composition is formulated as a spray, lotion, foam, gel, suspension, emulsion, mat, embedded fabric, powder, or granule.

7. A repellent apparatus, comprising:
an apparatus containing the composition of claim 1, wherein the apparatus is configured to dispense the composition.

8. The apparatus of claim 7, wherein the apparatus is a spray container, a heated emanator, a fan-based emanator, an aerosol based emanator, or a vaporizer.

9. The apparatus of claim 7, wherein the apparatus is affixed on a surface of an object.

10. A method of repelling an arthropod, comprising:
dispensing the composition of claim 1 to expose the arthropod to the composition, thereby repelling the arthropod.

11. A repellent pesticide composition, comprising
one or more compounds selected from Table CII.

12. The composition of claim 11, wherein the composition comprises two or more compounds from Table CII.

13. The composition of claim 11, wherein the composition is formulated as a spray, lotion, foam, gel, suspension, mat, embedded fabric, embedded paper, powder, granule, or emulsion.

14. A repellent pesticide apparatus, comprising:
an apparatus containing the composition of claim 11, wherein the apparatus is configured to dispense the composition.

15. The apparatus of claim 14, wherein the apparatus is a spray container, a heated emanator, a fan-based emanator, an aerosol based emanator, or a vaporizer.

16. The apparatus of claim 14, wherein the apparatus is affixed on a surface of an object (such as clothes, bednets, furnishings, plants, fruits, entryways, and foods).

17. A method of treating and/or controlling an arthropod, comprising:
applying the composition of claim 11, to a surface of an object.

18. The method of claim 10, wherein the composition is applied by spraying.

19. The method of claim 10, wherein the composition is applied using a sprayer, a fan dispenser, a vaporizer, an atomizer, a heated emanator, or an aerosol based emanator.

20. The method of claim 10, wherein the arthropod is a tick, a bedbug, an insect, a dipteran, a fruit fly and/or a mosquito, agricultural pest insect, a hymenopteran, a cockroach, a spider, or a termite.
